(19) United States
(12) Patent Application Publication
(10) Pub. No.: US 2009/0320713 A1
(43) Pub. Date: Dec. 31, 2009

(54) People & Cargo Transit Systems & Vehicles

(76) Inventor: AHMAD AMIRI, RICHMOND HILL (CA)

Correspondence Address: AHMAD AMIRI, 21 DUNLOP ST., # 207, RICHMOND HILL, ON, L4C-2M6, CA

(21) Appl. No.: 12/470,433

(22) Filed: May 21, 2009

Related U.S. Application Data
(60) Provisional application No. 61/075,348, filed on Jun. 25, 2008.
(60) Provisional application No. 61/155,851, filed on Feb. 26, 2009.
(60) Provisional application No. 61/178,413, filed on May 14, 2009.

(51) Int. Cl. B60L 13/04; B61B 13/00; B60R 21/13

(52) U.S. Cl. 104/281; 104/307; 280/1

(57) ABSTRACT

The Application discloses People & Cargo Transit Systems & Vehicles (PCTSV), using Narrow Vehicles (NV), which can have the form of a Bus, Train, Tram, Maglev, Mono-Rail or even Car or Truck. A preferred version of which is Single Seat Wide or below 70 cm wide, preferably a Bus type to need no Rail, using Dedicated Narrow Lanes adjacent to Curbside of existing intra-city streets or limits of inter-city roads. Said NV and Lane have Anti-Roll Over Means to stabilize such a narrow vehicle, which also eliminate NV Swaying even when NV is a Bus or Car with has no inherent Sway Limiting. Being Ultra Narrow with No Sway and Running at Curbside results in Negligible or No Blocking of other vehicles by NV.Said Lane/Tack, Anti-Sway & Anti-Roll Structures all Allow being Run Over by other Traffic and have structures not to be damaged, thus can be crossed over at Crossroads and other entrances and exits along said Lane. NV has enough Doors and is Narrow, hence each Passenger can reach a seat or exit, with No Isle inside it to walk along. So it can have Low Profile, like a Sports Car, some 120 cm tall. Hence it is easy to have Covered Trenches at cross roads for non-stop crossing. Trenches can run along most or all the Track, in which case adherence to streets and roads is relieved. Such Narrow and Shallow Trenches take a tiny fraction of time and costs of Skyways or Subways. Each Passenger thus can have her own door, own seat, in a small Cabin, which can be opened and closed to next Cabin, have reclining seats to join to that of next Cabin to sleep on, have laptop tray, etc. All those make PCTSV much more appealing to user's, even better than private transport. There are many Variations other than above. There is an NV Car for the last mile and or long distance use, which can integrate with NV Public Transit. Also modifications to NVs for use in Cargo and Parcel Transit.

### CROSS REFERENCE

Applicant claims priority of U.S. Patent Applications No. 61/075,348 filed Jun. 25, 2008 & 61/155,8541 filed Feb. 26, 2009 and 61/178,413 filed May 14, 2009.

### TECHNICAL FIELD

Is Vehicles & Systems for Private &/Public Transit of People & Goods

### BACKGROUND

Narrow Vehicle, to be called NV & Narrow Transit System to be called NTS, solve a number of problems with Buses, Tramways (Street Cars), Trains, Subways, Skyways (typically Monorail), MagLev, or other Conventional Public Vehicles, to be collectively called CPV, some problems being:
1—Subways and Skyways take huge investment and decades for infrastructure
2—Skyways but can be an eyesore and reduce a city's homeliness
3—Trams and Buses, are moderate in infrastructure costs & time, but are slow and slow other vehicles
4—Numerous other problems with all Conventional Public Vehicles, make them unappealing

If not for subsidized pricing and user's environmental concerns, CPT is inferior to Private Transport.

### SUMMARY

The Application discloses a Narrow Vehicle (NV), preferably Single Seat Wide, using Narrow Lanes and/or Tracks & Techniques for:
1—Minimizing Infrastructure Costs and Time,
2—Increasing NV Speed,
3—Reducing or Eliminating Blocking of other vehicles by NV,
4—NV Stability, not to roll even when ultra narrow,
5—NV adherence to a Lane and/or Track, with no or minimal Swaying,
6—Operating NV in a Covered Trench, as one variation, especially at road crossings,
7—Making NV and NTV much more appealing to user's, even better than private transport,
8—Variations and viable combinations and permutations of techniques disclosed, and or
9—NVs and NTS can be modified for Cargo and Parcel Transit.

Most disclosed techniques can be applied in isolation and/or in combination with other known or disclosed techniques and their equivalents, and can be applied to current public and/or private vehicles.

Preferred version of NV is a Bus, to need least infrastructure, but can be a Street Car, Rail Car, etc.

NV can have One, but preferably many Seat Rows, each row preferably a Single Seat but can have more.

NV can have one or more Decks. Accessing higher decks is preferably via Station's higher decks.

A number of NVs can be sequenced lengthwise to form a NV Train or NVT

NTS has almost all advantages of both private and public Transit plus numerous other advantages, almost none of their disadvantages, with minimal infrastructure, time and cost.

Narrow Vehicle Example (One Best Mode):
looks like a bus and has tires to use existing roads and no need for tram tracks
is long (above ten seat rows), very narrow (below 70 cm wide) and low height (below 150 cm high)
its length is divided into Articulating Segments attached together at Joints to ease turning
runs in a narrow lane adjacent to the curb
uses a wireless Auto Steering Technology to stay within that lane with little sway
uses Automatic Driving Technology to navigate the Narrow Transit System (NTS)
which lane goes via covered trenches at crossroads and or turns to avoid traffic lights & slow downs
is battery operated, with automatic battery changing at some stops or depot
is automatically connectable to and detachable from front and or rear to other NVs
hence can form a Narrow Vehicle Train (NVT) which can be made longer and shorter by demand
each row has one seat, one exit door to the curbside of each seat
exits are curb level for easy rolling in of wheelchair, suitcase, etc
each seat is secluded from next seats, effectively in a private cabin
a window between cabins, above the seat, can be blinded for privacy and opened for company
cabins have a desk, power jack, internet connection, heat & cold control, window blinds, etc
cabins can have elastic gym gear, rugged computer,
a programmable alarm wakes up each sleeping morning commuter at her destination
cabins have luggage room under the seat, on a rack, on and under the desk
seat, desk and rack are foldable, to make room for luggage, bicycle or disabled chair
seats are reclining and or sliding to form a bed when combined with the next seat
consecutive seats pivot at junction of their back & base or otherwise can face one another
joining with next seat is only possible if ticket holders of both seats agree
passengers can book adjacent cabins for children, sleeping or luggage, via kiosks, cell, web, etc
a portable scooter can fit in the cabin and or a bicycle can fit over the roof, for journey's last leg

Disclosure: Means, Techniques and System is described here. Later by Ref to Drawings.

Minimizing Infrastructure Time & Costs, by:
1—Using existing roads and infrastructure,
2—No or minimal road surface structures, as shown here,
3—Using a Covered Trench, instead of Subway Tunnels, preferably only as needed,
4—Simpler vehicles, as disclosed, and or
5—Variations and viable combinations and permutations of disclosed techniques

Increasing NV Speed, by:
1—Using a NV Lane and Ensuring that others do not unnecessarily use said Lane, if reduces NV speed,

Preventing abuse suffered by conventional bus and tram lanes is by a barrier along its boundaries.

Boundary can be marked “physically” by a wall, fence, ridge, bump, blocks, poles, cones, etc.

One version is Nails dug into the road with a hemisphere head protruding above road surface.

All can be made crossable, by being low profile and or discontinuous with wide enough gaps to allow use of the lane by pedal and motor bicycles, loading and unloading by other vehicles, entry and exit of NV, etc.
2—Using a Covered Trench, disclosed separately, especially across road crossings, turns and other barriers, to avoid traffic light and slow downs.
3—Using a Skypipe or Skychannel, disclosed separately, especially across road crossings, turns and other barriers, to avoid traffic light and slow downs.
4—Reducing or Eliminating Blocking of Other Vehicles, to increase overall traffic flow, disclosed separately, Conventional buses and trams and their lanes reduce traffic flow and indirectly their own speed.
5—Variations and viable combinations and permutations of disclosed techniques.

A Preferred Solution is 1 for most of the street, converting to 2 for where needed.

Reducing or Eliminating Blocking of Other Vehicles, by (Summarized First, Elaborations Follow):
A—Reducing NV Width, hence a Narrow NV Lane and or Track,
B—Reducing or Eliminating NV Sway,
C—Using Trenchways, as disclosed separately,
D—Running and/or Stopping the NV adjacent to Curb,
E—Minimizing road obstruction at NV Turnings, and or
F—Variations and viable combinations and permutations of disclosed techniques.

Details of “Eliminating Blocking of Other Vehicles A to F”
A—Reducing NV Width, hence a Narrow NV Lane and or Track, by:
1—Eliminating walkway Isle along NV Length by by providing enough door(s), at NV's side(s), front, rear and/or even roof, on both or preferably curbside, so that a small number of passengers use each door, Preferably One door per Seat Row or per two facing Seat Rows enables no increase in NV length,
2—An alternative to numerous doors is large doors, each serving a number of seat rows, Very large doors, such as one covering the entire side of NV are possible, but may need to open sliding upwards, rather than sliding back & forth or swinging away or up wingwise,
3—Using Widthwise Isle(s), which are “across” the width of NV (unlike conventional lengthwise Isles), each Isle leading to a door serving a number of passengers. This may add to NV length, but reduces doors.
4—Reducing the number of Seats across the NV width, unlike CPVs with typically four seats across, Single Seat Wide NV is Preferred. Such NV may need Anti Roll Techniques, disclosed separately, and/or
5—Variations and viable combinations and permutations of known and or disclosed techniques.

A Preferred Solution is Single Seat Rows and One door per Row.
B—Reducing or Eliminating NV Sway (to mean lateral movement and or extra lane width needed for lateral movement, not for tilting), hence Reducing NV Lane or track Width, by using:
1—NV designed as a Train, Tram, Mono-Rail (Typically on Sky Rails), Magnetic Levitating Train (MagLev) and/or Regular Rails on which NV runs and operates,
2—Driver trained to keep very close to the Curb with little Sway. Driver can be preferably assisted by Lane Limit Lines, a Strip along said line that creates a noise alarming the driver she is Swaying off the lane, a Ridge along the Lane Limit, etc, all of which can be crossed over if NV needs to go off Lane.
3—A Ridge along the Lane Limit which is further than the Curb, having a side facing the Curb, preferably inclined and not vertical to the road, to resist NV tires crossing over said surface, as going uphill. A similar structure can run adjacent to the Curb in opposite direction. Thus the cross section of NV Lane has a hill at the Ridge, a hill at the Curb and a flat valley between hills for Lane with. Ridges better be not too high, say below 10 cm, to allow determined crossing over, yet high enough to resist inadvertent violation.

4—Guide Channels on the road surface along NV Lane, inside which a number of NV Wheels run. Channel cross section should be preferably circular or parabolic so that a wheel running inside it has a tendency to run at its deepest center, and avoid friction against the Channel sides. Channels should be preferably close to the Curb and have a width and/or depth that allows other vehicles crossing over them, especially at cross roads, property entrances, turns, etc. It is better that at least two tires, one close to the front and one close to the rear of each Un-Articulated Segment of NV to run in same Channel. One example is two parallel Channels, in one the left side Wheels run and in the other the right side wheels. Another is one Channel, in which the wheels closer to the Curb run, which wheels are either larger than the wheels outside the Channel or are held at the right distance from the base of NV to keep NV level.
5—Channel Roller(s), typically small wheels preferably with tires, but not for running the vehicle, running inside Guide Channels. Relevant issues disclosed for Guide Channels apply to Channel Rollers too. Channel Roller(s) should be held firmly inside the Guide Channel(s), using springs, hydraulics, magnets, etc, attached to NV. One way to do this is to have three telescopic spring arms attached at different points to the underside of NV, all joining at a Channel Roller, looking like an upside down tri-pod, one end of each pod attached to NV underneath distant from other pods and the other end of all pods attached to the Roller, so that when NV distance from road surface changes, the springs adjust to keep the Roller inside the Channel, yet no lateral movement of NV is possible. A cable attached to the Roller, controlled by NV Driver, can pull the Roller up and out of the Channel, when necessary, say when NV should leave NV Lane to bypass a broken down NV blocking the lane. For Sway prevention, it is better that at least two Rollers, one close to front, one close to rear of each Un-Articulated Segment of NV to run in or on same Channel.
6—Guide Pulley(s) rolling on Guide Rail(s). Pulleys typically look like small wheels without tires, with a grooved rim which can roll over a Rial without skidding off. Relevant considerations disclosed for Guide Channels and Channel Rollers apply to Guide Pulleys. Guide Rails need not be strong or well supported for load bearing, and that NV itself need not run on them, but can run on asphalt, like a bus, yet have its Guide Pulleys on the Guide Rail(s).

Guide Pulleys should be held firmly not to move off the Guide Rail(s), using springs, hydraulics, magnets, etc, attached to NV. One way to do this is to have three telescopic spring arms attached at different points to the underside of NV, all joining at a Guide Pulley, looking like a upside down tri-pod attached to the Pulley at its peak so that when NV distance from road surface changes, the springs adjust to keep the Pulley over the Guide Rail, yet no lateral movement of NV is possible. A cable attached to the Pulley, controlled by NV Driver, can pull it up and out of the Channel, when necessary, say for NV to move off its lane when blocked. For Sway prevention, it is better that at least two Pulleys, one close to the front and one close to the rear of each unarticulated Segment of NV to run in or on same Guide Rail.
7—Sonar, Optical, Radio Frequency and/or other Wireless Position Sensing to gauge distance to Curb, or other Road Marks, plus Automatic Vehicle Steering (AVS), both known to the skilled to keep NV within a short distance from the Curb (A Preferred Solution).
8—Anti Roll Techniques, disclosed separately, some also prevent Sway. A Preferred solution.
9—Variations and viable combinations and permutations of disclosed techniques.

For example, NV can use a Guide Channel, except for cross roads where it uses Trenches.

There is no preset preferred one, as all depends on operating environment.
C—Using Trenchways, as disclosed separately.
D—Running and/or Stopping the NV adjacent to Curb, hence Eliminating stoppage of other vehicles, unlike say Trams which often stop at the middle of street for passenger pick up and drop off.
E—Minimizing road obstruction at NV Turnings. Preferably, NV Lane/Track is close to the Curb. Following techniques ensure least obstruction of other vehicles at Turnings say for U-Turns or Crossroads:
1—Minimize turnings by running each NV along almost straight streets as far as possible, even if some passengers have to switch to another NV running along a crossing street.
2—Maximize number of NV Articulating Segments, to reduce NV Turning Circle.
3—Minimize NV Length. With Automatic Driver, replacing one long NV with many Short NVs adds no cost.
4—Sequence Shorter NVs into one NV Train, run by same driver, especially if manually driven.
5—Curve street angles at crossroads and turns
6—Place the Turning Curvature of NV Lane/Track mostly over the Receiving Road to which NV is turning right (for right side traffic law). This means parts of the Curve are at a distance from Receiving Road Curb. Also Keep NV Lane on the Road from which NV Departs as far as possible close to Curb and not Curving. Receiving Road is slow anyway during NV and other vehicles turning right, so using much of the right half of it for NV Turning Circle does not affect traffic speed much. But during NV turning, Departing Road needs to move as fast as possible, and better not be blocked by any occupied turning circle.

This principle can be applied to left drive countries and other relevant cases, with obvious modifications.
7—If NV Lane is used by other vehicles, such as motorbikes or bicycles or if NV otherwise slows traffic, its passenger Stops close to a crossroad better be before it reaches same crossroad, where it must stop anyway for traffic light or crossing vehicles, rather than after said crossing. Also stopping before, not after, reaching any T-Junction is preferred.
8—Using sub-surface Trenches or Skypipes to shortcut, curve and/or avoid acute turnings.
9—Variations, combinations and permutations of disclosed techniques.
F—Variations and viable combinations and permutations of disclosed techniques.

NV Roll Over Prevention (Anti Roll Techniques), using:
1—Any of Prior Art techniques. Numerous inventions deal with stability of very narrow vehicles. Many do not even require small tires, low seats, wide body or level road, yet can race off road with few roll overs, such as techniques in Off Road Vehicles. Some use Springs and Hydraulics to balance the vehicle. Some use Gyroscopes, such as Segway personal mover. Other techniques are used and known to the skilled.
2—Choosing a proper NV width. NV does not have to be one seat wide. A two seats wide NV can be 120 cm wide, but if it has no Isles and no Sway, its lane is about 120 cm, which provides good stability, especially when combined with other Anti Roll Techs, yet does not block the road, unlike 350 cm wide bus lanes.
3—Low NV, with low center of gravity, by use of a combination of small tires, distribution of heavy components to vehicle bottom and corners, wheels at the extreme corners, very low seats, etc.
4—A a Train of Low Height Short (few seat rows) NVs, connected front to end, resists roll over, as at any time those NVs with tendency to roll are held by stable ones.
5—Articulated NV, with Segments connected at Articulation Joint which allows one Segment to tilt without transferring the tilt to the joined Segment.
6—Descending Seats, which rise for passenger to sit on them without the difficulty of sitting on a low seat, but are gradually lowered once the passenger is sat. Raising and lowering can be manual, electronic, hydraulic, by use of springs, etc and/or a combination thereof as known to the skilled.

A low seat needs more leg room, hence a longer vehicle, but length is not a problem for other vehicles.
7—Low Height NV: One main reason why conventional public vehicles are tall is their center walking Isle. Eliminating the Isle, disclosed separately, can reduce NV height to as short as sport or even racing car. Lowering NV, close to the Curb as an anti roll measure and for ease of passenger entry and exit, especially with luggage or wheelchair, reduces the height further. NV can be shorter than 150 cm, even 120 cm. A short NV has many advantages, such as use of roof as a bicycle rack for last leg of trip, not blocking the street view, less weight, less fuel consumption, no movement of troublemakers across isles, etc.
8—I-Rail & Claw (A Preferred Solution)

I-Rail is a Rail with a cross section similar to capital letter “I”, similar to normal Rails, stretched on the road similar a Train Rail, but not load bearing to need ties or other load bearing or leveling structures. A Claw or Hook is an Assembly of two Pulleys and two Rollers. The Pulley, looks like a railcar wheel or car wheel without rubber part of tires, but preferably smaller. The Pulleys, roll along the top of the I-Rail, similar to train wheels on rail, and its grooved rim holds the I-Rail, ensuring that Claw does not move laterally or skid off the I-Rail. Two Pulleys on same I-Rail prevent up-down and sideways tilting friction with I-Rail. The Rollers roll along the underside of the top of the I-Rail, each at a different side of the I-Rail. Hence the Claw holds the top T-section half of I-Rail and can move along the I-Rail. A Telescopic Arm connects the Claw to preferably the NV underside and closer to NV's curbside. The I-Rail is stretched along the road close to the Curb. The Arm stretches and contracts to conform to up and down movements of NV on uneven parts of the road. The Arm has limited stretch ensuring the left side of NV's underbody does not rise too much above road. A number of such Claws along the length of NV keeps NV's left side from tilting. Another I-Rail is stretched parallel to the first I-Rail, but closer to the non-curb side of NV, on which a number of Claws ensure that non-curb side of NV does not tilt much either. Preferably, at least two Claws should be allocated to each side of each Articulating Segment of NV. If NV is a Railcar version, running on rails, the Rails can act as the I-Rail. Thus a very narrow NV, Railcar and or Train is prevented from rolling. For Bus type NV, the I-Rail is not load bearing and does not require ties or a load bearing foundation. I-Rail should adhere strongly to the road not to be lifted under NV rolling pull. Rollers should be firmly fixed in the Claw to hold against the underside of the top T-section of I-Rail. Rollers can have cable, hydraulic or other gear to be released from the I-Rail when necessary, by NV manual or automatic Driver, say when NV needs to go off its lane or track to bypass a lane blockage.

There are many variations of above themes. One uses Rollers instead of Pulleys. To avoid Claw lateral movement, Rollers below the “head” of the top T-section of the I-Beam roll at about 45 degrees to T base.
9—I-Railing—is an I-Rail resting on Poles (or on a wall). Pole bottoms are fixed to ground, their tops holding the I-Rail above ground like a Fence Railing, preferably near the Curb. The Telescopic Arm is preferably attached to NV side (rather than NV bottom), at a height almost the height of the Claw. The higher the Railing & Claws, the shorter the Arm, the less NV tilting, but less than half meter height is sufficient. Better at least the T-Section half of “I” closer to NV should be almost horizontal, (unlike vertical I-Rial). I-Railing, compared to I-Rail has no Rails above the road. Unlike two I-Rails, One I-Railing suffices. At crossroads or property entrances, NV better switch to other techniques which more easily accommodate other vehicles crossing over, or I-Railing can be removed, where blocking a road, by:
   (a) lifting the I-Railing high enough to unblock the road when necessary, lowering for NV
   (b) pivoting at one end of the I-Railing, lifting the other end, like railway bars
   (c) dipping the I-Railing into the ground
   (d) sliding the I-Railing along the length of same I-Railing to open the blocking
   (e) swivelling the I-Railing away from blocking the road, swivel back for NV to pass
   (f) reclining the I-Railing onto the ground and hiding it enough for other vehicles pass over
   (g) other known ways of removing a Railing to open the road and moving back for NV crossing
10—Steel Strip & Magnets—A Strip of Steel (or other Material attracted by magnets), on the road surface along NV Lane, coupled with a Magnet attached to the underneath of NV, gliding close to the Strip provides both Anti Rolling and some Anti Sway, as the Magnet will resist any departure form the Strip. The Magnet should be as close as possible to the Strip for more attraction force. The Magnet better have Tiny Roller(s), underneath it, rolling on the road, but preferably on the Strip to prevent friction with the Strip. Anti Sway may be added to prevent Magnet from Swaying off the Strip. The Magnet need not be permanent, but Electric. Tilt Sensors in the NV can sense any NV tilting, and activate the Electro Magnet. The amount of electric power supplied can be adjusted to severity of tilt. Also a number of Electro Magnets can be employed, as many as necessary to be activated, as strongly as necessary, as detected by Tilt Sensor and calculated by Control Software. Permanent Magnets can be used for normal condition, supplemented by Electro Magnets when needed. In conjunction with other Anti Roll measures, use of Electricity will be occasional and minimal. Two Strips are necessary, one holding left, the other right side of NV from lifting above the road. One major advantage of the Strip is that it can be low profile, for easier crossing over by other vehicles.
11—Variations and viable combinations and or permutations of disclosed techniques.

Cross Roads:

Where I-Rails, Guide Rails, Rails or the like, which rise above road surface, may need to be run over by other vehicles, such as Crossroads, Property Entrance, NV Turnings, and/or where NV lane needs to be used by other vehicles, say as a bicycle lane, following techniques can be applied:
1—Making Rails or the like low rise for easier crossing over by other vehicles
2—Making Rails or the like strong enough to withstand cross over forces
3—Placing Rails or the like inside Road Channels, such that all or most of their profile is below road surface. Road Channels should be wide enough to allow movement of Pulleys and Rollers that must move inside.
4—Road Bump, with a cross section similar to a two right angled triangles facing each other, embracing the Road Channel cross section between them. Road Channel cuts along the length of the Bump. Such Bumps can be constructed using Wedge Blocks having a right angled traigle cross section. One surface of the Block resting on and touching the road surface, another surface facing the Guide or Rail almost perpendicular to the road surface and a third slanted above the road surface. Hence the two rows of Blocks on both sides of the Rail create a road Bump, along which a Road Channel runs, shielding the Rail.
5—Using Covered Sub-Surface Trenches at Crossroads and/or property entrances
6—Using those of various techniques which can more easily accommodate being run over
7—Slowing NV at crossroads not to require Rail type structures, linking to Rails off crossroads
8—Variations, combinations and permutations of disclosed techniques.

For example using Rails for most of the road but switching to Magnetic Anti Roll at Crossroads.

Multiple NV Lanes/Tracks, Created by:
More than one NV Lane or Tracks running in the same and/or different road directions
Lanes/Tracks running at the middle of the road and/or away from the Curb
Lanes and/or Tracks running above one another. Each NV Track height can be even below 120 cm.
Some Tracks can be sub-Surface, some at ground level, some above ground.

Since NV can be narrow, low profile and light, sky tracks can be cheap, simple and thinly structured not to obstruct the view. First Lane can be ground level, second at 130 cm, third at 260 cm and forth at 390 height, which is below a double decker bus.

NV Lane/Track Wall: separating it from other vehicular lanes is a good idea, as it reduces the sway allowance for other vehicles, as drivers observe a narrower distance to a wall than to a moving NV, thus more road capacity. Wall better have gaps for pedestrian or other crossings. If the wall is less transparent, and blocks all of NV to other drivers, less sway room will be used by them. So Fences and Poles are less restrictive of street view, but cause more wasted sway room. Similar points is true for a Wall between NV Lane and Sidewalk, but advantage is more Pedestrian Safety than Capacity.

Merging, Forking, Crossing & Overtaking Tracks:

Lanes can Merge and Fork just like ordinary lanes. Known techniques for merging and of forking Rails can be applied to Anti Roll and Anti Sway Ridges, Rails, Tracks, Channels, etc, collectively called Guides. Guides merge, fork and/or cross, having gaps at their Cross (X), which gaps allow any Roller, Claw, etc, (collectively called Glider here), gliding in or on the Guide to go in either direction.

Automatic or manual Driver bears the NV towards chosen direction, causing the Glider to do the same.

Another approach is to enable a section of the Guide at the Junction of Guides to have lateral movements, to Switch from one Guide to another, effectively opening one Guide and closing the other.

Switching is by motors at the Junction, controlled centrally or by approaching NV, preferably wirelessly.

Overtaking can be done via side Lane/Track or Vertically via Trenchways or Skychannel/Skypipe. Overtaking Tracks better be at NV Stops which can house them without inhibiting other traffic.

Driving NV off Lane/Track, without rolling over, is possible by:

NV being enabled to dislodge from Track and pass over any Lane/Track barriers, disclosed separately
Using Anti Roll Techniques that do not rely on Track, disclosed separately
NV Wheels that protrude from NV, say along their axis to make a wider NV, not to roll over
NV Extra Wheels that protrude off NV body when off NV Lane/Track
Support Rollers, each at the end of a Telescopic Arm that protrude and roll on the road
Road Trucks that are summoned to attach to and hold NV from rolling over
Carrier Truck that lifts NV and moves it between Tracks
Variations, permutations and or combinations of disclosed techniques.

Other Vehicles' Parking & Sidewalk Access: NV Lane/Track can be regarded as the extension of the Sidewalk. Hence parking, loading and unloading of other vehicles is doable along and besides NV Lane. Loading and unloading is difficult only if NV Track has Walls or Fences as Anti Sway or Anti Roll techniques, which can be substituted by no-wall versions.

Trenchways

In this version of the Invention, NV uses Trenches dug along roads, sidewalks and or off-road. Trench width, need not be, but can be, no more than for a Single Seat Wide NV to run inside it. Trench height need not be much more than that of a Short NV for sitting only passengers. Thus even less than 70×150 cm Trench cross section is possible, especially for Low Seat NV.

Trench Bottom's Depth can be:
Enough to provide Anti Sway, Anti Roll and or Anti Friction for NV, by Rollers on both sides of NV that roll on or close to the side walls of the Trench, hence Trench depth need only cover the lower part of NV,
Marginally more than NV height, where Trench Top is almost at road surface, to be called Surface, Trench, especially where the Trench must be Covered to allow use of surface above the Trench or other vehicles to run over the Trench Cover at crossroads or to free more of the road width for other vehicles.
Deeper underground, where necessary for shor cuts, to avoid underground structures, and or etc, Underground segments of Trenches look like Pipelines,
Negative, becoming Skypipes or Skychannels, preferably where necessary, or
Nill as in Corridors above ground, by erecting two parallel walls on the road, between which NV runs.

Height of the walls should be enough to provide Anti Sway, Anti Roll for NV.

Rollers on both sides of NV that roll on or close to Trench walls prevent NV Friction against the walls.

At crossroads, NV should switch to other techniques that allow crossing of other vehicles.

Alternatively Said walls can be removable, at least where they block traffic, by:
(a) lifting the walls enough to open for traffic when necessary, lowering for NV
(b) pivoting one end of the wall, lifting the other end, like railway bars
(c) dipping the wall into the ground
(d) sliding the wall along the length of same wall to open the blocking section of the wall
(e) swivelling the wall from away from blocking the road, swivel back for NV to pass
(f) reclining the wall onto the road and dipping it slightly into the ground for vehicle passing
(g) other known ways of removing the walls to free traffic and moving back for NV crossing

Trench cross sections can be rectangular, circular, oval etc, depending on engineering and soil needs.

Circular and oval Trench can withstand more of ground pressure than rectangular for same wall thickness, but requires more soil lifting in construction for the same NV size to run in it.

The longer each Un-Articulated Segment of NV, the wider the Trench needs to be at Turnings and Curves.

Rollers at the sides of NV, preferably near NV front, back and middle can prevent NV Sway, Tilting, Rolling and Friction with Trench walls, especially at Turnings and Curves.

Rollers can also be inserted along the Trench walls, as addition and/or substitute for NV Rollers

Trenches can be left open, be fenced or bettre Covered to prevent people or objects falling into them. Where other vehicles must run over the Trench, its Cover must withstand the load.

Cover can be and better be Removable at least in intermittent sections, to ease repairs and provide passenger escapes in case of breakdown, fire etc.

Trench Cover better be sealed or contoured to disallow rain or snow to enter.

NV Roof and Trench Cover can be both removable to allow passenger escape.

NV running inside the Trenchways can be Bus like with tires rolling over the Trench bottom.

NV can also be similar to a Tram, Train, Mono Rail, Levitating Rail, etc.

NV can surface at overground Stations or use Sub-Surface Stations.

Several Trenches can run side by side and over each other, even forking and merging. Trenchways need not run only along roads, but can criss cross the ground at many levels. Track Switching Techniques can be used to direct a NV to the desired Trench fork or merger.

A section of Trench can move laterally to disconnect from one fork and connect to the other for Switching. Trenchways can be used for the entire public transit.

Preferred Version is that NV uses over ground systems, becomes Surface Trench at crossroads and where streets are so crowded that NV width, even if tiny, is a problem. Trench may go even deeper for shortcuts. Also Skypipe or Skychannel version can be utilized where digging is not viable.

Trench construction costs and time are similar to sewage pipes, magnitudes less than Subways.

Covered Trench Lids: need not be along all trench length, but only where needed. Lids need not have hinges, but can be liftable, without hinges, manually or assisted, or even be cut to open.

Reducing Trench Air Resistance and drag: various known techniques can be used. One version
allows air to bypass NV from one sides, two sides, top and/or bottom of NV,
nose and body of NV is aerodynamically efficient,
bypassed air is directed to Trenchside channels, for less friction with NV,
bypassed air is directed to the back of NV to provide push,
and/or a combination of known techniques are used.

Multi-Channel Trenches: In many circumstances, it saves time, digging and costs if several Trechway channels are conjoined. In particular, rather than two Trenches, one going say north, the other south on the same road, making a Trench for two way traffic may be beneficial. If NVs rely on Trench walls for stability or anti roll, dividing walls between channels may be needed, but such walls are internal and far cheaper than external walls of a Trench that must resist pressure, water penetration, etc.

NV Train: NVs can be sequenced to make an NV Train. Attachments can be mechanical. But a better way is Wireless NV Coordination, so that consecutive NVs run as one NV Train. Wireless vehicle sequencing is known to the skilled, using Automatic Driving and Coordinating Software. If the Lead NV is manually driven, others should have Automatic Drivers, at least to overrule any inconsistency their own driver, if manual, may have with the Lead NV.

Snow Removal

NV Lane/Track is preferably located close to the Curb, where snow is usually piled. Some solutions are:
Plowing the snow to the middle of the street and/or away from NV Lane
Using Plow NVs to keep clearing NV Lane
Adding Plows in front of NV
Erecting permanent or temporary walls along the limits of NV Lane
Using Anti Sway and/or Anti Roll techniques which have Walls or Trenches Channels or similar Lane/Track cavities can also be cleared of snow or other debri, by NV brush and/or Plows that run inside them.

Multiple Doors per Passenger Row: Wider and One Passenger Wide NV can have more than one Door per Row, preferably one on each side, to speed simultaneous boarding & unboarding, at suitable Stops.

Narrow Vehicle Power Supply: Preferably, each NV should have its own power, using fuel, fuel cell, battery or solar. NV is much lighter and aerodynamic than buses or trams of same capacity because it can have (a) no Isle, (b) far less height as one needs to walk inside it, (c) very narrow width, requiring less elaborate springs, and (d) small wheels.

Unlike cars, it visits NTS Depots (Garages), where hydrogen and charged batteries can be supplied. Therefore many techniques not viable for heavy Buses and Trams can be used for NVs.

If grid power is preferred it can use Cables, used by Buses & Trams and Power Rails as done in Subways.

However, Cables and Power Rails should be protected from being under snow or flood by:
technique that inherently protect them such as Trenchways, Corridors, etc
cable or power rail to be high enough above ground
snow and or flood to be removed and or blocked prior to covering the cable or power rail Also, a Shield should prevent inadvertent or even deliberate contacting of cable by humans.

NV Inductive Power Supply: A good way of using grid power is Sealed Electric Coils (SEC) along NV lane, at Curbside or on the road. SEC are fed by the power grid. NVs have Coils (NVC) that get very close to SECs as NV runs or stops. SECs Induce power into NVCs, which is then preferably stored in NV Batteries. SECs better have sensors to switch on when an NVC is close by and switch off otherwise. SECs can and typically use an electro magnetic wave frequency which is harmless to nearby humans. If need be, a shield can prevent EMW from reaching humans. NV can have a shield on its body too.

Dynamic NV Scheduling: NVs are fast, automatically driven, centrally controlled, have own lane, don't interfere with other vehicles, many small NVs can be used instead of a large one, and can be added to and taken from tracks. All that enables schedules that need not be static, but dynamically changing by demand and for efficiency. Frequent NVs can stop at each Station connecting to other stops, perhaps by changing to another NV. Busier Routes can get more NVs, so that passengers do not encounter full NVs.

Automatic Driver: NVs run on well defined Lanes/Tracks. Therefore Sonar, Optical, Radio or other Sensors can be used to accurately measure NV distance from physical, visual or electromagnetic Roadmarks laid along NV Lane. Said or other Sensors can also calculate NV distance to other NVs, vehicles, obstacles, etc. Video Cameras in front, side and rear of NV can provide eyes for a Remote Manual Driver (RMD). Each RMD can drive many NVs by using Auto Drive with manual interventions as needed. NV Location can be transmitted wirelessly or by cable to a NV Auto Driver, RMD or Central Auto Driver. Said Drivers can receive relevant info from other sources such as City Traffic Control, other NVs, GPS, etc. Even when NV has to be driven off NV Lane/Track, say to avoid a blocked lane or to move to a different Lane, said info can be used to steer it. Having additional Roadmarks along other road lanes, road center, lamp posts etc, helps better off track NV locating and steering.

Whether on or off NV Lane/Track, Sensors, using Roadmarks and or usual road clues, can gauge distance between NV and other vehicles, curb, road center, lane limits, obstacles, people, etc, and also the speed of approaching each. Automatic Steering, Braking, Speeding and Driving can then use all to guide NV.

NV Stations should preferably:
be narrow, even one passenger wide, stretched along the Curb, to be least obstructive
have a by-pass NV track/lane so that NVs need not stop behind stopped ones
enable simultaneous stopping of more than one NV
have NV tracks above each other, if having them side by side slows other vehicles
have seats with direct access to each NV door for minimal passenger walk to door
have multiples of entrances, so that passengers need not walk much along the station
have lockers for portable scooters for trip's last leg
have stand for bicycle, motorbike and or tiny cars (each some 50×100 cm of floor)
have lockable cubicles for safety against suspect strangers while waiting
some cubicles and/or seats to have rugged computers for ticketing, games, websurfing, TV, etc
some cubicles to have simple showers, as users bags can hold a small towel and soap sachet
healthy food packs to buy, suitable for bag carrying and consumption in NV Above are easy steps that combined with other virtues of NV, entice passengers to prefer NV to cars.

NV Examples:
Two Seats Wide, relying on low center of gravity as anti roll for city speeds. Uses sonar position sensing and automatic steering to keep close to the curb, thus effect on other vehicles is minimal (similar to a bicycle track, unlike a bus lane). Requires no infrastructure beyond existing roads. Its Lane is usable by pedal and motor bikes. Has one slide up door for all seat rows for fast loading.
Sides and dividing center of existing highways can be used as NV Lane for city and inter city transit
A Monorail along the middle of highways can be used as NV Track for city and inter city transit

A Preferred NV Version: Single Seat Wide NV, one door per seat, using Covered Trench at road crossings, Curbside Track, Anti Sway Rail and Anti Roll Rail. Thus it can be less than 70 cm wide, run close to the Curb with little Sway, hence negligible effect on other vehicles, have fast passenger pick up and drop off, avoids traffic lights, and run fast without rolling over. By comparison, buses and trams need a 350 cm wide lane, block other vehicles, stop at traffic lights and have one or two doors and take long for passenger pick up and drop off. Even a bicycle track is wider than NV Lane, due to sway and rider's spread legs.

Explanations: Following further explain some aspects of NV & Transit System:
Scooters can be deposited by passengers in boxes or slots placed in the station/stop, or suspended from bars or poles, preferably chained.
There need not be pre positioned Stops, as the NV can stop anywhere, once NV Driver sees a passenger.
For automatic driver NVs, a passenger should be equipped by a wireless signaling device, provided when the passenger buys a ticket or is registered.
In some circumstances, NV can drive slowly so that passengers can jump on and off.
Seats are not a must. Our references to Seats is a preferred version. NV can have Standing Passengers.
NV width to be one or more seats can mean one or more persons wide, either facing NV front or side.
Many of the ideas detailed can be applied to Magnetic Levetating Trains (MagLevs) and/or Monorails.
There are a number of Anti Roll Techniques along the lines described. One group is based within the NV. Another relies on the track/lane. Within the latter, one theme is that a mechanism grabs/holds/hooks/latches/liens/ . . . into/onto the Lane/Track and/or a Rail/Wall or the like along the track/lane, which means must enable forking, merging, cross road traffic and/or use a alternative for cross roads.

Anti-Roll Hooks are another variation. Rollers Hooking to the underside of a Rail is one type. Part of the Rail's underside is raised above the road surface to enable said Rollers to Hook to said raised underside. Ditto for Roller Hooks hooking to I-Railings.
Rails should have protective means, such as being solid and strong and/or having ramps along their sides, to enable and withstand being run over by crossing vehicles.
I-Rail Claw can have fewer Rollers and/or Pulleys than described which caters to many technical issues.
Even though Anti-Roll I-Rail better have two Rails, one to keep the left side of NV and the other for the right side, it is possible to use just one I-Rail, holding bottom middle underneath the NV(between the left and right tires) to the I-Rail.
I-Railings has typically one Railing, but can have two.
There are also many variations of Anti Sway. For example, Rollers attached to NV, rolling on the vertical sides of the described Ridge(s) can help a smooth NV Ride, preventing Micro-Swaying.
Techniques introduced can be applied to non city transit, say for campus, resort, industrial plant etc.
One Lane, Track, Trench or Skypipe can be designed to fit many parallel NVs along part or all of its route, even running in opposite directions.
Propelling means can be incorporated into the Route (Track, Lane, Trench, Skypipe, Monorail, etc.) rather than on the NV. For example Conveyors or Rollers attached to the Route which move a NV to the next Roller(s), Maglev, etc can all serve as moving means.
References to Left or Right in the Description depend largely on system being left or right hand drive, if the observer is in or off the NV and which direction she is looking. So the actual meaning should be derived from overall content and words Right or Left and Errors are not supposed to limit or invalidate a described technique. Typically the observer is a passenger in the NV, facing NV's forward moving direction, in Right Hand Drive system.
NV Lane and Track are used interchangeably. Sometimes Trench and Skypipe, even conventional Rail, Monorail, Maglev or the like are also used. Route is sometimes used to encompass all. The meaning is clear from content.
Whenever NV height is used, it means its tallness, not at which height it is driving, unless otherwise clear. Low Height or Low Profile is used instead of “short” to avoid confusion with “the opposite long”.
We have suggested using Rollers to prevent friction in many situations, including I-Rails and Trenchways. Said Rollers need not actually roll, but stand ready to roll instead of allowing friction. Say in I-Rails, the Rollers under the top of the Rail can be a few mm apart fro the Rail without rolling, yet once the NV is tilted, they come in contact with the Rail to prevent NV Roll over, and roll to prevent friction.
There can be many variations to I-Rail and I-Railing themes. The idea is to have a Rail type structure fixed to the road, means for holding the NV to said structure to prevent Roll Over as the NV is moving, which Rail structure should not prevent other vehicles crossing or running over them, via a variety of means, such as being dipped below road surface into a channel, being hidden behind or between ramps, over which ramps other vehicles can run without damaging the Rail, being lifted, dug, retracted, swiveled, or otherwise removed from the path of other vehicles and then returned to use for NV.
Techniques required to make or use a part of the Invention if not elaborated are known to the skilled.
An alternative to the Steal Strip stretched on the road as part of an anti-roll techniques is steal or other magnetically attractive particles adhered over the road or embedded into the surface asphalt, concrete etc.
Lane or track switching can be done Magnetically, using magnets close to switching points to pull and/or push the NV to the desired track, lane or direction.
In many cases, such as Anti-Roll I-Rails, I Railings, Trench and Trench worthy NV, we have suggested using Rollers to prevent friction of a moving part against a Rail, Trench wall, etc. Magnetic repulsion can also be used, which magnets need not be active all the time but activated by sensors warning of friction.
One can reduce NV profile even further than the sitting as in sports car of about 120 cm, to less than 70 cm, by having the passengers lie down inside a fully reclined seat. They could rest, sleep, read, watch TV, use a suited computer, etc. This can reduce or eliminate need for Anti Roll Techniques, and enable less intrusive Skypipes or cheaper Trenches.
NV Skypipes or NVs running on Skylanes can have low profiles, even with the NV in or on them.

Therefore running them on the sides of buildings, especially between the top of the windows of one floor and the bottom of windows on the higher floor, does not obstruct windows. Such narrow structures can often be supported by said buildings, without the need for ground based support pillars. They can have stops at higher levels, say at an office tower's third floor, or descend to ground for loading/onloading. They can run between adjacent buildings or across roads, straight (or arched for better support) without being much of an eyesore. While a conventional fly over for a bus or train is ugly and seriously obstructive to view, a narrow and low profile pipe does not, and can even be decorated or be a decorative structure. Historical cities have many arches crossing over their lanes and streets, adding to their aesthetics.
NV Train, composed of a sequence of NVs attached mechanically or better just running in tandem using coordinated automatic drivers need not remain assembled for the length of a route. Some NVs in the sequence can be switched to different lane, usually at a Stop or Station, even not stopping at such stop/station. Then NVs remaining on each track/lane or lane can resequence/reassemble to form new NV trains. This is easier with NVs that are connected wirelessly, but any mechanical connections should be enabled to disconnect from and reconnect to a next NV, upon signals from manual or auto drivers.
NVs locations within the network can be easily known to a computer. Sensors can detect which seats or cabins are empty, on which NV (of a sequence of NVs forming an NV Train). Thus a Stop can show waiting passengers via a screen or passengers own computers where to wait in line for quicker boarding.
One approach is that a tiny light is lit, on a railing or ceiling besides and along the lane/track, such that when the next NV or NV Train stops, a person close to a lit light will be closest to an empty seat.
There are a number of techniques to establish the location of each NV. One is RFID Tags & RFID Readers along the network. GPS is another. Other types of sensors along each track can be employed.
One location to run NV Lanes or Tracks is along the line between car lanes. This enables reducing the width of each car lane, as cars are not running aside other cars, thus need narrower lanes to avoid collision with a car running to their side. Stops can be allocated between same car lanes, or NV can use a spur line, preferably Trench or Skylane not to obstruct the car lane, to stop at a sidewalk or other stop.
One way of reducing air resistance for NV moving inside a Trench is letting the air escape the Trench. Trench can be without a Lid or Lid can be perforated. To avoid rain and snow enter yet allowing the air exit the Trench, one technique is the Lid to be solid (not perforated), vents are placed along the joint between Trench wall and the Lid. The Lid is curved, slanted and/or contoured to run water off itself and into a channel or duct running along the Trench, below the Lid, and lead to the water disposal or sewage system.
Destination Grouping: Screens in a Stop can advise waiting passengers which section of NV to board, depending on their destination, so that some sections (equivalent to a train wagon) will become empty at a later stop and decommissioned or taken out of NV Train, as disclosed before.
NV Track/Lane Width: is what determines intrusion into other vehicles path. So a very narrow vehicle with wide sway can be more intrusive than a wider vehicle with limited sway.
Some Locations for NV Lanes/Tracks: There are many locations, apart from described ones, such as besides or on top of the crash bars in the middle of &/the extreme limits of streets, roads, highways.

Prior Art Deficiencies:

Every prior art lacks a number of key elements listed under “Some of NV & System's Advantages” and “PPT Features Table”. Deficiencies of prior art are much more profound when multiple elements missing. It is easy to check all the deficiencies of any prior art against said advantages and features. Hence the purpose of NV & System is to have a Transit System with most of the advantages of both Private and Public Systems, few if any of their disadvantages, plus more.

Some Ticketing Techniques:
Ticketing: Controlling passenger payment can be done in the Stop and or NV Cabin.
In Stop Control requires tickets to enter and or exit the Boarding Halls of the Stop. Sidewalk Stops need be blocked also at their road side where NV stops, when no NV at the Stop, to be opened only when a NV stops there, and only to the extent needed for boarding and unboarding.
Cabin Entry Control requires Cabin door to open by scanning/reading a ticket. This can lengthen boarding time, especially if a number of passengers are using same Cabin or Entrance.
In Cabin Control: is preferred. Each passenger enters or shows her ticket to ticket reader/scanner, keys in her ticket code, scans her fingerprint, palm, iris, face, etc. Software can detect if they have paid.
Camera Control: One technique that can be used In Cabin uses Cameras that scan faces and using current Face Recognition Technologies, to count the number who are in each Cabin and calculate how many in each Cabin have not paid. Then the system can alert the security at the next stop to deal with unpaid passengers. Cameras can also take Face Recognition Data (FRD), typically a number of points on ones face and distance between them, say distance between centers of eyes, of all in the Cabin passengers, check with FRD of those who have paid, recorded at Payment Point of, or at point of checking in, and find out FRD of those who have not paid, for remedial action, such as black-listing until they pay for use and a penalty for adding to control and collection costs.

Said Payment Point can include a Passenger's Computer or Cell Phone, using its Camera to transmit FRD to Transit Ticketing.

Said techniques can be modified for Controls at Stop Entry, at NV Boarding and or Exit too.

If Exit or Distance on the NV is to be checked for payment, similar contorts may be applied at Destination.

NV Rail Rattle Reduction

NVs, Trains, etc. running on Rails typically rattle when running over the Gap between two Rail Beams. Some attempts have been made to seal or narrow said Gap needed to absorb Beam expansion due to heat. Conventional Gaps are perpendicular to the Beam and have a length equal to Beam width.

The wheel runs on the Beam, then reaches the end of a Beam abutting the Gap, dips into the Gap, hits an end of the next Beam abutting same Gap, which cause rattles as the wheel runs over and across a Gap. Our solution is that each Gap has an angle with the Beam and hence is much longer than the Beam width. Thus a wheel running over the Gap will never dip into the Gap to make noise. The wheel is constantly supported by Beams on either side of the Gap, never dips into the Gap.

(Personal) NV Car

One major problem with public transit is that people dislike walking to the station, especially in bad weather, with luggage, in a rush and or for daily commute. This application introduces a Car which is also an NV, hence can join NV Routes (Lane, Track, Trench, Skypipe, Rial, Monorail, Maglev, etc), so can be used as a Car, especially locally and or from Origin say home to NV Route and then off NV to Destination, say work.

We have already mentioned that NV can:
have as few as one Rows of Passengers
use NV based, Anti-Roll Techniques, independent of NV Track/Lane (can move off Lane/Track)
have and typically has road worthy Tires
merge to and fork off the Lane/Track
have its own power and propelling means
use power provided by the Lane/Track, such as Induction So a properly equipped NV can be a Car too, but with many advantages, due to petite size, non driving (on Lane/Track) mode and environmental savings.

A one passenger wide & long NV, or single Cabin NV, can be less than 60 cm wide×90 cm long×150 cm tall, and be driven into a home (no need for garage), elevator, office, shop, theater, etc. Even buses, trains and planes can be modified to receive them. So larger cars simply deprive the user of end to end transit and necessitate walking to/from parking. A two seat long NV with reclining seats can be used by one passenger to sleep in, while on Track not driving. A two person wide NV, can be narrower than 100 cm, stable, yet narrow enough for NV advantages. A 2 wide×2 long NV carries a family. With reclining seats enables two to sleep in. A three seat long NV houses a couple and a child or a sitting and a sleeping passenger. A 2×3 carries a group or can be a pick up truck.

Sleeping capacity enables one to drive from home onto a normal road, join a NV Lane/Track intra city, then join a conventional or NV intercity transport, use the NV as a Car, Office, even Bed in destination City, and be back. Sleeping capacity and wireless computer provide for home and work space for a person or couple. So one NV Car can be a Car, Office, Temporary Home/Bed, etc. Parking and Shower can be found in community centers and terminals, and can be offered by gas stations, malls, campsites, etc. A Trailer can fit a toilet, shower as sat on toilet, mini-oven, mini-fridge and more, all within a NV size.

When off NV Lane/Track, NV Car can use Anti-Roll means which increase its width beyond that of Lane/Track, to enable higher speeds. One such means is one or more Anti Roll Arms, pivotably attached to NV sides at Arm's base, with a Roller at the other end of the Arm. Said Arm pivots to place the Roller a distant from NV, rolling on or just above ground. Thus too much tilting of NV is prevented. Pivoting said Arm to and away from NV can be automatic or manual (preferably operated from inside the NV).

NV Car can Join NV Lane/Track, in or out of the NV Stop, using merging and forking techniques described. It can also drive from a NV Stop Platform onto a Carrier NV, if NV Car length is short enough. If NV car is too long for said purpose, Platform should provide for maneuvering NV Car onto it.

A preferred way for NV Car to move from a Platform onto a Carrier NV is for NV Car to have wheels that turn to right angle, enabling sideways moving.

NV Car should have Steering Means for off Track driving. A preferred version is a Steering Handle, instead of Steering Wheel, to be less obstructive, fits in any location inside NV, does not increase NV length, does not use up (fold up) desk room in front of the driver, who is a passenger when NV is on Track.

NV Car should have breaks and be otherwise road worthy, but need not be too elaborate, as driving only short local distances can be at low speed, requiring less roll over and crash protection.

If Track is a Railway NV Car should be suitably equipped. It should have Wheels in addition to Tires. Said wheels should retract when off Rail, not to damage the road. A Preferred solution is a Tire Wheel combination. Each tire has a rubber section for the road and a metal section for Rail. Preferably, rubber section is in two parts sandwiching the metal wheel.

NV Car better have Fender, preferably rubber like, to smooth hitting the front and/or rear NV Car, while on Track/Lane, if the automatic driving does not function properly. NV Car can have Pedal or Manual Propeller Means, that may be sufficient for local driving. NV Cars can be parked in a number of depots to be used by any subscriber, then left at a depot for others.

Many methods of ticketing can be employed to charge the passengers. Electronic tickets, such as RFID or other tags, read magnetically, optically or otherwise, can be used to enter and or exit a Station and or an NV. Thus the distance and class of trip is calculated and charged to prepaid ticket, card or account.

NV Car Add-Ons:

NV Car designed for the last leg of Transit can be very limited in fuel capacity, engine power, safety features, etc., as for high speeds and long distances, it can rely on Lane/Track for power (s.a. induction power source), propelling (s.a. being on another NV Flatbed), anti-roll (s.a. I-Rail) and safety (s.a. Auto driver preventing crash with front or rear NV and/or Track & Lane preventing contact with other road vehicles).

To use NV Car as an independent automobile, for long distances off Lane/Track, one solution is to provide it with more fuel, power and safety features. Such features add to weight, consumption and cost, even on Lane/Track.

A Preferred solution is to use add-on capabilities, some being:
Add-on Fuel, being battery, petrol, diesel, LPG, liquid, hydrogen, etc, depending on engine type, even compressed air or nitrogen to be heated to release energy. Cartridge(s) are preferred.
Add-on Engine, which is liftable by a person or equipped with rollers, to get close to and attached to preferably front or rear of NV Car. It can be small enough for a small lady to handle. Power transmission from add-on Engine to NV Car can be by gears or other means. One Preferred option is that the NV Car is equipped with hydraulic mobility, so that the engine causes oil pressure in a tank, which pressure is transmitted hydraulically to wheels. In such case, add-on engine need only be connected to NV Car via a hydraulic hose to add to compression capacity.
Add-on Anti-Roll mechanisms, such as Anti-Roll Wings, attached to NV Car, having Rollers at their unattached end and rolling on or just above road surface, to prevent NV Car tilting. Said Wing Rollers can be manually or automatically kept close or away from NV Car Body, depending on speed and road conditions. A controller can detect speed and relevant road variables and adjust the Wings, widest for better anti-roll protection, narrowest to allow the NV Car to fit in small spaces, for parking or for maneuvering between vehicles, like a bike.
Add-on Upset Protection Bars, to protect passengers in case NV Car turns upside down.
Add-on Collision Fenders, attached to NV Car's front and/or rear. Preferred is Elastomer Fenders.
Also Air Bag Fenders that inflate upon detecting pending collision by radar, sonar, laser, etc.
Ditto, add-on NV Car Sides Fenders.
Add-on Passenger Air Bags, inside NV Car, for front, side, rear and/or upset protection.
Add-on Passenger Room, towed to NV Car rear. Front stowage is possible if passenger seat is low enough not to inhibit driver's view. Even side seats are possible, as in motor cycle side cars.
Add-on Trailer, which is mechanically attached to NV Car.
Add-on, Cable or Wireless Trailer. It has its own propelling means, but its Auto Driver is controlled by the NV Car to follow the same path as NV Car, with a short, fixed or variable distance.

Each of above can be one or more, say more than one add-on Engine, say one for each tire.

A number of above can be combined into one add-on unit. In particular, Fuel, Engine, Anti-Roll Wings and Fenders can all be combined.

Said add-ons should be designed for easy attaching to and detaching from NV Car. They better have rubber or other paddings at points of attachment to reduce noise, vibration and wear. Add-ons can be carried by NV Car, used when needed. Say add-on Engine can be turned on and off. The overall idea is a Modular, Integrable and Disintegrable Transport Vehicle. Techniques to make said add-ons and their attachments to NV car known to the Skilled.

Improvements to NV Car: Any number of following will provide better utility for NV Car. They can be applied to other vehicles too. Techniques for implementing them are known to the skilled.
A Steering Handle that can be on Driver's side or front, instead of steering wheels which are awkwardly placed, takes much room, inhibits driver movement, entry and exit, dangerous in a crash, etc.
A preferably thin small electronic control board, which can be placed anywhere, even movably, instead of a Dashboard.
Windshield to be retractable or removable, so that Driver's face is open to the outside.
Even the top of NV Car to tilt open or be removable, for an Open Top NV Car.
Transparent Laptop Desk in front of Driver that when tilted up for stowage does not block side view.
Many components inside NV Car to be placed behind or to the sides of Driver to clear the front.
Even the rearmost Seat to be Reclinable for sleeping, even if sticking out of NV Car when reclined.
An Acardeon or similar Extension to NV Car's Roof, can cover the reclined rearmost seat.
A front panel added to the Seat, which is vertical between the NV Car floor and the edge of the Seat, but tilts to become horizontal and fixed to hold a persons lower legs in sleeping position.

Such an NV Car, especially the one seater version, can be used at home as a chair, say in open top mode, have a laptop tray, move from room to room to kitchen, turn into a bed, move to the street for local transit, enter a restaurant, even to a table and used as ones chair, no need to park outside, use Public NV Lane/Track, move onto a NV Rail/Bus flat bed or bus or even a suitably designed larger car, enter elevators, offices, be used as an office cubicle, drive on sidewalks at low speed, be parked in very small spots, etc.

NV Car Nose &/Tail Door(s)

To enable a entry to NV Car from Nose, a number of following can be done, most suggested already.
using a handle by Driver's side for steering
placing most of instruments and other gadgets traditionally positioned in front of the front seat(s), away from the dashboard position, say on the floor(especially for brakes) or on poles and/or pods with their base supported by NV Car floor, sides, etc, which poles/pads hold the instrument panel and/or other gadgets, etc on their top (non-base end), preferably capable of being pushed aside
laptop tray to be stowable away, say fold up or down to NV Car side
no dashboard in the conventional sense Thus NV Car can have an entry at its Front/Nose.

Ditto for a Tail Entrance. Rear seat(s) back can be attached to and move with Tail Door to open entry. Said Back (Support) can also be folded down, towards the roof, to the side, etc, to allow entry. To open, Nose or Tail doors can use any of lift, swing, slide up, slide aside or other mechanisms. One advantage is parking in very tight spots.

NV Car-Air Vents

To help NV Car be simpler and narrower, one technique is to install Air Vents, rather than side window pull up and down which is complicated and widens the car. Thus side doors and windows can be very thin. Vents can be installed in front of NV Car, on roof, on side doors, preferably below side window, at rear etc. Air Vents can be designed with controls for air amount, (even more than a window), noise and direction, say towards a persons body or feet, and away from any unwilling person. Said features are all lacking in conventional pull down windows. Even side windows that tilt open lack many of said features. Air Vents can be used in other vehicles too. Conventional dashboard airvents are too small, not controllable by rear passengers, only let in hot air if the heater is on, hence no substitute for a window.

NV Car Lanes/Tracks: NV Car need not have multiple stops for loading and unloading. So its Lane/Track's preferred location is not necessarily adjacent to the Curb. Other good locations are between road lanes, also serving as a barrier between lanes. Said barrier can be crossed by Non-NV Cars, to change lane. NV Car can move onto the Curbside Lane/Track, then unattach itself and move onto a road lane, then reattach itself to an NV Lane/Track laid between said lane and an adjacent lane, and so on as it speeds up, do the reverse as it speeds down to stop.

NV Car Elaborations:
NV Car Concept-General Applications: Most techniques and concepts are applicable to most vehicles.
NV &/NV Car: are used interchangeably in many instances. The related sentences either apply to both or is the meaning is clear from the context. In fact NV Car is an NV anyway.
Tall NV Car: can be made for stanging passenger(s) and driver, for short distance use, say until it hops unto another carrier, so that more of them fit in elevators, homes, offices, buses, trams, etc.
NV Car formations: NV Cars can run in sequence, or side by side or both, say 2×3, to simulate a group or family drive. Synchronized Auto Drive can be used.
Eliminating NV Differential: One method of reducing NV height is to use power transmission systems that do not rely on Differential, such as electric cars which have a motor for a number of wheels, etc. Most components can be slimmed, but conventional differentials need a vertical flywheel.
NV Underside Rollers: Low Road Clearance is one tool for a Low Height NV. This may cause NV underside to be caught over road bumps or when NV wheels dip into a road cavity. One solution is to distribute Rolles across NV Underside, in critical positions, say ahead of lower parts and or important parts. Underside Rollers are idle, not connected to transmission, preferably rubber rimmed and preferably connected to the underside via a short Spring. NV Underside should have structural design and strength to support each Roller, assuming that over a bumper, much, perhaps all of NV weight will be on one or few Rollers, for example, beams across NV width &/length of NV underside, along which Rollers are installed. Techniques disclosed here can be used to make other Low Profile Vehicles, such as Low Height Cars, Vans, Pick-Ups, Buses, Trucks, Tams, Tains, etc. Pallets, Containers and other items carried by them should also be low profile.
Safety Flag: A low profile NV Car may be less visible to other vehicles posing a risk. Raising a visible flag above it, preferably on a flexible and or telescopic or otherwise mast with controllable length, will subtartially increase visibility, yet fit in low profile locations, such as inside a carrier or a shallow covered Trench when joining a Public NTVS.
NV Car carried by NV Train/Bus: The Flatbed(s) of NV Bus/Train that are too narrow to carry NV Cars parked on them sideways can use Swivel Trays, which are positioned on the Flatbed sideways (Trays length is perpendicular to Flatbed's length). NV Car drives headways form a Stop platform onto a Tray (Tray & Car lengths are in same direction), then the Tray is swivelled manually or automatically to have its length in same direction as Flatbed direction), thus a long NV Car can be parked lengthwise on a Flatbed, so that the NV Bus/Train to which the Flatbed is attached can be overall narrow and can run through narrow tracks and Trenches. There is no need for said Trays if all riding NV Cars have side drive wheels to drive sideways and park on the Flatbed facing parallel to its length.
Low Profile Large Wheel Vehicles: It is not necessary to rely on small wheels to reduce vehicle height. Chasie can be lowered as necessary, even if the wheels, even differential is large, as known to skilled.
Racing Car Height NV & Car: Can be less much than 120 cm tall, but long enough for a tall Driver/Passenger, enabling sleeping half stretched, even without reclining the seat, laptop working, very low profile Trenches, almost the size of sewage pipes, and pipelike Skylines which can cross or arch ornamentally between buildings and across streets, without blocking the view.
NVRoof Door: It is much easier to enter and exit a Low Profile NV if it Open Top, sa one Verion. This may not be practical in cold rainy weather and unsafe for children and in Trenches. So NV Door can open from both Side and Roof. Roof Door can extend across some or all of the NV width. One way is to have a Door that bends on top to form part of the roof. Depending on NV body design, such a Door may require to have a design to enable it to open. Some of many ways to achieve this are:
(a) Door is lifted by its Hinges that are of the type that lift the door as opening,
(b) Door has an almost quarter circular rim across the NV roof, enabling it to swivel easily, but when open, the roof is opened the shape of an almost quarter circle, not a rectangle, which is somewhat more difficult to enter and exit than the roof opening a full rectangle,
(c) Door is hinged on its rear edged instead of customary front edge, if that suits the swivel better,
(d) Door is split in two, or two doors, one opening NV Side, the other NV Roof,
(e) Sliding Doors, as in some Vans
(f) Gull wing Doors, or
(g) Other designs known to the skilled.

Remote Controlled Vehicle

RCV is another concept,which can be used say be a mother, sending her child to say school. RCV location is known by GPS, Triangulation with known towers or other installed electromagnetic landmarks, Digital tracking of its route and comparing it with a memory stored map of the area, etc. Mother and child have videophone communication. Mother can see RCV's surrounding vai video cameras installed on RCV or subscribing to road video cams network. Mother can park the RCV in a safe location, remotely unlock the RCV door, which can intruder proof, and follow her child to inside of school, and back, without leaving work or home, only sporadic supervision of RCV, who can be on Auto Drive most times.

Solid Wheels/Tires:

Air tires are far less efficient than solid ones such as rail wheels, due to friction, drag and energy required for their constant change of shape. They also occupy much more space. Their advantage is absorbing noise and vibration.

Problem with conventional low or no air wheels, using air, rubber or metal springs to dampen noise and vibration, that the spring or shaft connecting the wheel to vehicle body is never isolated from said body. Springs and rubber isolators do not provide sufficient isolation, transfer noise and vibration.

To have the efficiency small size of a solid or low air wheel/tire plus absorbing properties of air, air inflated rubber balls (not necessarily spherical, any hollow air holding body) should be placed at every point where the wheel, shaft, coil or telescopic spring or other means of connecting the wheel to vehicle is likely to contact said body. Inflated rubber balls spread vibration and noise inside their air volume and are much better than rubber pads and metal springs.

Thus an NV can have metal wheels, covered by a rubber ring if necessary to avoid road damage, with very little or no air. Said wheel is connected to NV via coil, telescope or other means, which means are separated by rubber balls at all points of contact with NV Body. Trains buffered from their wheels by said airballs will have much less rail noise and vibration transmitted to their passengers. Said Airball buffers can have universal applications.

Lasting & Low Cost NV Car

To reduce NV Car costs, Depreciation and Repairs should be reduced. Some conventional methods are:
rust resistant body
dent resistant body
electric or fuel cell engines,
non wearing brakes, such as hydraulic or magnetic types, no pad or drum change,
brakes that recover the energy in slow down to use in speed up.

Above are not sufficient, because most are rarely used, and a car gets old or undesirable for other factors, especially by odor, wornout seats, dirty seats despite surface washing, scratched body, fainted paint, etc. So some or all following techniques need be added, so that what gets old can be changed, rather than changing the whole car and many repairs can be done cheaply by a layman, to include laywoman:
carpeting, to be fully removable, washable off the car and replaceable, say snap off and on by laymen, not glued, not requiring experts and repair shop equipment, not surface washing as installed which hides most dirt inside,
carpeting to be non absorbent, such as rubber, not to hold dirt, moisture and odors,
seats foam, padding and cloth to be removable, washable off the car, replaceable, by laymen, say as a pull over to the seat body,
seat covers that are home washable, easily removable and pulled over the seat,
inside roof and side paddings that are removable and replaceable, preferably snap on & off,
instrument panel(s) which is hose washable, such as enclosed panels with surface touch keys,
open close drains at the bottom of the Car to enable hose washing, especially after snap removing absorbent panels, pads, seat padding, seat covers, etc,
avoiding stain proof seats and carpets that do not work, at least for long, despite what advertised,
modular exterior body, some or all modules or panels attached to and removable from a hidden interior body skeleton, by screws or preferably snap on /off, which panels are not welded to each other, so that panels can be replaced by a layman, (unlike conventional cars that use said panels as the skeleton welded together to need cutting and welding to replace),
some or all of panel attachments of said skeleton that harbor a panel, to be able to attach to panels of different exterior contour, so that car's external design can be changed by changing body panels,
modular design for most components, such as skeleton, engine, transmission, accessories, each module to be replaceable, preferably by layman, preferably by snap on off means,
any replaceable items such as air and oil filter, cartridge type and placed accessibly for laymen,
thin, preferably sub-millimeter, rigid layers of prepainted self adhesive plates, contoured exactly like a body panel, that can be adhered onto a whole or part of a body panel, rather than repairing or repainting or scratch removing such panel,
steering to be Joystick version, preferably based on the car floor or consul, not dashboard based,
Instrument panel to be on a pole or consul supported by car floor, not dashboard,
Heat/Cool Vents to be raising from car floor or consul, not dashboard,
Glovebox to be in front of seat(s), say opening between passenger/driver legs, or on consul,
Eliminating the Dashboard, using above techniques,
Attaching brake and indicator lights to chasie rather than body panels,
Windshield can be on a support erected on the chasie, not to rely on body panels,
Wipers and side mirrors can be attached to same windshield support or other chasie based support,
Making the car road worthy, with seats only, no body panels, using above techniques,
Body panels to be mainly for rain protection and ornamental, liftable on a sunny day,
Thus the body can be changed, in part or in whole to meet taste and fashion,
applying some or all above, reducing element to cause obsolscene, while much of the car is intact,
various combinations of above conventional and new techniques.

Sudden (Emergency) Brake:

NV Car, being small yet potentially fast, needs good safety features. Conventional Brakes require a minimum distance to stop a vehicle because road friction is limited. Sudden Brake can be used in other vehicles too. Ability to brake at a desired distance, independent of road friction, enables cars to drive faster and closer to a front vehicle, substantially increasing road capacity, especially for Narrow Vehicles, more so if Automatic Drivers are used to drive vehicles closer to side vehicles.

Sudden Brake has a Gun that can eject an Arrow at very high speed. The Gun is powered by gunpowder, compressed air, compressed spring, etc. Said Gun is firmly attached to NV Car, facing towards the road surface. Said Arrow is attached to one End of a strong Cable, made of say steel chain or wires, kevlar, etc. When the Gun is fired, said Arrow is ejected into the Road, digging with it Cable's Arrow End. The Arrow and/or Cable's Arrow End are constructed to easily enter into the road material, but once entered cannot be easily pulled out. The other End of said cable is firmly attached to NV Car, preferably to its underside, preferably rear end. Once Arrow is fixed into the road, the Cable stretches out of NV Car, until fully stretched, stopping NV Car. Said Cable runs via a Smoothing Brake (distinct from NV Brakes) to smooth its stretching. Said Brake can use various techniques, some being:
Applying Friction to the Cable
Reeling the Cable around a Reel which turns to release the Cable, turning is controlled by a Brake
Said Brakes can Friction type operated by cable, air, hydraulic, electronic, etc.
Preferably Said Brakes can use Hydraulic (Liquid, typically Oil) Resistance instead of Friction
Other Braking systems

Hydraulic Resistance can be made more effective and controllable by mixing or suspending conductive particles, such as powdered iron in their Resistive Liquid. Applying an electric charge to said Liquid increases its viscosity and Resistance, depending on the charge.

Said Gun can be activated by a number of means, some being:
The Driver, say when she feels NV Brakes are not adequate
A passenger, say if Driver has fainted
Automatically, say if the NV Brakes are applied beyond a predetermined intensity
Automatically, by an Intelligent Sudden Brake Control

One Intelligent Sudden Brake Control (ISBC) is introduced here. It uses Sonar, Laser, Radar, Infra Red or other Surveillance, known to the skilled, to measure and calculate how fast NV Car is approaching an obstacle, such as a car in front. It can be equipped or programmed to also measure how fast the obstacle such as a crossing bicycle is moving across the road, and measure if it will clear NV Car path before a collision. It can have means to measure if the obstacle is an animal, by sensing its body heat or heart beat. It can have means to check how many in NV Car are wearing seat belts, even child seat belts. Based on all such measurements, ISBC decides when to fire the Gun. Say no fire if time for Driver action. Smoothing Brake Force should be enough to stop NV Car before hitting the Obstacle. If seat belts are on, Smoothing Brake can be activated later but with more Force, as less risk of throwing passengers forward. Various Algorithms can be devised as to if, when and how strongly to apply the Sudden Brake.

Superior Cheaper Railroads:

As briefly mentioned before, Anti-Roll and/or Anti-Sway Techniques described here enable construction of much cheaper yet better railroads. Conventional Railroads require perfect leveling of both of their parallel rails to prevent roll over. That necessitates good foundations for each rail plus numerous strong wooden or metal ties laid over supper compressed gravel, supporting and connecting both rails at numerous points along the track. Making wide tracks is prohibitively expensive, requiring longer and thicker ties, wider foundation and doubling of compressed gravel bed. Therefore tracks are much narrower than the train, ironically making trains less stable. Rails have to be supper strong too, as otherwise, one rail can bend downward at a point where the parallel rail is not dipped, causing the train to tilt. Thus the rail has to be like a small wall to resist bending, keeping it upright requires supper strong harnessing to the underlying ties.

This application introduces rails which are independent of the parallel one, not connected by ties. Parallel rails can be much wider apart, each on it own bed, allowing much wider apart wheels for opposite side of the train, making the train much more stable. Therefore train is not likely to roll over even if parallel rails are not fully level at every point. This enables more flat, less upright rails, requiring weaker harnessing and less foundation under each rail.

Anti-Sway techniques keep the train on the rail, even if the train wheel is not a pulley on an I-Beam. So the rail can be a Strip or other shapes, cheaper to make and support on the ground, even without ties, compared to a beam. Train wheel can have many other shapes too. Anti-Sway means do not require superstrong foundation, ties, etc.

Anti-Roll Techniques, which by themselves are not load bearing and do not require superstrong foundation, bed, ties, etc, but prevent the train from rolling. Hence all the superstrong features explained to avoid train rolling over can be much relaxed, all leading to much cheaper railway.

As an example, a I-Beam which also acts as the I-Rail for Anti-Roll prevents the train from rolling over, even if the trains tilts, even at high speed, so long as the I-Beam itself is not totally lifted high off the ground, under tilting pull from the train. Such pull is less than conventional trains on conventional rails, because in or system the train can be one much wider base and less likely to tilt. Also roll over due to rail being lifted is is highly unlikely, as all of the length of the beam cannot be lifted, and the train passes the lifted point before it has time to roll over. The I-Beam (I-Rail) need only be strong enough not to tear due to undue lifting by train tilting.

Therefore low profile and wider parallel I-Beams can be stretched on relatively solid bed, each on its own bed, no connecting ties, no superstrong foundation, no superstrong harnesses. Beding of the beams can be tolerated to some degree, repaired when beyond tolerance.

One method of straightening a bent down rail is to inject a hardening compound such as concrete under it at the point of concave.

Freight/Cargo/Parcel Ways

Techniques introduced here can also be used for Freight transportation intra-city, inter-city, inter campus, resort, plant, etc. Often no need to redesign the City et al but as an aftermath to existing ones.

Freight of Parcels and or Cargo (we will use either to mean both unless specified) provide some relaxed requirements compared to People Transit, such as:
Parcels can be designed to fit a smaller space than a person can
Less rush and time sensitivity, as most parcels need not arrive for work by a set time every time
Sequence of loading and arrival is not an issue
Aggregation is acceptable, parcels can wait in a transfer station
Safety issues are minimal and no health issues, even if a parcel is stuck for long
Speed is not crucial, as parcels do not get bored when moved slowly
Heating, Cooling, Lighting, Seatbelts, Seating, Luggage Room, . . . are not issues
Curbside running is as much an advantage as it is with passenger NV

Due to so many relaxing points, Parcelways and Narrow Freight Vehicle (NFV) can be designed very small in width, diameter, profile, say only to handle small packages such as mail or as large as needed. An NFV 60 cm wide×150 cm tall (equivalent to a one person wide NV)×300 cm long (suitable for curved Trenches) can carry almost as much as a pick up truck. A 120 cm wide NFV (more than two person wide) by 120 cm profile can carry standard cargo skids. It can also run at low speeds. Thus simple Anti-Roll Techniques in the NFV, without any I-Rial or similar Route Based Anti-Roll technique are enough.

A very large proportion, perhaps 95% of city cargo is or can be broken down into sizes to fit in an NFV. NFV can be a Passenger NV which also handles Freight. NVF Route can be NV's or different.

A preferred location for NFV Route is a Trechway close to surface of Sidewalk adjacent to Buildings (away from vehicles pavement), at least for its Pick-up or Loading Stops, crossing the roads when needed. NFV Route can run overland to save Trenching where space is available, in particular running through the mid road isle dividing opposing directions of traffic, even over the crash bars along said isle. Parcels and or Containers better be Weather Proof, Shock Proof, Vandal Proof, Theft Proof, Tamper Proof, etc., as necessary, depending if containerized, overland and accessible to unauthorized, etc. Each NFVs can have one or more Flatbeds (as in railway cars) on which Cargo or Containers are placed. Some or all NFV Sections can be like a Container in which the Cargo is placed.

One useful device is Roller Trays on which Parcels or Skids are placed to ease moving, especially on and off the Flatbed or Container. Alternatively Skids or parcels can be equipped with Rollers.

Said NFVs, Flatbeds, Containers and or Roller Trays better be standardized like Freight Containers. Emptied ones can be sent back, perhaps via NFV to Operator and reused as an asset, rarely disposed. Containers and Roller Trays can have their own propelling means, even controlled automatically, even remotely. They can be of different different sized.

A Preferred NFV is also a Container or Flatbed, preferably in many sizes, so that different parcels can be placed on different NFV and each sent to their own destination. Large loads can be broken to Container/Flatbed chunks, each on one NFV, but all addressed to same destination.

Each Parcel, Flatbed, Container, NFV can be Tagged, preferably RFID or Optially Readable, for Routing, Sorting, Storage, Retrieval, etc. RFID and or Optical Readers along the Route can read said Tags to Direct. Charging by parcel weight, size, travel length, speed of delivery, origin, destination, etc can be automated as all info is available.

Freightways Loading/Unloading/Spurs & Stops

To move a Parcel or Container off a Flatbed or Container onto a Stop or Station Platform, many techniques including manual and conventional ones can be used. Rollers and or Conveyors on the Flatbed/Container, Rollers, Conveyors, Kickers and/or Suctions or Pullers in the Platform can move a Load or Tray onto a Platform or the opposite, from Platform into/onto NFV.

Stops can be in suitable locations, say at large buildings or plants. Small entities can have their own Stop. One Preferred version is that Freightway Trench runs along the built side of Sidewalk (away from vehicle pavement). Each building or Recipient has a Platform by the side of the Trench. Platforms are Tagged and electronically or optically identifiable. NFV Control thus knows it is reaching a Platforms, stops by the Platform and shifts a Parcel addressed to said Recipient onto said Platform. Recipient then picks it up, by opening a Platform Lid. Trench Lids need not be accessible by Recipient or anyone other than an Authority, the Platform Lid can be accessed only by the Recipient.

Roller Trays and Containers better have Rollers that turn at right angles to direction of NFV movement, for easier loading to the Platform from a Flatbed or vice versa.

Trench Platforms can have a Jack or other means of lifting the Parcel, Container or Tray deposited on them up and above ground for easier access and unloading.

Other variations are possible too. A Container is put on an NV Flatbed, addressed to a Recipient. It stops at a Stop close to Recipient, where the Container Rolls itself off the Flatbed, onto the Sidewalk. Recipient is automatically alerted of its arrival, who can then pick it up and continue Auto Rolling it to destination. Once emptied, Container is returned to the Stop and programmed to Roll onto an NV for return to its Origin or Freight Operator. In fact a Container or Roller Tray can be programmed to run the last leg all by itself, provided it is equipped with auto driving technology, most of which depend on roads being landmarked and or otherwise traceable by auto drive. Such technologies are developed or within reach of current art, some not perfected yet.
CargoWays: can be build narrow and low profile, hence can bridge or arch between buildings, above ground, without being an eyesore.
NFV Battery Charging: Can be done in same manners as described for NVs, at a Station, Transfer Station, Destination, Origin, on Track/Lane by Induction or Contact with a power source.
Interplay between Cargo & Passenger NVs: Depending on circumstances, different rules should govern. Generally, a Cargo NV or NV Container should yield to Passenger NV, especially when using the same track, to go fast enough not to stop or slow a Passenger NV.
CargoWay+NV Trench Combo: CargoWays can form the bottom or preferably the top layer of a Trenchway which is deeper to house said layer, hence some savings in construction time and costs compared with digging two Trenches, one for people and another for Cargo. At Pople Stops, if the Passenger NV needs to exit the Trench to surface, the Cargo layer should deviate or fork away and perhaps rejoin after the Stop.

Generalizations, throughout this application, unless expressed otherwise:
when a number of techniques are disclosed to achieve a result, isolated and viable combinations, permutations and or equivalent(s) of each and all are also included within range of such techniques
many of techniques, are also applicable to current vehicles (cars, vans, buses, trucks, trams, trains, even airplanes, etc)
many techniques are applicable to Conventional Transit Systems too
many techniques disclosed, even if appear for “intra city” can also be applied for “inter city” Transit
Curb is used to mean the limit of the driveable part of a road, even if the road has no visible curb
each significant word, has the meaning which extends and does not limit coverage
Best Modes: Wherever appropriate, best mode(s) for relevant techniques have been mentioned. In many cases the best mode depends on circumstance. No prefixed best mode to pinpoint.
Conventional Techniques: known to the skilled, other than those mentioned in this application, can be used to achieve some of the discussed desired aims. Also they could be used in conjunction with novel techniques disclosed. The clause “combinations and or permutations of disclosed techniques” or similar clauses should be deemed supplemented by “and or techniques known to the skilled”. For example, many Magnetic Levitating (MagLev) Trains and MonoRail systems have in build Anti-Roll, preventing the Train from roll over, typically by clawing onto the underneath of the Rail. Such known technologies can also be used to achieve the purpose at hand, say Anti-Roll.
Varying Details Interpretation: The fact that some sections are more detailed does not by analogy mean that less detailed sections are less informative to the skilled limited to what is written. All sections are deemed to be as broad as a skilled person can understand. However, since there is a difference between a hypothetical skilled person and a typical reader or examiner, applicant has used more detail in some sections for reader or examiner, even though not needed for the skilled.
Details have been Avoided: in many cases where the technology being referred to is known to the skilled
Drawings are not Proportional: with reality, for better or easier representation of matter at hand.

### BRIEF DESCRIPTION OF THE DRAWINGS

FIG. 1—Sectional view of a Narrow Vehicle (NV) width/height compared to others and a typical road

FIG. 2—Side view of a Narrow Bus with three Articulating Segments

FIG. 3—An individual NV Cabin with luggage and laptop tray

FIG. 4—Ridges restricting NV wheels to Limit Sway

FIG. 5—Rollers adhering NV to curb to limit sway (Surface Ridge on opposite side of NV not shown)

FIG. 6—Road channel in which NV Wheel moves to limit sway

FIG. 7—Road Channel with Channel Roller attached to NV to limit Sway

FIG. 8—An I-Rail and Roller Hooks (cross section), holding NV to I-Rail to prevent NV roll over

FIG. 9—I-Rail cross section with 2+2 Rollers as NV Anti-Roll

FIG. 10—Two I-Rails and Hooks to prevent NV roll over at both sides

FIG. 11—Ramps on both sides of I-Rail for vehicles other than NV to cross over I-Rail

FIG. 12—A Trench with liftable lids crossing a road junction

FIG. 13—An NV inside a covered Trench

FIG. 14—Cross section of NVs running thru a Trench at a road crossing

FIG. 15—Cross section of a Trench with a one passenger wide NV inside

FIG. 16—A Double Decker NV being boarded from a platform on right and road level on left

FIG. 17—A Vertical Track Switch, enabling NVs to fork into three directions

FIG. 18—NV with Power Induction Receiver, sliding along a a Power Inducer along the road curb

FIG. 19—Single Seater NV Car

FIG. 20—Double Seater NV Car

FIG. 21—Double Seater NV Car, seat reclined to a bed for auto drive or no drive ride

FIG. 22—Personal NV Cars on a an NV Flatbed attached to Public NV

FIG. 23—A number of NV Cars sequenced to form an NV Train

FIG. 24—An Auto-Drive Container inside a Covered Trench Cargo Way, another parked in a Bay

FIG. 25—A Trench Raised to avoid a crossing buried pipe and Ramps for vehicles to cross over it

FIG. 26—A Raised cross road junction to enable Trenches to avoid a crossing buried pipe

FIG. 27—A Ski-Chain Accompanying or Substituting a NV Wheel to negotiate road Dips and Bumps

FIG. 28—Ski-Rollers Accompanying or Substituting a NV Wheel to negotiate road Dips and Bumps

FIG. 29—A NV Car with Ski-Chain for front & Ski-Rollers for rear

FIG. 30—A NV Car with Engine, Chasie, Gearbox, Wheels & Cabin separated by Air-pads

FIG. 31—A Sudden Brake System attached under an NV Car and a Sensor at front facing forward direction

FIG. 32—A Group or Family NV Car Carrier

FIG. 33—NV Car Snow Plow

FIG. 34—Two narrow Magnetic Levitating Train(s) or MagLev(s), at a crossroad crossed by a bike

FIG. 35—A Tram Rail with Anti-Roll mechanism

FIG. 36—A Hydrogen Fuel Cartridge

FIG. 37—NV with Anti Head-Roll

FIG. 38—NV with Anti Side-Roll using body tilting

FIG. 39—Hydraulic Power Transmission Schematic

### DESCRIPTION BY REFERENCE TO DRAWINGS

Narrow Vehicle NV can be below about 60 wide for one passenger per row, or below around 100 cm wide for two passengers per row, using Anti-Roll means, and means to keep it within a certain Lane/Track without swaying.

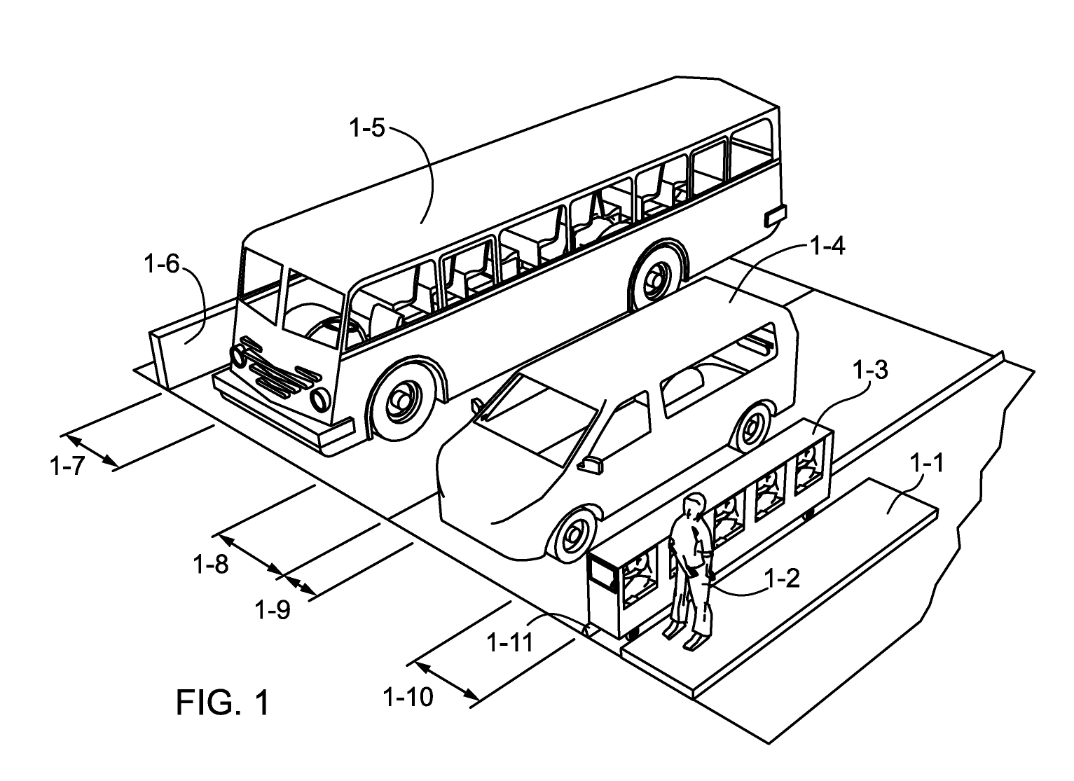

FIG. 1—A Passenger 1-2 beside a Narrow Vehicle (NV) 1-3, on a Lane/Track bordered by Ridge 1-11. Compare width/heights of NV with SUV 1-4, Bus 1-5. NV can be below 60 cm wide and below 120 cm tall. Wheel diameter can be even less than 20 cm. NV has negligible Sway, but other vehicles need Sway rooms 1-7,1-8,1-9,1-10, wasting much of the span from Roadside Curb 1-1 to mid-road Divider 1-6.

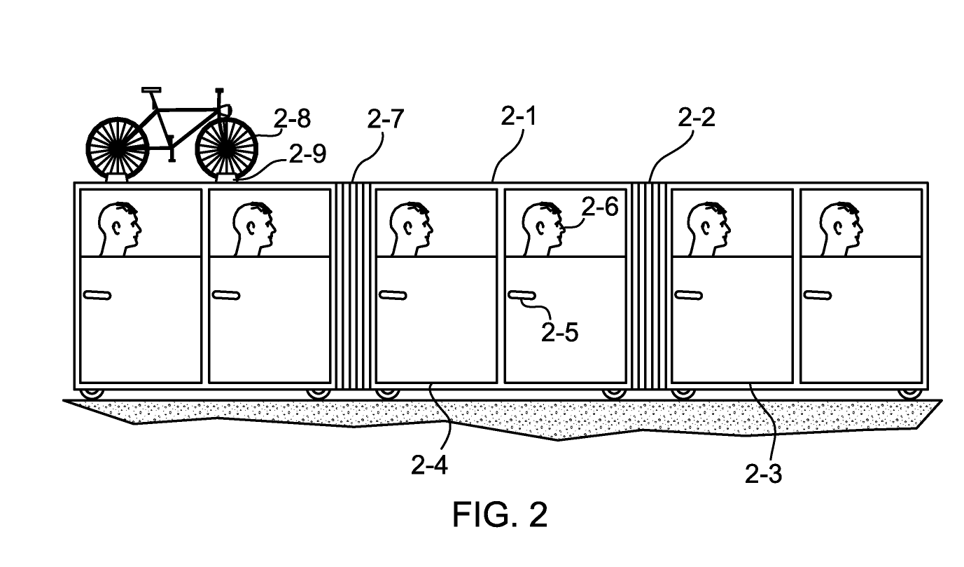

FIG. 2—A longer version of NV 3-1, with Segments (one being 2-3) Articulating at 2-2 and 2-7, like articulated buses. Each passenger 2-6 has a door 2-4, with typically password or card activated lock 2-5. Low height allows lifting Bike(s) 2-8 to be held by bike Holder(s) 2-9.

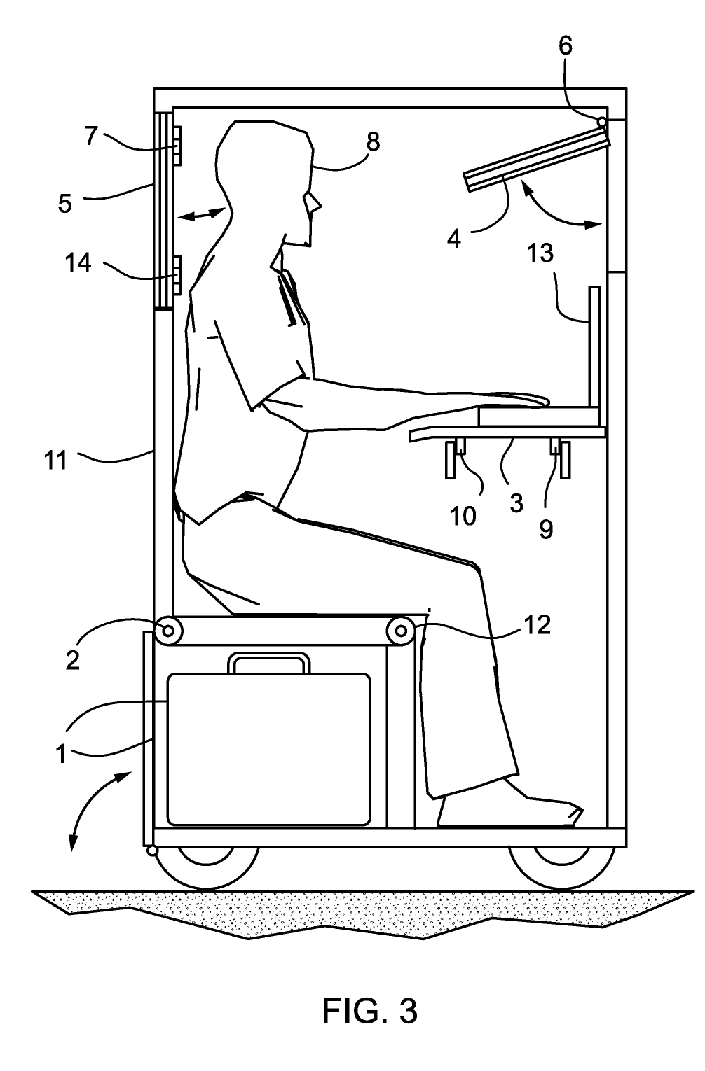

FIG. 3—A One passenger Cabin of an NV, the rear wall and seat back of which 3-1 can be reclined at Lockable Hinge 3-2, to allow passenger to sleep (if the cabin behind is also rented by passenger, ditto for front cabin). Seat is reclining at Lockable Hinge 3-12 for leg rest. Laptop 3-13 is held by Tray 3-3 which can fold away, say down or up towards the Cabin wall, at Lockable Hinges 3-9 & 3-10. Seat is slimly built to fit a typically small suitcase underneath. Window 3-4 opens into cabin at hinge 3-6. Window 3-5 can open into cabin, towards the cabin ceiling, walls at hinges 3-7 & 3-14, so that if adjacent passengers both agree, they can converse. Communication is also possible by NV Intercom.

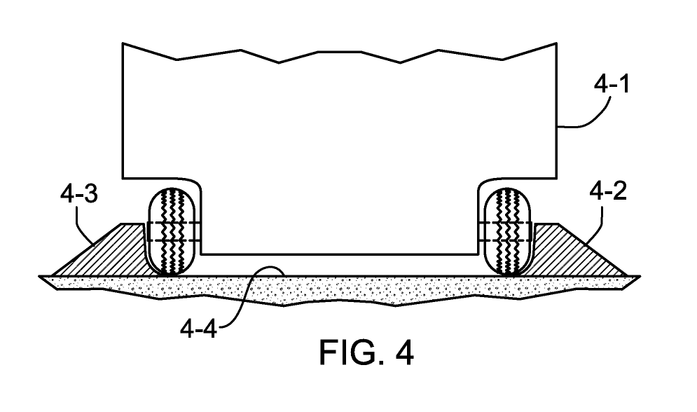

FIG. 4—NV 4-1 uses two rows of Ridges 4-2 & 4-3, as its Track borders to limit Sway. Ridges to have Low Profile, less than say 10 cm, preferably below 5 cm tall where they should allow being run over, such as crossroads, turns, exits & entrances along the Track, where typically NV does or should slow down, not to be de-Ridged (derailed).

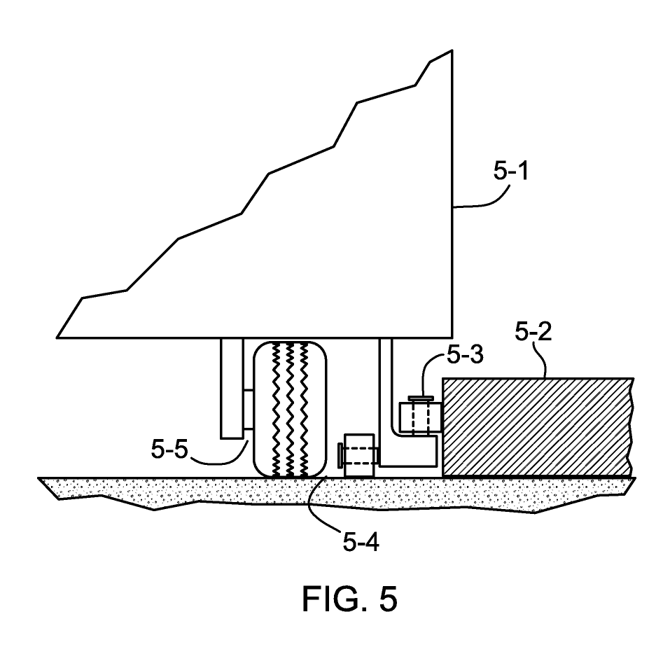

FIG. 5—NV 5-1 uses a curb like short Wedge 5-2, along and against which Roller(s) 5-3 roll to ensure that the vehicles stays within track, assuming another Wedge or Curb is on other side(not shown) of the Track.

Roller 5-3 prevents friction with road surface. NV need not be a train or tram, but use Tires 5-5.

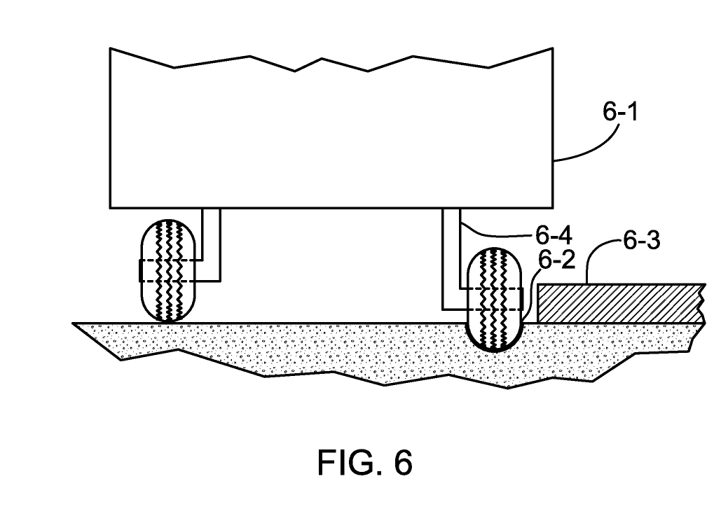

FIG. 6—NV 6-2 uses a Channel 6-1 on the road in which one of the wheels drives, to limit Sway,which wheel has a longer connection to the vehicle than the other wheel.

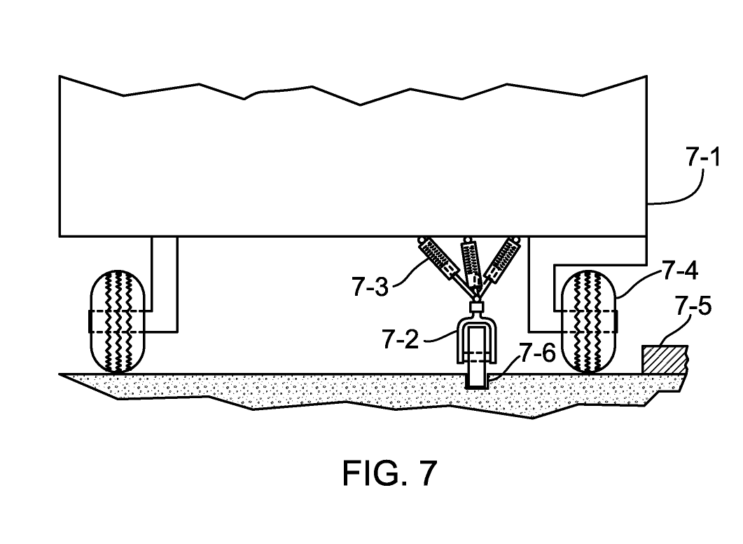

FIG. 7—NV 7-1 uses a Channel 7-6 on the road in which a Channel Roller 7-2 moves, which is kept inside the Channel by three Telescopic/Spring Arms 7-3 forcing down upon it, which Arm's attachments to the NV form a triangle on the underside of NV.

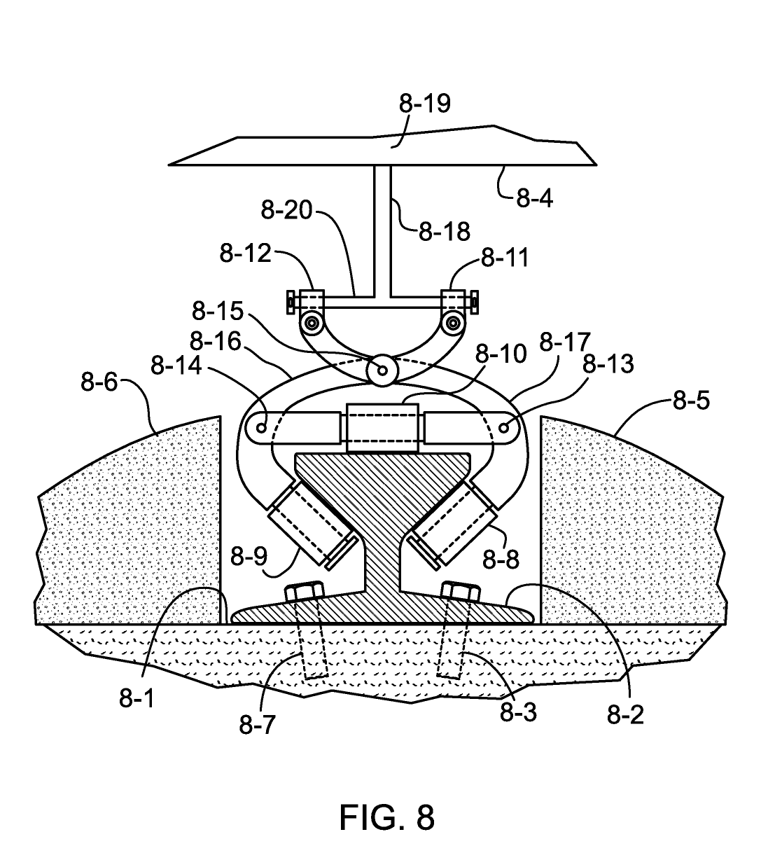

FIG. 8—Cross section of an I-Rail Anti-Roll mechanism, preventing NV from tilting or roll over. I-Rail 8-2 placed on road surface 8-1 secured by screws 8-3 & 8-7, hedged by Ramps 8-5 & 8-6, which Ramps enable vehicles other than NV to cross over the I-Rail without damaging it.

The shown Hook assembly secures the NV to the I-Rail. Rollers 8-8 & 8-9 roll over the underside of I-Rail, prevented from dropping by Roller 8-10. Handles 8-16 & 8-17 pivot at hinges 8-13 & 8-14 and scissor at 8-15 ending at double joints 8-11 & 8-12. Said double joints are able to swivel sideways and back and forth compared to their horizontal support Rod 8-20, connecting said double joints. Said rod is connected to lever 8-18 which connects to a control mechanism inside NV 8-4 shown symbolically as dotted 8-19. Said control can pull the lever 8-18 up to tighten the grip of rollers 8-8 & 8-9. It can push down on lever 8-18, which in turns pushes scissor joint 8-15 down, pushing Rollers 8-8 & 8-9 away from the underside of I-Rail, releasing the NV to move off the I-Rail. Many variations of above technology can be applied.

Anti-Roll Hooks: There are many variations of I-Rail Claws and I-Railing Claws. Rollers Hooking to the underside of a Rail is one type. Part of the Rail's underside is raised above the road surface to enable said Rollers to Hook to said raised underside. Ditto for Roller Hooks hooking to I-Railings.
Rails should have protective means, such as being solid and strong and/or having ramps along their sides, to enable and withstand being run over by crossing vehicles.

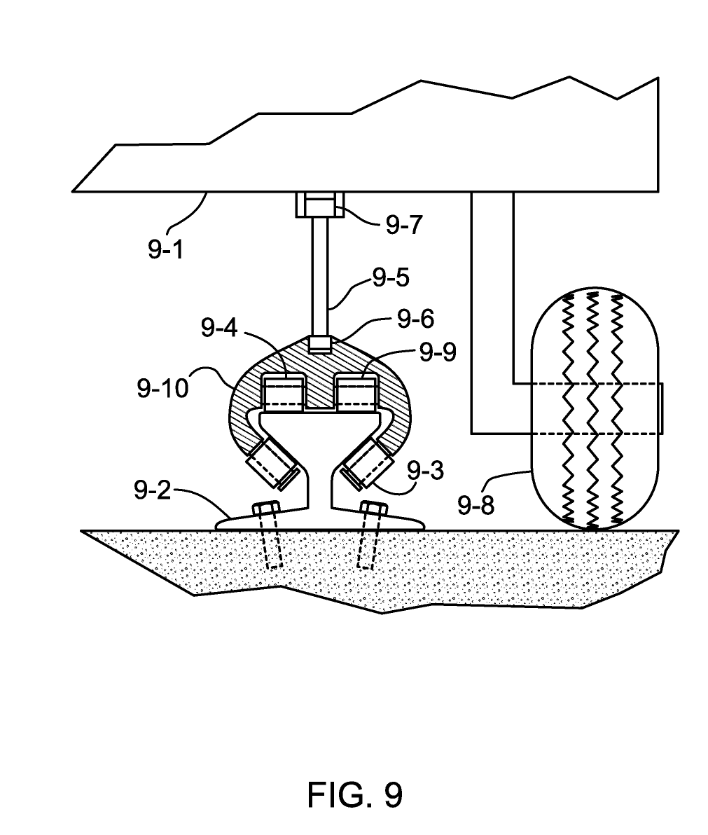

FIG. 9—Cross section of another version of I-Rail Hook 9-10, securing NV to an I-Rail 9-2. The Hook has two rows of Top Rollers 9-4 & 9-9, and two rows of underbeam Rollers 9-3. Each of above top or under rows can have one or more Rollers along the length of the Hook, which length is parallel to the I-Rail length. Hook is connected to hinge 9-6, then rod 9-5 then hinge 9-7 to NV 9-1, which NV has a number of wheels 9-8. Many variations are possible.

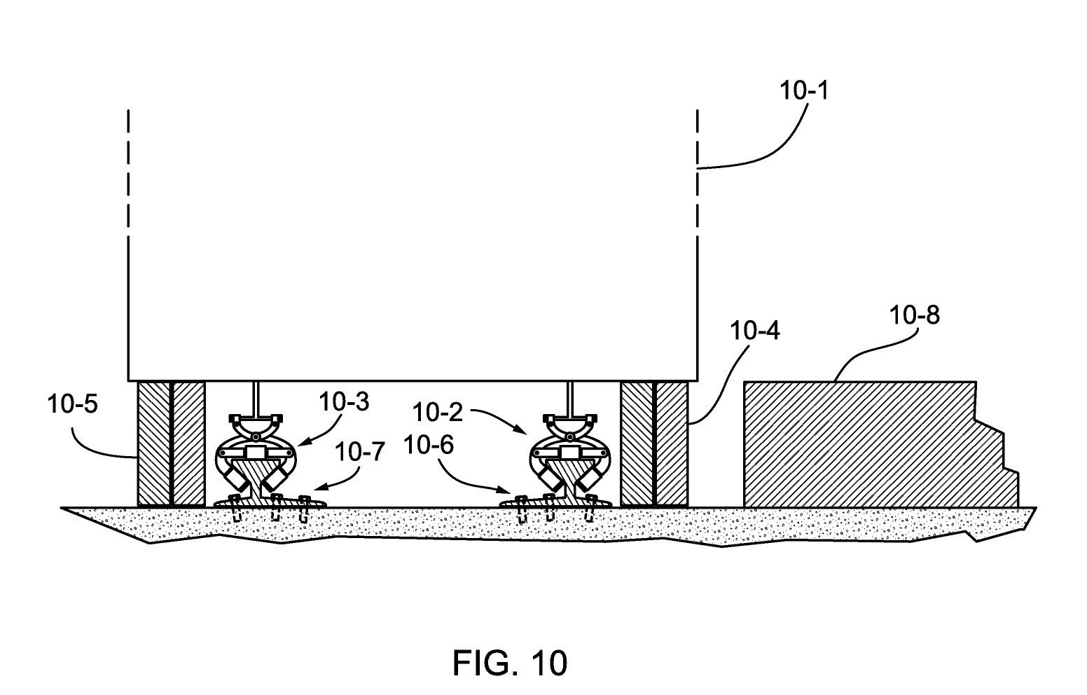

FIG. 10—NV 10-1, secured to I-Rails 10-6 & 10-7, running parallel Curb 10-8, by Hook 10-2 which is close to right back wheel 10-4 and Hook 10-3 close to left right wheel 10-5. NV, all to prevent NV tilting or roll over.

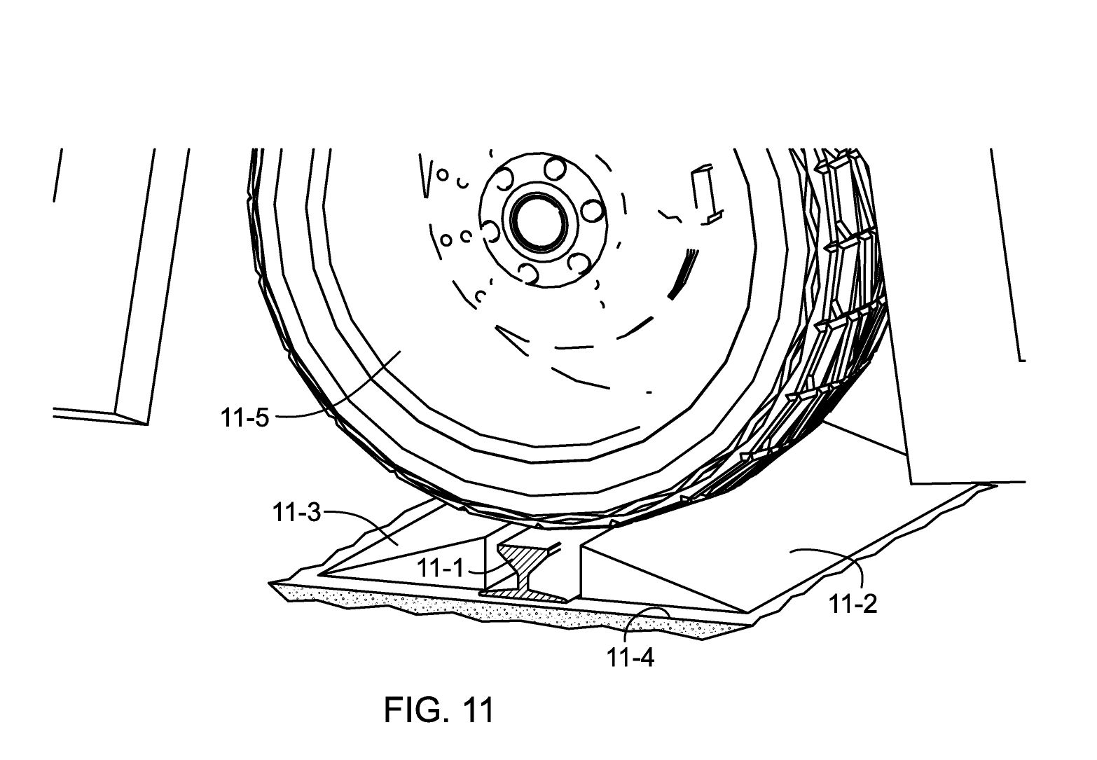

FIG. 11—I-Rail 11-1 is hedged by Ramps 11-2 & 11-3 allowing a car's wheel 11-5 to cross above the I-Rail without damaging it. Rows of Ramps can be placed where the I-Rail crosses other vehicles paths, such as road crossings, property entrances, etc.

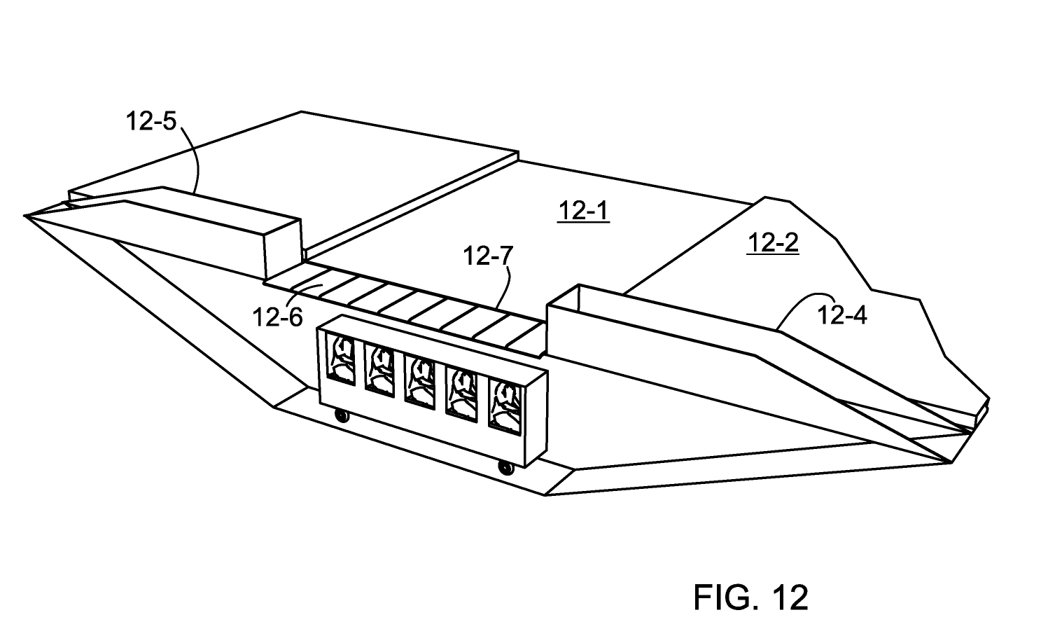

FIG. 12—A covered Trench used by NV across road crossing. North road 12-1 crossing East road with curb 12-2. Fences 12-4 & 12-5 prevent vehicles and people from falling into Trench, which is covered by Lids 12-6 hinged at 12-7 which Lids can be lifted to open the Trench for emergencies and maintenance. Trench can have sizes even smaller than 80 cm width and 140 cm height.

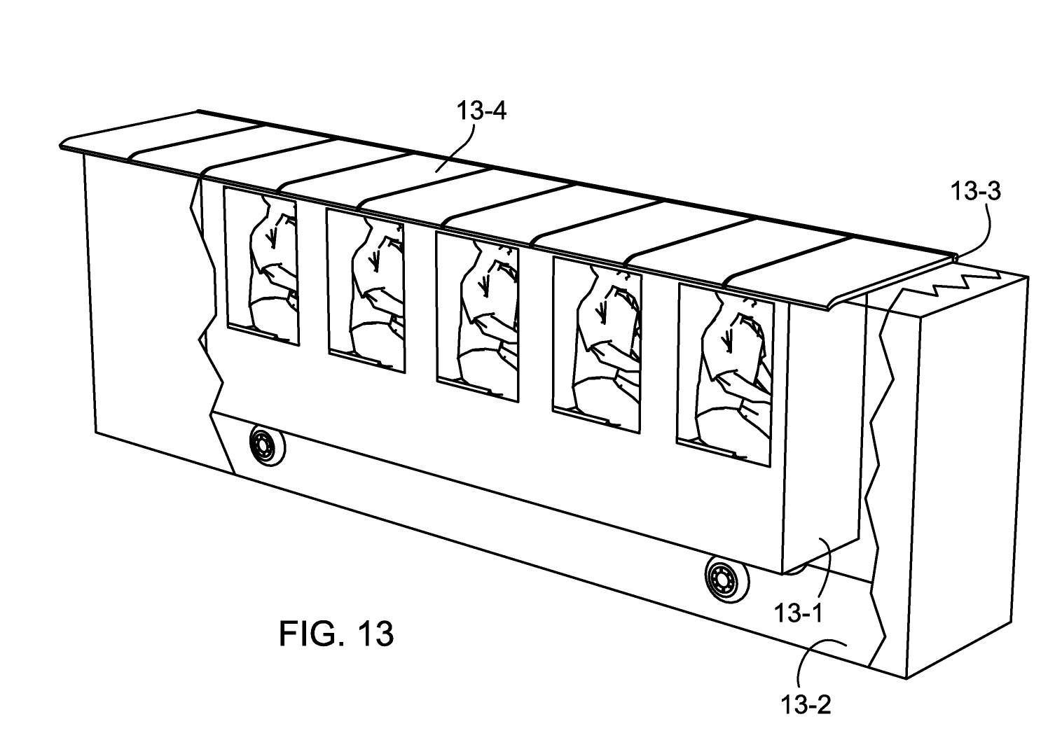

FIG. 13—NV 13-1 inside a Trench 13-2, off a road crossing, covered by Liftable Lids 13-4.

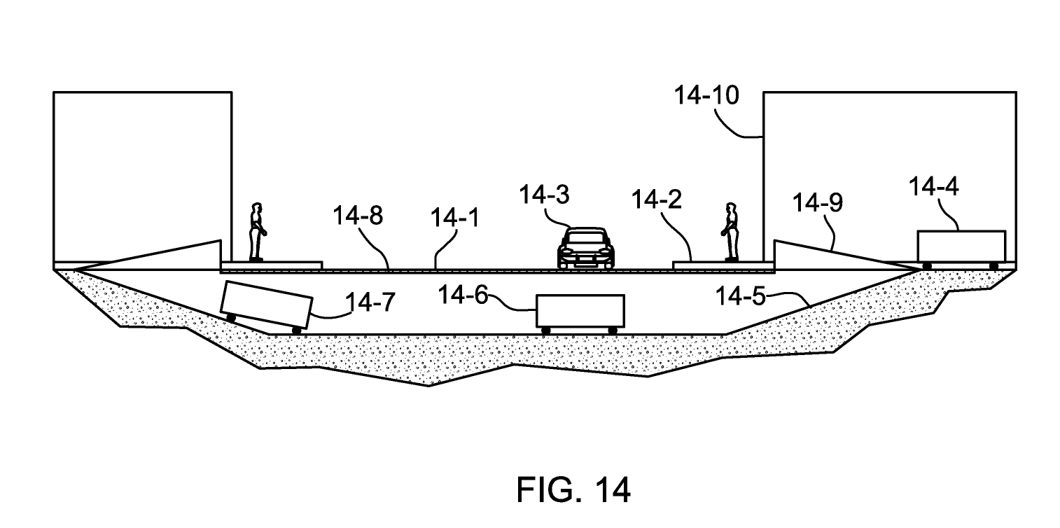

FIG. 14—NVs 14-4,14-6 & 14-7 entering, entered, exiting the cross-road underground covered Trench 14-5, while a car 14-3 crosses over the road surface 14-1, above the trench roof 14-8, and passenger walking on sidewalk 14-2 is prevented from falling into Trench by fence 14-9.

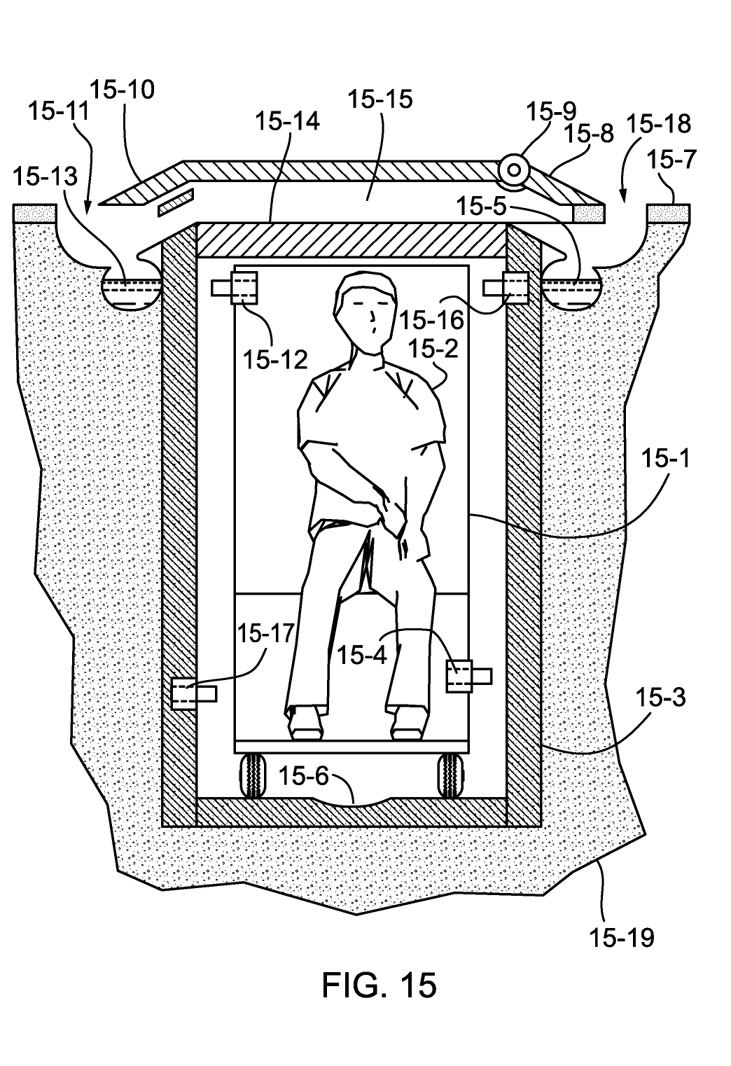

FIG. 15—NV 15-1 cross section, one passenger wide, inside a covered Trench walls 15-3, dug into earth 15-19, under road surface 15-7. Passenger 15-2 is sitting across the width of NV, facing forward. Rollers 15-12 & 15-4 prevent friction with Trench wall. Rollers opposite 15-16 and 15-17 on the Trench wall prevent friction with NV. Channel 15-6 is water draining. Lid 15-10 hinged at 15-9 drains rain which runs over slant 15-8 and 15-10 via air exit rain entry openings 15-11 & 15-18 into rain drain pipes 15-5 & 15-13. A Blade Roof 15-14 (shown symbolically only) has a design to ease air flow from NV front over NV to back of NV. Trench Lid 15-10 can pivot at Hinge 15-9 to open in emergencies and for maintenance. Blade Roof can also be lifted away. Ditto for NV ceiling 15-21 which can pivot on hinge 15-20 to lift open from inside and outside in emergencies.

When NV is supported for anti roll only by rollers such as 15-12,16,4 & /17, said Rollers should be placed close to the top and bottom of the Trench and Trench opening at a Stop should starts below the top Roller(s) and above the bottom Roller(s), so so that when the Trench side and NV doors open at a Stop, Rollers maintain their ability to hold the NV.

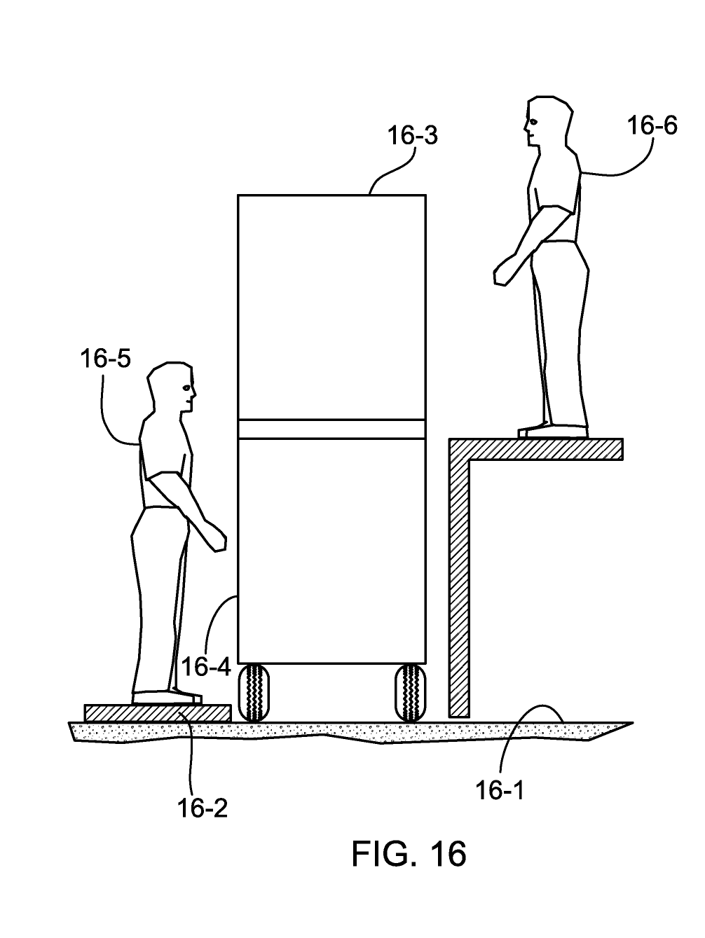

FIG. 16—NV lower Deck 16-4 being accessed by passenger 16-5 from ground, and upper Deck 16-6 being accessed by passenger 16-6 a station Platform 16-1. Passenger is 170-180 cm, NV width can be below 60 cm for one passenger per row and below 100 cm for two per row. NV height can be below 120 cm for each deck, as in a sports car, plus few cm for inter deck plane plus below 10 cm as wheel radius.

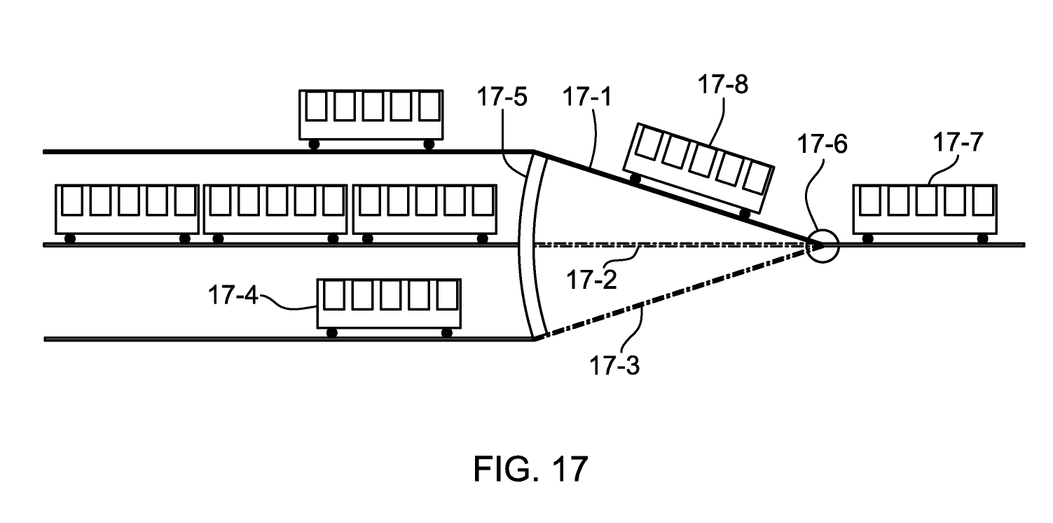

FIG. 17—movable Ramp 17-1 can take 3 positions, up, level and down to lead NV 17-7 to different tracks 17-1,17-2 or 17-3. Lifting mechanism 17-5 moves one end of the Ramp up and down and locks in one of three positions. Hinge 17-6 allows Ramp pivoting. NV 17-8 ramping up, 17-9 on the upper level and 17-4 has ramped down. Other NVs have moved straight.

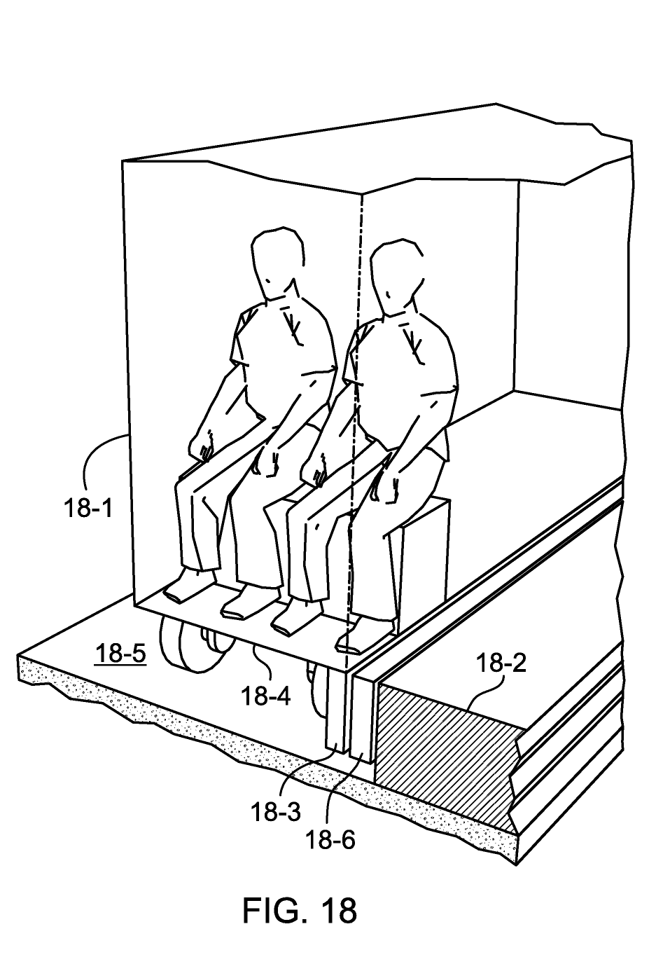

FIG. 18—NV 18-4 with Induction Receptor 18-3, being charged or receiving power inductively by sliding along an Induction Power Dispenser 18-1 attached to curb 18-2.

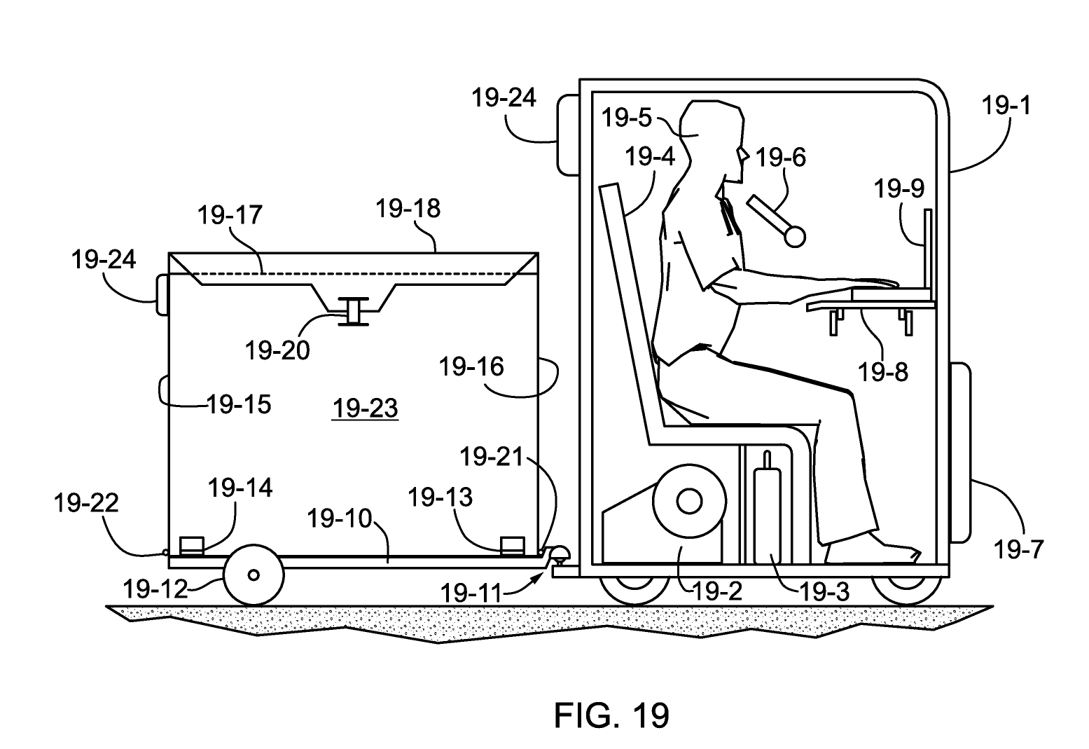

FIG. 19—A one passenger NV Car 19-1, preferably steered by Joystick 19-6 powered by electric or other engine 19-2. Since it needs to cover mainly the last mile from/to a Public NV Stop, at low speeds, perhaps on sidewalks, said Engine can be small enough to fit under the seat with a briefcase 19-3. Rubber like or other flat Fender 19-7 protects NV Car from some head collisions with other NV Cars, typically when many NVs are sequenced to form a Train. Laptop tray 19-8 is foldable towards NVs side via two lockable hinges shown under it. NV Car can be made to be used as a proper Car, with adequate engine, safety and anti-roll provisions, using prior art and those described in this application.

It is important to keep its size small yet give it all functionalities, one being luggage room, that must preferably have a number of features such as being foldable onto itself, folding up against the Car, retractable, sliding underneath and or into the Car, detachable, convertible to a flatbed, etc.

One way of doing so is a Luggage Flatbed 19-10 hinged to the Car via Detachable Hinge(s) 19-11, suspended above the road by locking said hinge(s) or preferably by rear Roller(s) 19-12. Luggage Container can be provided by a Tent. Preferably Near (to viewer) Panel 19-23 connected to and collapsible onto the Flatbed by hinge(s) 19-13 & 19-14, ditto for Front Panel 19-16, Rear Panel 19-15 and Far Panel 19-17 and Lid Panel 19-18 hinged to said Far Panel closes the Container and Lock at 19-12. All said Panels can collapse onto each other and the Flatbed, then slide under or inside the Car, but preferably

Detached at Hinge 19-11 or Hinged Up at 19-11 against the Car's Rear (side or door) secured by conventional Latches. Said Panels should have Binders along their joint sides t hold them together when opened up, and should each preferably be detachable Rubber linings at rattle points can reduce noise and vibration. A Bag or Lining inside the Container can protect the Luggage from rain, yet be collapsible and foldable. Flatbed and Panels can be made extendable and retractable to re-size the Container to more securely hold the Luggage. Indicator and brake Lights 19-24 and Number Plate should be positioned to be visible when Luggage Container is unfolded, say at the top edge of the Car's Backside.

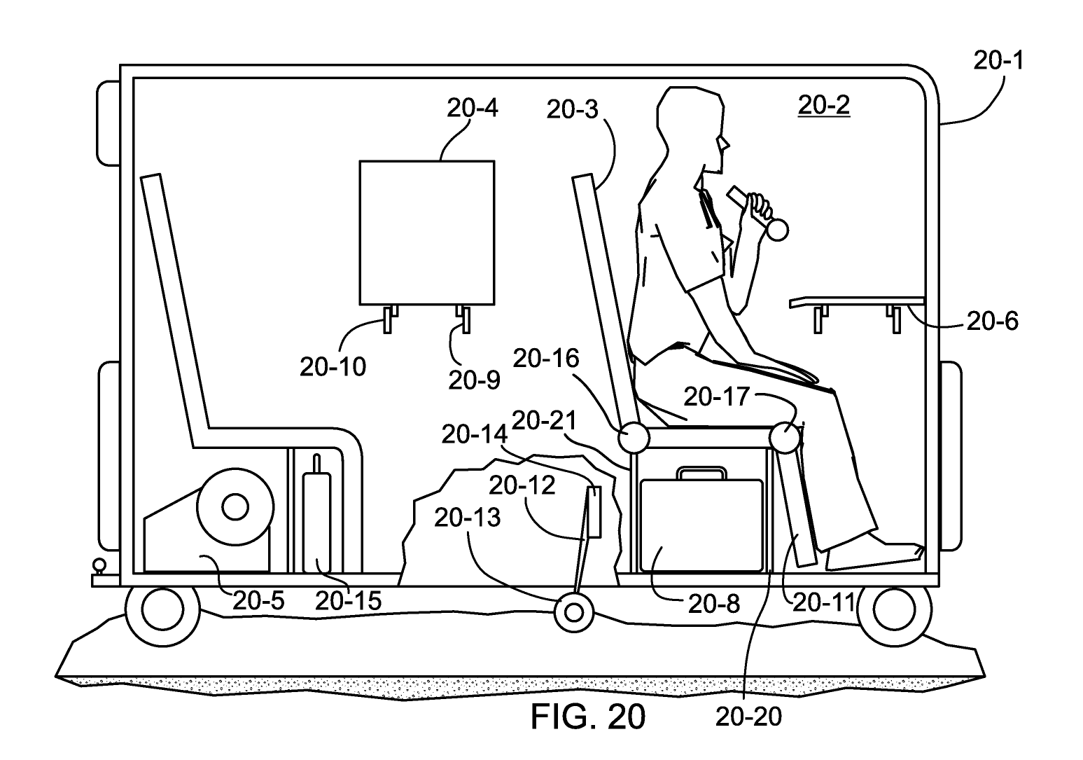

FIG. 20—Double seated NV, with laptop Tray 20-4 folded towards NV side by lockable hinges 29-9 & 20-10. Anti Roll-Over Wing 20-12 hinged to the NV at Base 20-14 with a Roller at tip 20-13. The wing can swing open to prevent NV roll over when driving above certain speeds. Some versions of NV can have two or three passengers per row. Front seat has legs 20-19 & 20-20, lockable hinges 20-17 at front to level up a hanging foot rest 20-11, and at back 20-16 to recline the seat like a bed.

Fast NV Cars, especially if short (lengthwise) may Roll Over Head &/Side when braking. Hence Anti Roll-Over Wing Base should be close to NV Front and the Wing extending both forward and sideways, say one attached close to and extending towards the northwest of a northbound Car, another attached close to and extending towards north east. Alternatively, one or two Wings should serve the front and one or two Wings serving each side.

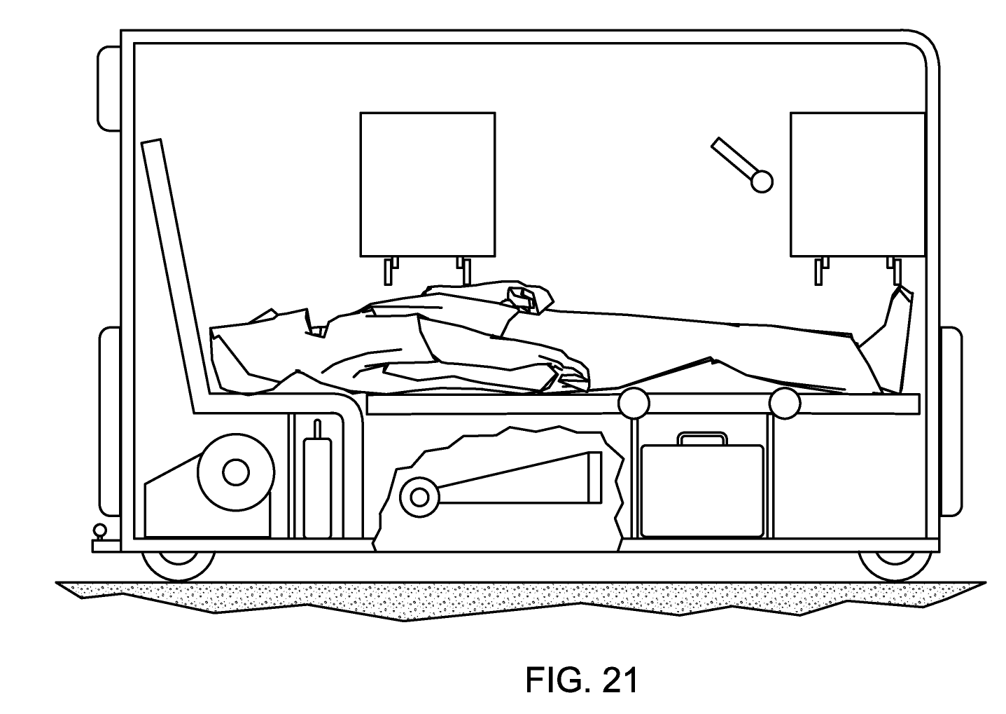

FIG. 21—NV Car of FIG. 20 with laptop trays and wing folded up and passenger sleeping.

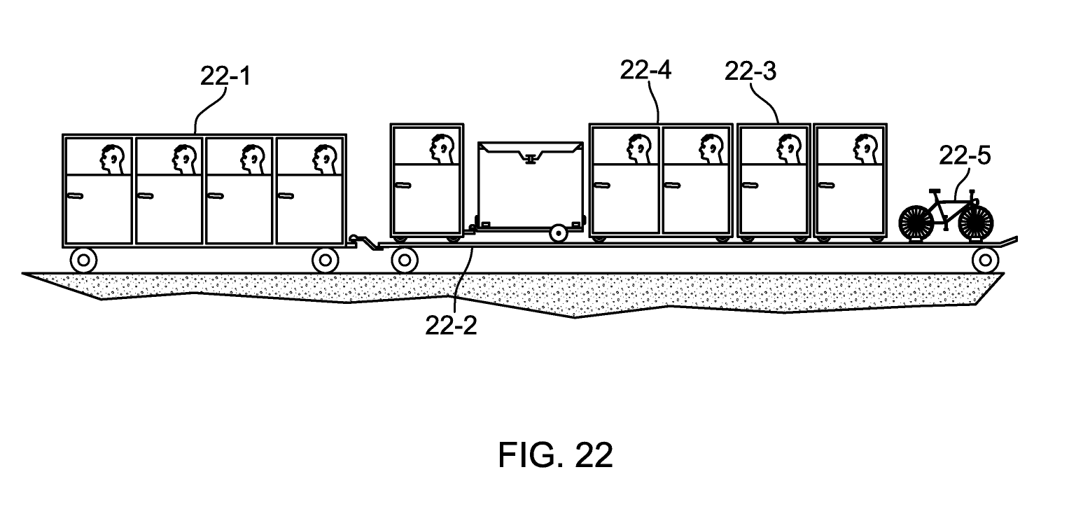

FIG. 22—NV 22-1 pulling a Flatbed 22-2 on which NV Cars like 22-3 & 22-4 and bike 22-5 are parked.

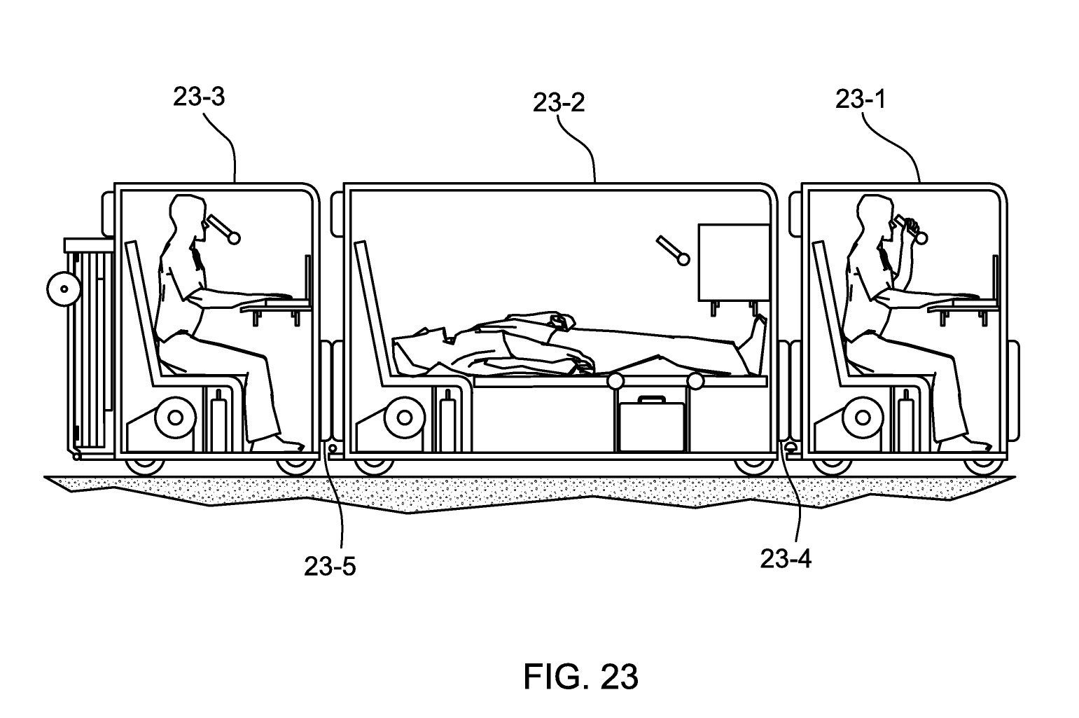

FIG. 23—NV Cars 23-1, 2 & 3 in a row, separated by a small distance and guarded by Fenders 23-4 & 23-5. They form a sequence of NV Cars like a train, driven by auto drive, while some passengers are sleeping, some working on laptop, some sight seeing, etc.

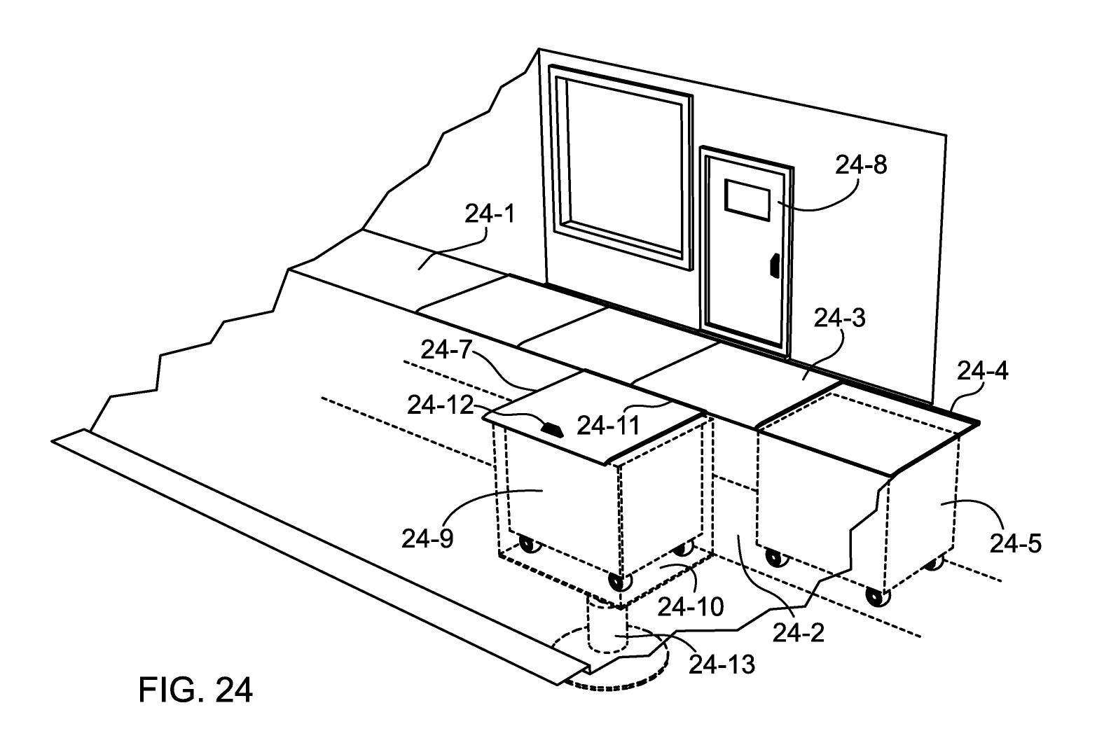

FIG. 24—A Trench Cargoway 24-2, dug along and under a Curb 24-1, near the shops wall and door 24-8 with Liftable Lids 24-3 hinged at 24-4. A Rolling Container 24-5 rolls inside the Trench. Another Container 24-9 is parked inside a cubicle Bay 24-10, covered by Liftable Lid 24-7, hinged at 24-11, having a lifting Handle 24-12. Jack 24-13 can lift the bottom of or all the Cubicle up, to bring the parked Container 24-9 to the surface, to be emptied by the addressee shop owner and returned to the cubicle bay. Containers can be any size. Typical sizes can be 50 wide by ×60 cm deep for Trench cross section and 45 width×55 height×90 cm length for Container.

Containers use automatic drive and move onto the Bay, say by stopping and turning their wheels at right angle to the Trench length, when they reach a pre-programmed Bay.

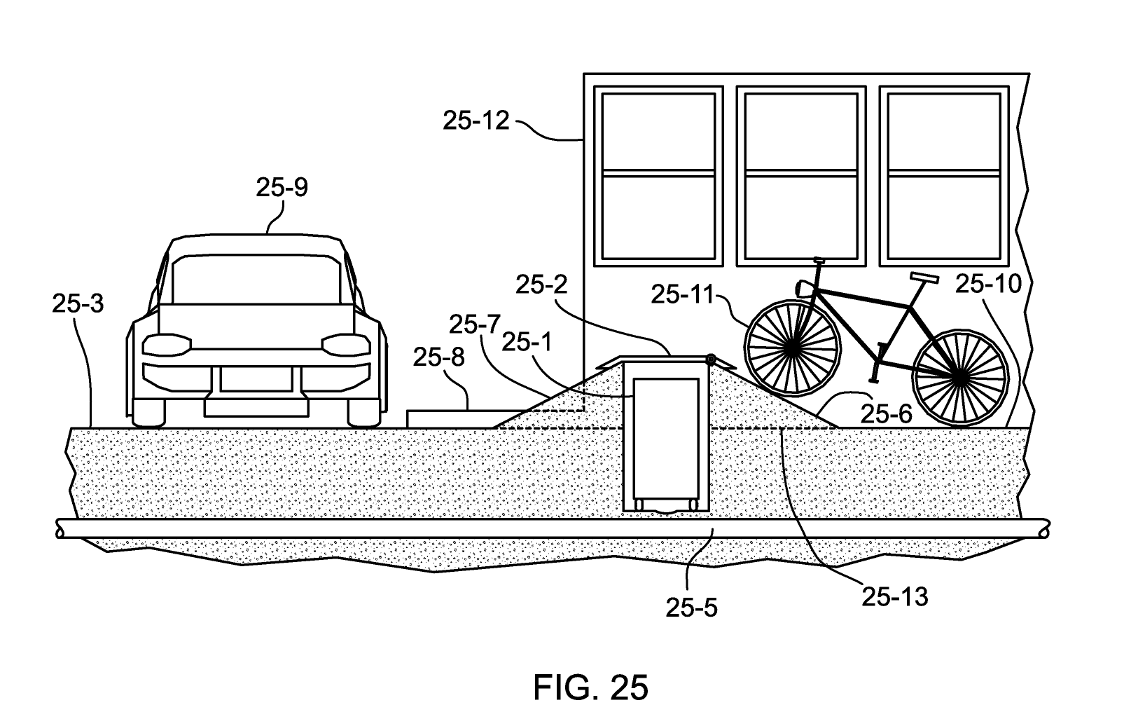

FIG. 25—Cross section of a Northbound Trench 25-2 which is Raised to avoid a buried utility Pipe 25-5. Bike 25-11 is driving on West Road 25-10 and Automobile 25-9 driving on North Road 25-3, by the North East Corner Building 25-12. Ramps 25-6 & 25-7 enable the Bike to cross over the Trench. If necessary, Trench course is deviated to have enough distance from the Intersection for Ramp 25-7 to end before the Curb 25-8 hypothetical continuation line, hence Auto 25-9 need not curve towards the middle of Northroad to avoid bumping onto said down-Ramp, while Northward NV 25-1 is free to cross the Intersection concurrently with the Bike.

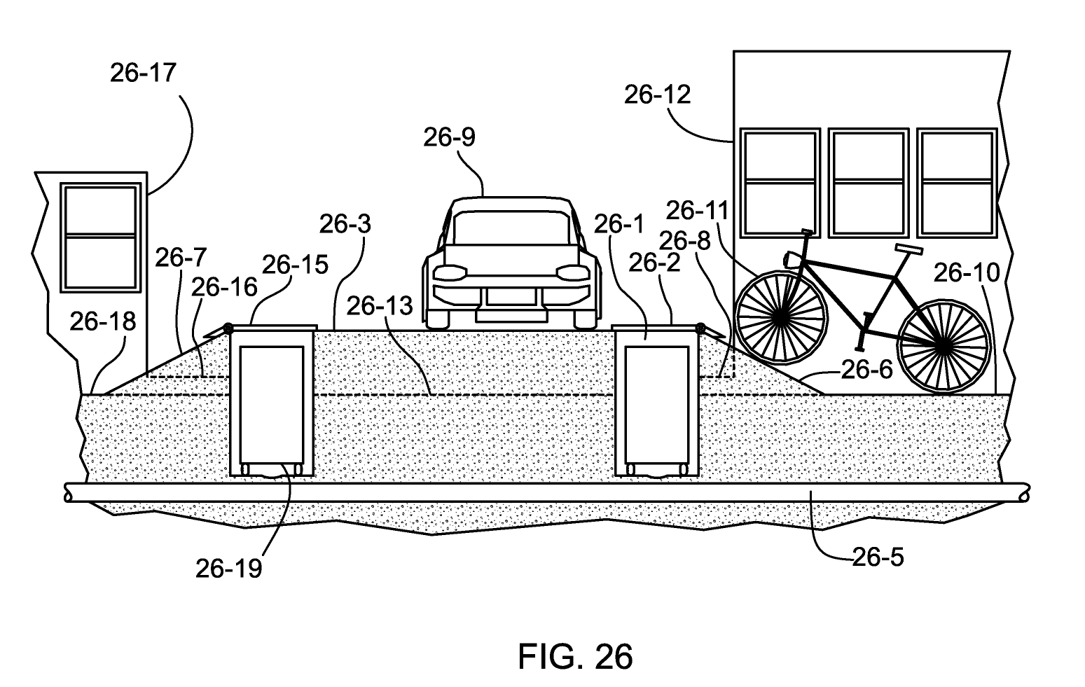

FIG. 26—Shows cross section of Trench Northbound 26-2 which is Raised to avoid a buried utility Pipe 26-5. Bike 26-11 is driving on West Road 26-10 and Automobile 26-9 is driving on Intersection of North Road 26-3 and West Road. Ramp 26-6 enables the Bike to cross over the Northbound Trench, onto the Raised Intersection 26-3, by the North-East Corner Building 26-12 over the Southbound Trench 26-15, to down-Ramp 26-7 by the North-West Corner Building 26-17, onto West Road continuation 26-18, while Northward NV 26-1 and Southward NV 26-14 are free to cross the Intersection concurrently with the Bike. FIG. 25 & FIG. 26 Techniques are applicable when lowering, redirecting or relocating the buried Pipe is not viable.

Other Techniques include (a) Minimizing Trench height, (b) Using Skypipes, arching the Trench over the West Road, (c) Curving the Pipe overground above the Trench, adding an exterior, not to raise the Trench.

Ski-Chain & Ski-Rollers:

We have discussed the merits of a low profile vehicle such as NV or NV Car. We have also incorporated features that would eliminate need for new roads or even changing existing roads, as part of reducing Infrastructure costs and time to roll out a transit system, such as PPTS.

One tool in making a low profile vehicle is small wheels, which can be as small as blade rollers. But one problem is posed by uneven roads with concave holes, dips, valleys, into which an NV Wheel can fall, while the underneath of NV is lowered to the dip's rim, suspending the wheel disengaged from the road. Similarly when NV Wheel crosses over a bump, larger than NV Wheel, leaving the NV underbody on the pump and suspending the Wheel disengaged from the road.

Prior Art chain wheels used in bulldozers have the problem of undue wear, friction and power consumption. Ski-Wheels introduced solve said problems without increasing NV height, with negligible increase in fuel.

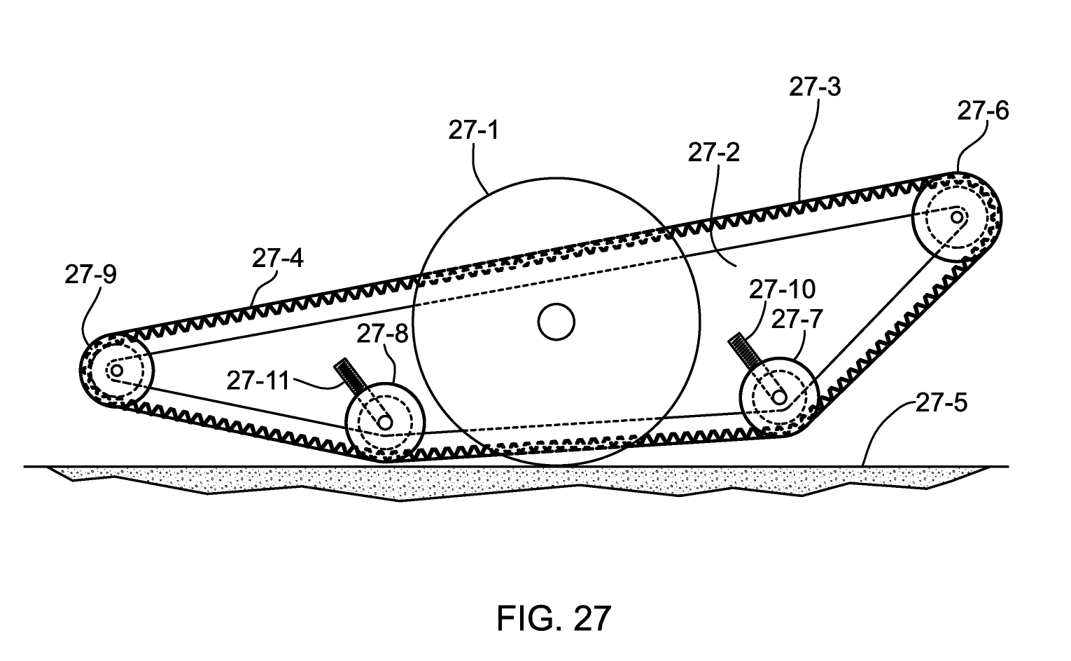

FIG. 27—Shows an NV Wheel 27-1, supplemented by a Ski looking Chain Wheel or Ski-Chain having a Belt 27-3, preferably of poly-urethane, guided by a number of Pulleys 27-6,7,8, & 9 attached to Ski-Wheel Body 27-2. The band is preferably lifted above the road surface 27-5, hence motionless with no wear or power consumption, until NV Wheel becomes suspended inside a dip or over a pump, at which time the Band hits the road, and prevents friction between NV underside and the road, while NV is powered by its other unsuspended wheel(s). NV Wheel and Ski-Chain can be separate, but should preferably be combined.

A more complicated version of Ski-Chain is powered. One group is connected to the NV Wheel or engine &/gearbox and runs constantly.

Preferably, the Ski-Chain should be powered only when the Belt touches the road. Sensors 27-8 and 27-7 sense when the Band has touched the road and prompt power &/gear connection. Alternatively Power Pulley is disengaged from gear and or engine, until said Power Pulley moves up a predetermined amount due to the Belt hitting the road, when said Pulley is placed in a location that engages it to gear and or engine. The exact details depend on the engine being electric, combustion etc, and to power transmission being gears, hydraulic, electric, etc. A preferred Power Transmission is Hydraulic, so that when the Power Pulley moves up, a Hydraulic Pipe that powers it is opened, but closes when the Power Pulley is disengaged from the Road Surface, hence moves down.

Power and gearing applied to the Power Pulley that runs the Belt by engaging Teeth 27-4 or Friction, should run the Belt at same ground speed as the suspended wheel should have run if not suspended.

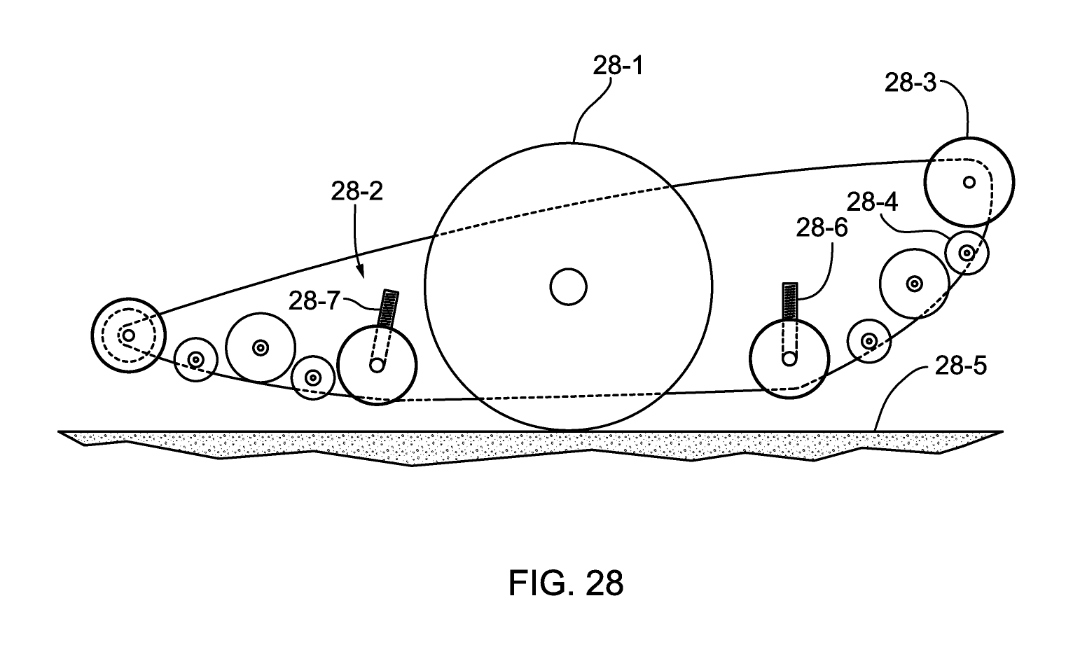

FIG. 28—Shows an NV Wheel 28-1, supplemented by a Ski looking Multi-Wheel or Ski-Rollers having a a number of Rollers 28-3, attached to Ski-Roller Body 28-2 and preferably a number of smaller Rollers 28-4 to fill the gaps. Rollers are preferably lifted above the road surface 28-5, hence motionless with no wear or power consumption, until NV Wheel becomes suspended inside a dip or over a pump, at which time some or all Rollers hit the road, preventing friction between NV underside and the road, while NV is powered by its other unsuspended wheel(s). NV Wheel and Ski-Rollers can be separate, but preferably be combined.

A more complicated version of Ski-Rollers is powered. One group is connected to the NV Wheel or engine &/gearbox and runs constantly. Preferably, each Roller to be powered only when it touches the ground. Sensors 28-6 & 7 sense Ski-Rollers touching the road and prompt power to a number of Rollers. Alternatively each Roller is disengaged from gear and or engine until it moves up a predesigned amount due to hitting the road, when said Roller is placed in a location that engages it to gear and or engine. This enables running only the Roller(s) that are pressed onto road surface at least to a predetermined pressure. The exact details depend on the engine being electric, combustion etc, and to power transmission being gears, hydraulic, electric, etc. A preferred Power Transmission is Hydraulic, so that when the Power Roller moves up, a Hydraulic Pipe that powers it is opened, but closes when the Power Roller is disengaged from the Road Surface, hence moves down.

Power and gearing applied to Each Powered Roller should Turn it at same ground speed equivalent as the suspended wheel should have turned if not suspended.

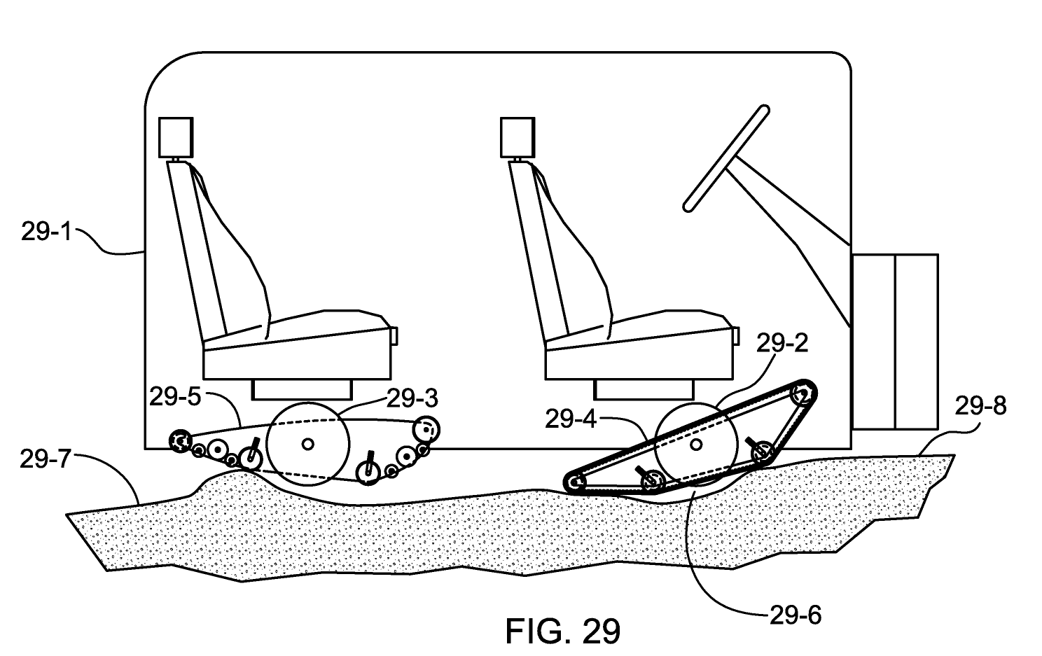

FIG. 29—Shows NV 29-1 with Front Wheel 29-2 suspended in a Dip 29-6 while Ski-Wheel 29-4 maintains contact with road Surface 29-8, Rear Wheel 29-3 suspended over a Bump 29-7 while Ski-Rollers 29-5 prevent NV underside friction with the Bump.

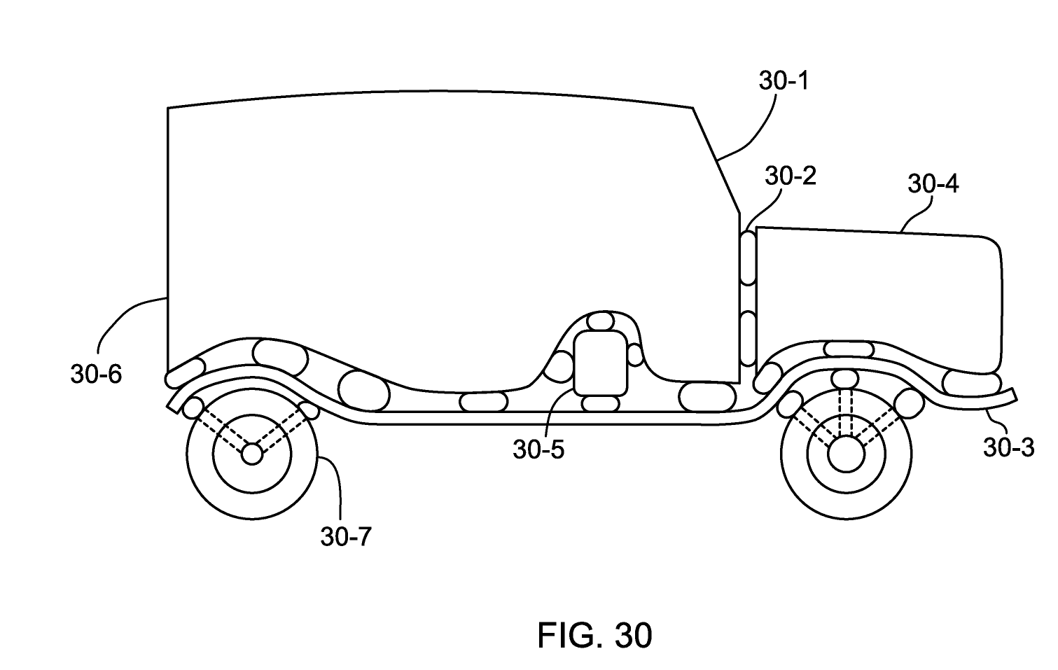

FIG. 30—Shows a NV Car 30-1 with a number of Air-Pads, one numbered as 30-2, others not numbered, which are Rubber like Bags containing a liquid, but preferably gas, preferably Air, separating most or preferably all the Components, Chasie 30-3, Engine 30-4, Gearbox 30-5, Wheels 30-7 and especially passenger Cabin 30-6. Said Components can also be connected conventionally for weight support and power transmission, but connections are all flexible as in suspension springs, universal power shaft joints, gearbox to wheel universal joints, etc., which reduce vibration from ground or engine, but still transmit noise.

However, in this design, preferably all Rigid connections between said Components and even sub-Components are flexible, better via Air-Pads.

Air-Pads better be distributed at least close to NV Exterior, not to leave a gap for dirt, water, snow, . . . entry. Alternatively any exterior gaps can be closed by soft, rubbery material, not to transmit noise or vibration. A major reason is that Wheels can be Rigid, with minimal or No Air, and minimal Rubber to reduce Noise and road damage. Rigid Wheels are much more efficient, as in tains, durable, maintenance free, cheap, puncture free, etc, with much less volume and radius. Thus Wheel Air is shifted to Air-Pads. This design reduces noise and vibration felt by passengers.

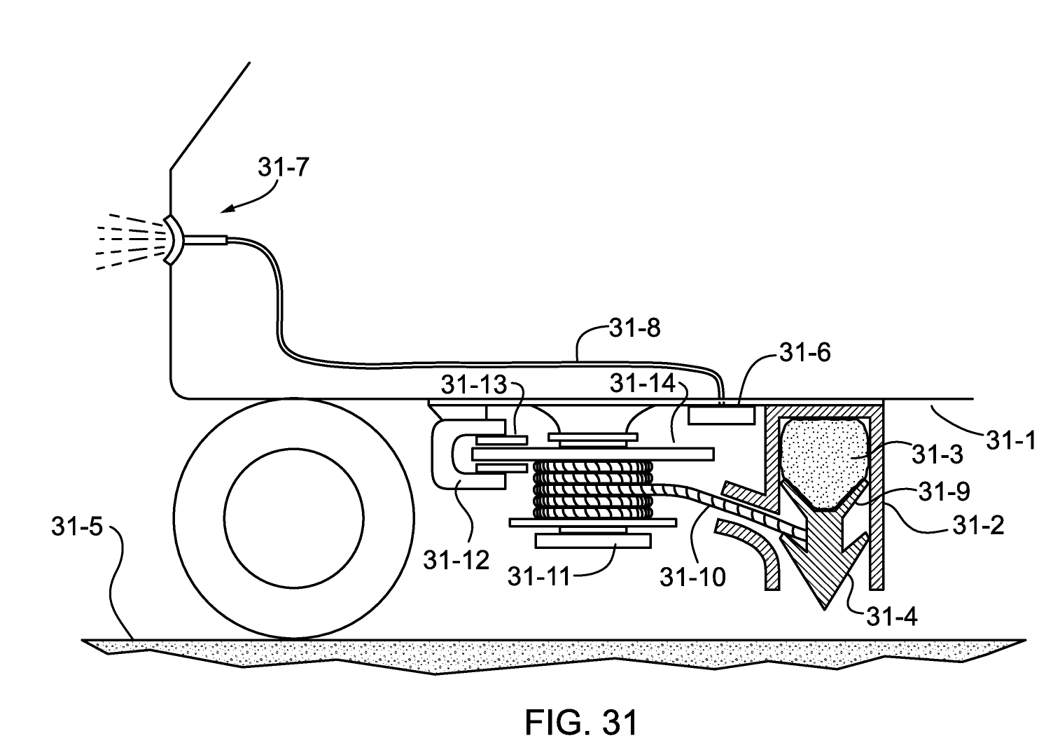

FIG. 31—Shows a Sudden Brake System attached to the underside of NV Car 31-1. A Gun 31-2 charged with an Explosive, Compressed Air or Spring 31-3 can fire an Arrow 31-4 into the Road 31-5, upon command from Control 31-6, which is fed information by Sensor 31-7 close to front of NV Car, facing forward movement, transmitting data to Control by Wire 31-8 or wirelessly. Arrow has Fins 31-9 to prevent it from being pulled out of the Road, to keep one end of Cable or Rope 31-10 which is attached to the Arrow fixed to the Road. The rest of the Cable is around in Reel 31-11, whose unreeling can be smoothly slowed and or stopped by a suitable Braking System, in this version using Pad(s) 31-13 gripping both sides of the Reel's Wheel 31-14. Thus the Cable release can be gradual and be stopped after a Desired Length has been released, as calculated by the Control Unit. Explosive should be enough to penetrate the Arrow deep enough into any material, even concrete, so that Arrow is not released by NV Car Momentum. After such Sudden Brake, the Cable is scissored at Road surface. Arrow, Explosives and Cable will need replacement. Alternatively Compressed Spring or Air are designed to be Recompressed and Arrow is designed to accommodate Cable Reattachment, so that a longer Cable can be reused many times. Like many of Techniques introduced in this application, Techniques in FIGS. 27, 28, 29, 30, 31 are usable Generally, including for Roller Blades, Scooters, Scooters, Bicycles, Motorcycles, Cars, Buses, Trucks, etc.

Group (Family) NV Car Carrier (NVCC)

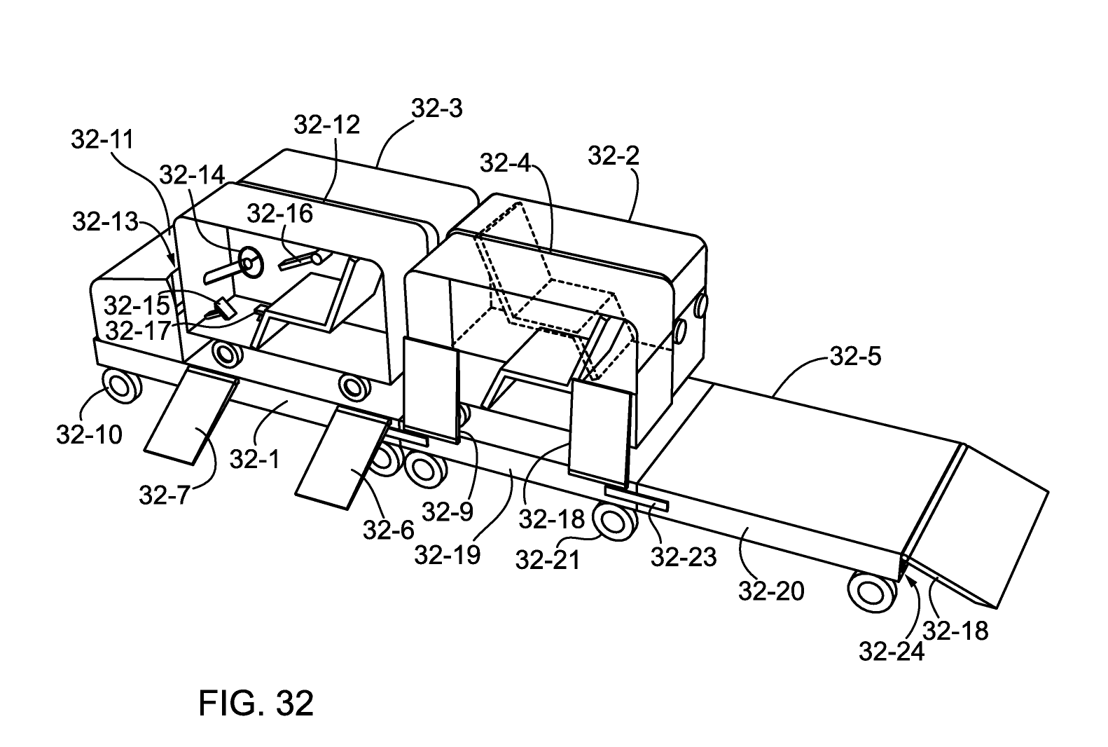

FIG. 32, NVCC is a drivable Flatbed 32-1, onto which a number of NV Cars 32-2,32-3,32-4 can be placed, preferably with some Cargo room 32-5. It has ramps 32-6, 32-7 on its sides, which open to form a ramp from road surface to the the Flatbed to allow an NV Cars that can drive sideways and or ramp 32-18 for an NV Car to drive onto the Flatbed. Said ramps swing up 32-8,32-9 or slide into the Flatbed, when not in use. Said Flatbed is preferably low close to the road surface for easier loading and unloading. It has wheels 32-10, engine 32-11 and a Driver Cabin 32-12.

Alternatively one of the NV Cars on it can be the Driver Cabin, connecting to NVCC's Powered Steering, Brake, Gas Pedal and other Controls wirelessly or via cables, so NV Cars Controls also control the NVCC. Alternatively the Driver NV Car opens from the front 32-13, as detailed separately to access the NVCC Steer 32-14, Brake 32-15, etc. Said Driver NV Car's Joystick Steering 32-16 and Brake 32-17 are shown. Each NV Car can preferably connect to NVCC power source, not to use its own, for say heating.

NVCC holds a number of NV Cars in rows of one, two or more, road parallel and or sideways. Family NVCC can typically house 2 rows of two NV Cars, with some room for open or covered Cargo. The fewer the NV Cars loaded.

An NV Car can have one Side Exit, an or a Front Exit, in which case it should face the forward or backward direction to allow exit, when another NV Car is blocking one side or front of it. An NV Car can have two Side Exits and or Roof Exit, giving it more options for direction and passenger exit.

Flatbed can have Disintegrable Segments 32-19, 32-20 to increase or decrease its length. Each Segment can have enough wheels 32-21, 32-22 to be stable, or be connected to the Main Segment 32-1 or an adjacent Segment 32-19 via rigid connectors 32-23 for stability. Some or all Segments can have their own engine, all controlled by the same Driver Cabin. This is technically more viable with electric engines, that connect to the rest of the NVCC by cable or wireless. Hydraulic power transmission also allows easier power transmission from a Central engine & Control from Driver Cabin, joining disjointing of Segments. Rear Indicators and Brake lights can be same as conventional Tows. Preferably, an Indicator Board 32-24 can be attached to rear of rearmost Segment, connected by cable or even wireless to the Main Segment.

Segmentation along the width of NVCC is also possible, using above techniques. The Engine width should be no more than that of the least width the NVCC can get.

Another type of NVCC is formed by a number of NV Cars with means to attach to each other, each as one of said Segments, yet once attached, only one Driver controls all. Again this is easier if Brakes, Gas Pedal, Steering are all Powered and activated electrically, hence can be controlled by one Driver via Cable or Wireless. In fact Steering of all non Driver NV Cars should be released to neutral or idle.

Front and back of NV Cars should preferably open to allow tunneling to the next one. Thus seats can be reclined for some passengers to sleep. Side windows and or intercom enable conversation. Therefore, family or group members can have their own NV Car, yet can travel together, using one Driver, one set of wheels to wear out, etc, have a Flatbed to be used as a Pick up truck and or as a Tent Floor. NVCC can also use NVTS Lanes/Tracks, especially when its width is narrow enough.

A preferred version is an NVCC Main Segment that can harbor a Driver NV Car and one Passenger NV Car aside each other, as even a Group or Family NVCC carries only one Driver and one passenger most of the time. Other Segment(s) for more NV Cars and or Cargo can be added when necessary.

NV Car-Snow Plow

NV Car being typically (but not necessarily) small, with small typres better be equipped to cut through snow.

Techniques mentioned here are applicable to other vehicles, such as cars, trucks, even less obvious ones such as tiny scooters, bicycles, motorcycles, etc.

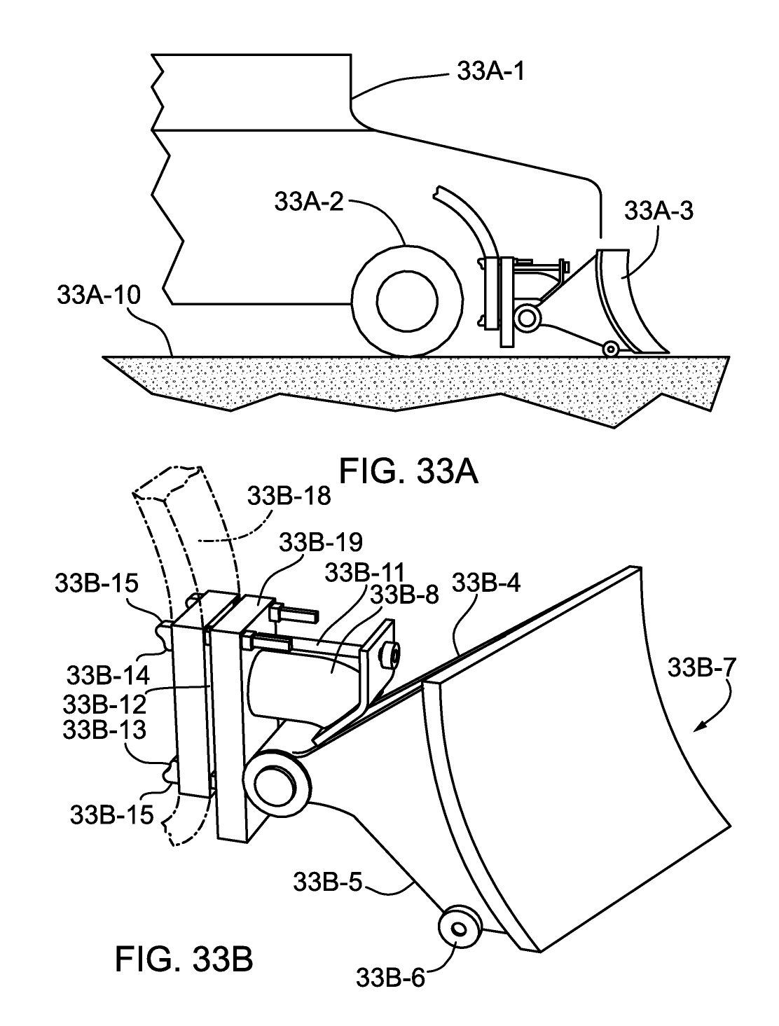

FIG. 33—A—a NV Car 33A-1, a small Plow 33-3 placed ahead of Wheel 33A-2. FIG. 33—B blown up Plow.

Plows should preferably have a number of following features:
be placed in front of the Car, ideally replacing by snapping off a segment of Car Fender, and snapping on the Plow, not to add to Car length,
for tricycles and other vehicles where rear wheels do not use front wheel tracks, one Plow per wheel,
be thin and light, but have structural support Spines 33B-4, 33B-5,
have Roller(s) 33B-6,33B-7, preferably rubber, to prevent it from scratching the road Surface 33-10, which wheels to have a distance of at least a few millimeters to said Surface, only to touch the Surface over road bumps or if the wheels dip, achievable by say tightening or loosening 33-B-11 Screw
be able to move up, no run over road bumps, as the Spring 33-B-9 so allows,
be pushed towards the Surface, by Spring(s) 33B-9, to push into rather than surf the snow,
be placed where the plowed snow can escape, say close to the extreme front end,
not be under the Wheel Housing 33-19 and not to compact the snow in the housing,
be angled to push the snow aside,
if placed underside the Car (rather than front), be Slanted to push the snow down, not to clog against the underside of the Car,
placed also in front of rear wheels, if room for navigating road bumps can be provided, say if the Car has enough road clearance or by reducing the Plow height,
have means to modify its Slant (angle with Surface), Tilt (angle with road's hypothetical walls), which can be achieved, say by having variable length Spines,
have little rattle and or noise, say by adding rubber lingings at rattle or loose joints, 33-B-12,
clear a path wider than wheel track, even when Tilted for narrowest path, and/or
be removable and attachable to the Car, ideally snap on off, say by Snap Pins 33B-15,33B-16 on the Plow Base 33B-19 running through Attachment Plate 33B-17, attached to Car chasie 33B-18, while retractable Latches 33B-13, 33B-14 hold the Base against said Plate, which Base can be pulled out by force, while pushing against snow will not displace it.

Above illustration is one best mode, as Plow's construction and connection to the Car depends on the Car design and construction and location of the Plow, and many designs can accommodate above concepts.

A Practical MagLev (Magnetic Levitating Train)

Some problems with conventional MagLevs are:
they are wide typically four seats per row and an access isle running along the middle of the train, which is solved here by introduced of very narrow vehicles,
they are tall to enable passengers walk along said isle, which is solved here by introduction of multiple doors so that each passenger can access a seat and exit the vehicle without use of an isle,
typically above 2 meters wide and above 3 meters tall and carrying loads or passengers across said width, some load off center and at the extreme side causing load leverage, their support infrastructure, which is usually an Inverted Triangle cross section Rail running above ground supported by Beams dug deep into ground to support all that load and prevent the Rail from tilting is Huge,
all that magnifies the size and power of magnets and other things at every point of Rail & Train,
at crossroads or other places where other vehicles cross their path, such huge structure requires Mega Fly-Overs or Wide & Tall Tunnels to Cross-Under, for at least one of the crossing traffic,
all above block views, change and ruin the homeliness of city streets, alianate the pedestrians who feel overwhelmed by the existence of Behemoths everywhere, widen the roads beyond being cozy, etc,
costs or road widening, new roads, said mega structures are almost always prohibitive,
almost always impossible in already established cities and streets, especially those of historic or other importance which cannot be restructured.

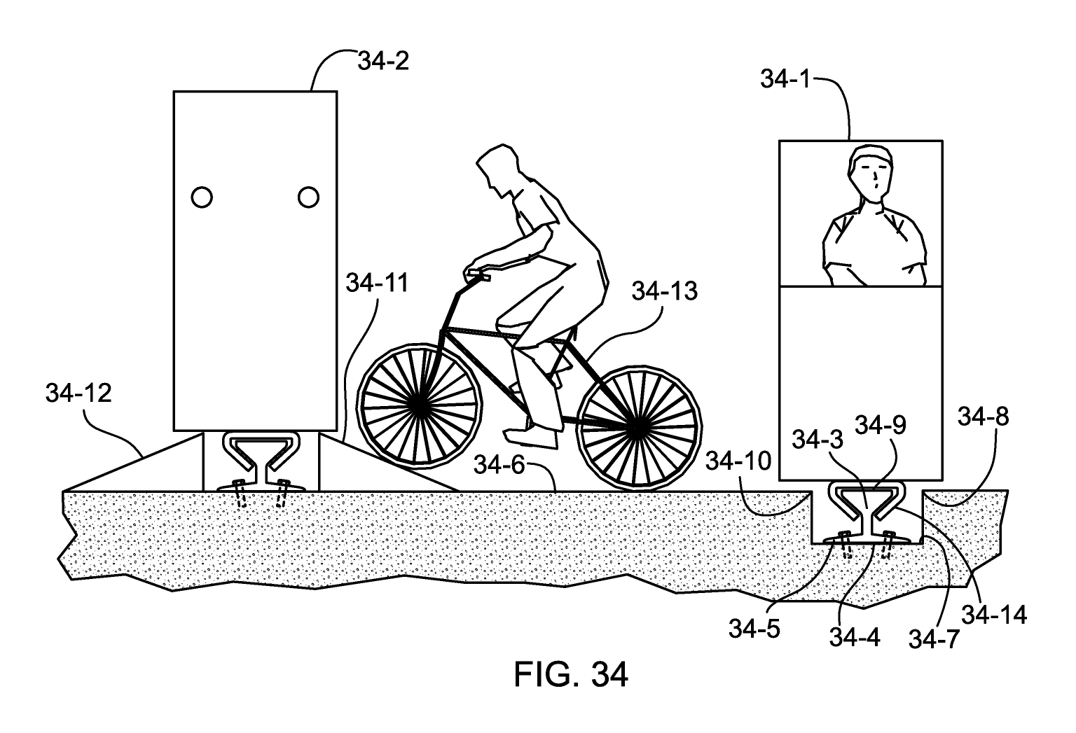

FIG. 34 introduces very narrow Train(s) 34-1 & 2, some just one passenger wide, and low height ones, some below just 120 cm tall, so at each point along the length of a MagLev Rail, there can be a 60 m wide by 120 cm tall, carrying a load or one passenger whose weight is stretched along the length, in the middle and over said Rail, not on the extreme sides of said Train, with very little side leverage, thus a very simple, light, low profile Rail much narrower than the Train will suffice.

Said High-Beams are not needed, as the MagLev's Typical Inverted Triangle Rail 34-3 can be laid over and supported by an Upright Triangle cross section Bed-Rail 34-4 creating a large but Flat I-Rail 34-5, which Flat I-Rail can be laid on the Road 34-6 or in the Ground 34-7.

Instead of Repulsion 34-14 to hold the Train Weight, Rollers and Tires can be used over the Rial. Instead of Repulsion under the Rail to prevent side tilting or roll over, Rollers can be used under the Rail. Instead of Magnetic Drive, Tires connected to poer transmission can be used over, under or the sides of the Rail. Wider versions are possible, as eliminating the Isle and reducing height substantially reduce infrastructure.

Preferred version is One Passenger, say 60 to 70 cm wide, about 120 cm tall, with one door per passenger, short some five rows long, but frequent and auto driven.

Such preferred version can glide on said Flat I-Rail, some 30 cm wide, some 40 cm tall. Hence can be overground, without being an obstacle to anyone. Flat I-Rail can be dug inside a Shallow Trench, especially at crossroads, where crossing vehicles can run over the Edge of said Shallow-Trench 34-8, onto the Rail Top 34-9, to the opposite Edge 34-10, then continue on the road 34-6.

Flat I-Rail should be strong enough to withstand being run over, at least where that is likely, especially to protect any magnets, wirings and electricals inside it. Brushes attached to a number of Trains can clean the gap between the Flat I-Rail and the Shallow Trenches or Ramps.

At crossroads, building entrances, property exits, etc, even if the Flat I-Rail is overground, Crossing Vehicles 34-13 can use an Up-Ramp 34-11 and a Down Ramp 34-12.

MagLev Train can be hidden or half height inside Trenches, especially at crossroads, which Trenches are covered at least where other vehicles must run or cross over them.

An alternative to I-Rial 34-5 is that the top inverted triangle of its cross section which looks like a T, is narrow enough, from left to right of the T top, even with no horizontal ears for said T. Passenger's Seat rolls above said I-Rail, her legs on sides of the I-Rail, as if sitting on a motobike, inside the Train. This enables a smaller overall height for the Train+Rail, making it easier to run through a Trench or over a Sky-Rail, at least at road crossings. At crossings, if no Sky-Rail nor a deep enough Trench to bury the height of both I-Rail and the Train, at least the top of Rail should be not higher than road surface to enable crossing vehicles to run over it. The Gap between 34-8 and I-Rail 34-5 should be wide enough to allow the lower parts of the Train body, which houses Passengers legs and hangs below the road surface, to run through. Said Gap should have a Lid at least at road crossings, which Lid is lifted automatically to let the Train cross and then lowered to enable crossing vehicles to run across and over the I-Rial.

A Tram Anti-Roll

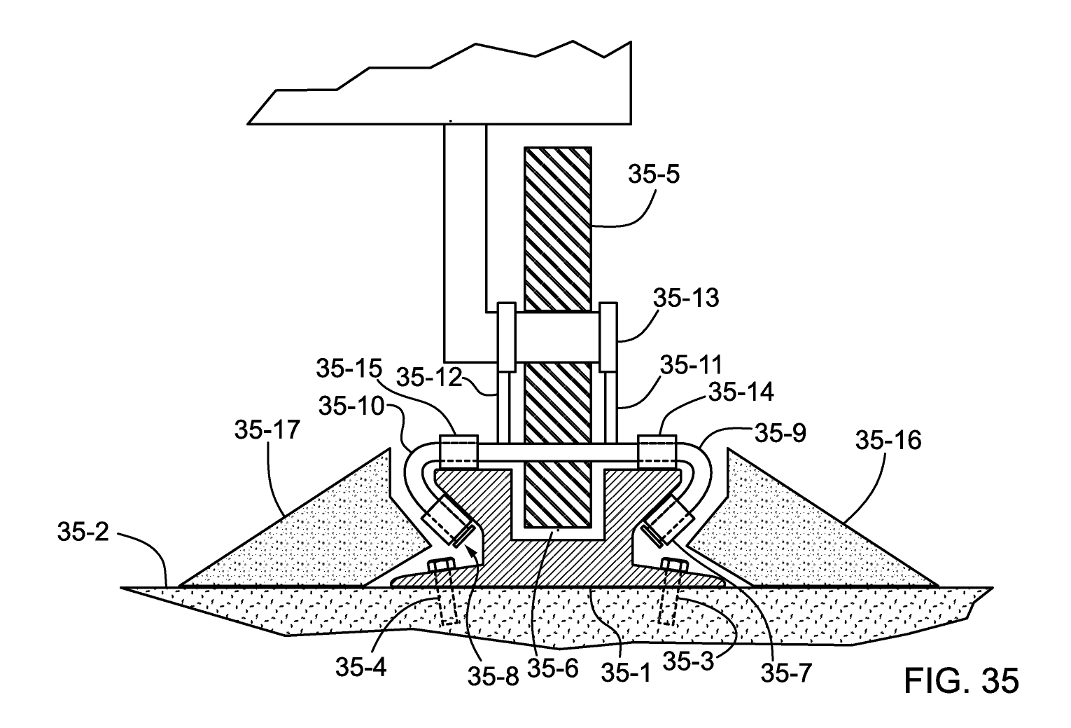

FIG. 35 shows a Tram's 35-18 (Convex) Rail 35-1 fixed onto Road Surface 35-2 via screws 35-3 & 4. Conventional digging the Rial into Road is possible but costlier. Tram Wheel 35-5 runs over and inside the Rail Channel 35-6. Claw Rollers 35-7 & 8 Claw under the Rail, and are connected vai Roller Cores 35-9 & 10 and Connecting Rods 35-11 & 12 to Wheel Axis 35-13. Top Rollers 35-14 & 15 run above the Rail, preferably behind the Wheel, to prevent Rail Friction with Roller Cores. Ramps 35-16 & 17 protect the Rail when run over by Crossing Traffic, especially at crossroads, entries and exits along the track, etc. Anti-Roll Claws need not be connected to every wheel, but one or two on each side, preferably at front and end extremes of each Tram Car or Wagon should suffice.

Anti Roll allows said Rails to be more liberally built and laid on the road. Conventionally, the Rails should be very level with their parallel to avoid roll over, requiring substantial rail foundations that do not sink over time, or slow running Trams. Using above Anti-Roll, Rails can be laid over the road and no chance of roll over even if Rails are or become imbalanced.

Variation of said concepts are possible. The essential concept is That the Vehicle, in this case the Tram is Slidably Clawing or Clinging to a Fixed Rail or Railing along its Lane or Tack, to prevent Roll Over on its side. Also that said Anti Roll Structures should Allow and Withstand other vehicles to Run them Over. For example, Top Rollers are not essential, as Claw Rollers can be directly connected to the Wheel Axis. Connecting Rods can be connected to some other part of the Tram too. One Claw Roller, especially the one towards the outer side of the wheel is enough, if made sturdy.

Hydrogen Fuel Cartridge (HFC)

NV Car should be preferably eco friendly. Typically used for local or last mile, rechargeable batterie(s) are preferred. For faster and or larger ones, and or longer trips, more batteries can be added, in cartridge form.

Same concepts can be used for other liquefied gaseous and liquid fuels.

Same concepts are applicable for general use, other than for NV Cars.

Hydrogen for Fuel Cell and Combustion is stuck in Distribution Infrastructure catch 22.

This application introduces HIFC, which in its optimal form is:
Fillable at Hydrogen Production Plant,
Portable by vans, trucks, trains and or etc to existing gas stations, shops and even homes,
Liftable, when full, by most drivers, say below 10 kg filled,
Standardized in shape and function, to be returned when emptied, and refill,
Sturdy to withstand use, some abuse and potential accidents and drops,
Strong to withstand gas pressure inside,
Optimal in shape, not wasting space in the car, unlike spherical and cylindrical ones,
Holds optimal amount gas per unit weight and volume, using thin light material and structure,
Capable of use in multiples, many can be added together, and
Easy to Install on and Remove from a car.

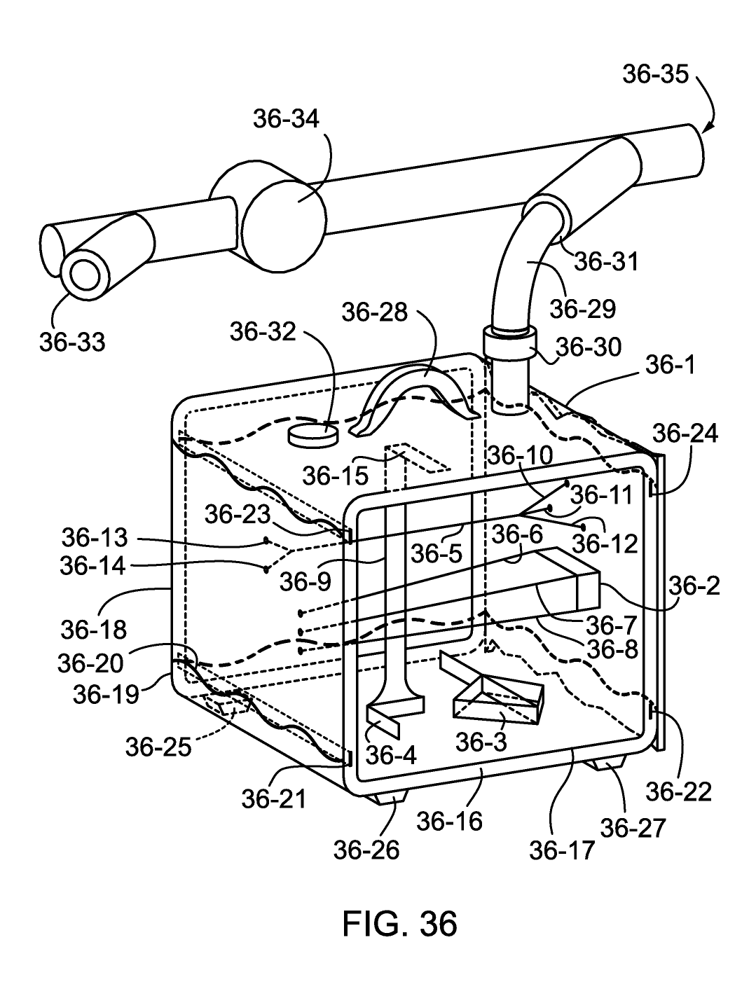

To save space, HFC FIG. 36-1 better have a Rectangular Cubic shape. But gas pressure will push its Sides outward, unless they are very strong, which usually means thick and heavy.

One technique for making a light but strong Side or Casing for a pressurized gas container such as HFC, is to use light and thin sheets of material, say steel, and weld or adhere Walls almost perpendicular to and across most or all of its inner surface (towards inside of the HFC), creating a Wafer looking Sheet. Wafer Walls can be almost parallel lengthwise and or widthwise, can form triangles, squares, rectangles, stars, hexagons, etc.

FIG. 36 shows a number of such Wafer Walls 36-2 & 3 & 4, glued to vertically on HFC Inner Sides of Fuel Container 36-17. To avoid making FIG. 36 busy and confusing, only a few scattered Wafer Walls are shown, but such Walls better cover all of the inner Sides. Wafer Walls can be thin not to use up HFC capacity.

One Technique to counter gas pressure is to connect opposing Sides by non-stretch Cables and or Strips. Examples (a) 36-5 connecting points 36-10,11,12 on the Right Side 36-13,14 on the Left Side, (b) Cables 36-7,8,9 connecting the top of a Wafer Wall on the Right Side to three distinct points on the Left Side, (c) Strip 36-9 connecting the Wafer Walls) 36-4 on the Bottom Side to point 36-15 on the Inner Top Side. To avoid confusion and clutter, only a few are shown, but Cables and Strips better connect numerous points of opposing Side, including Back (hidden in FIG. 36) and Front (shown open for illustration).

To reduce denting and piercing the HFC Inner Container 36-17, a Rubber, Dense Foam or similar Shield 36-16, under about 10 or even under 5 mm thick, covers almost all of the Outside of said Fuel Container, and better be thicker and or more flexible at and near the Container Bottom, to protect against falls.

To protect against external strikes that may bend said Shield and dent the Container, Thin (say below about 2 or even under 1 mm thick) Rigid Plate(s) 36-18 are added to the Exterior, thus strikes are spread out across the Shield, loosing denting force. Some of said Exterior Plates form a Bottom Bowl 36-18, better be stronger to protect against falls.

Said External Plates better be in Segments, meeting along Seams(s) 36-20 which better be wavelike, to prevent easy bending inward of said Plates along said Seams. For more such resistance, rigid Bands 36-21,22,23,24 can be placed under Plates along said Seams.

Studs 36-25,26,27 prevent said Bowl from touching the ground, as a protective measure. An outer Thin (under about 5 mm or even under one mm thick) Skin 36-29, say of Rubber can provide said Plates from damage and scratching. A Fish-net Layer below or within said Skin, made of Kevlar or other Non-Stretch fiber, threads or wires can provide more resistance against inner gas pressure. Fuel Container 36-17 is made of Steel, preferably rust proof, Aluminum or other material. Handle 36-28 helps lifting. All above layers can be thin and light, yet strong.

Discharge Pipe 36-29, enters the Fuel Intake 36-31, preferably in Layman ready Snap-On, Clamp On & Off. Shut Valve 36-30 opens only when said Pipe is secured in said Intake, and is otherwise closed. Refill Cap 36-32 is used at a Hyerogen Plant or Distributor, such as a Gas Station, Shop or Home Hyrogen Generator, to fill the HFC. A second Fuel Intake 36-33 can receive a second HFC, adjacent to the first HFC. Ditto for third and more HFCs. Control Valve 36-34 ensures that second HFC gas is released only after pressure has dropped in the Car Fuel Line 36-35, which Fuel Line leads to Fuel Cell or Engine. Above Fuel Intake, Shut Valve, Cap, Control Valve are known to the skilled.

Each Car should have an HFC Holder for at least one HFC. Emptied HFCs returned. Filled ones bought.

Head-Roll Prevention

NV Car should preferably go fast, even if used mostly, but not necessarily for the last mile from a Public Transit Stop to/from Home/Work. One Preferred Version of NV Car is Short, some 50 cm long for carrying one standing, or about 90 cm long for one sitting passenger. Braking or hitting an obstacle at high speed can cause them to roll over on its head. Some existing two wheel and even 4-wheel Vehicles are also short, and can use described techniques.

One solution is that at braking, rear breaks are applied a fraction of a second before front breaks. Since most brakes are servo assisted, this can be done by an electronic control that once brakes are applied, activates the rear brakes before the front ones. It can be done by driver as in bikes.

Another technique is to have one, preferably two Arms attached to the Front of the Car from one a Base end. A Roller is attached to the other end of each Arm. Said Roller(s) should be preferably Omni-Directional, like those fitted under most swivel chairs. Said Rollers are normally kept close to or within the Car, by retracting said Arms towards the Car. Sensing mechanism, preferably electronics, known to the skilled, sense a pending Head-Roll and trigger said Arm to Swing or Eject and place said Rollers a distance ahead of the Car and very close to or touching the road surface, and hold it there firmly without allowing retraction, to prevent Head-Roll.

Said Arms can be Wing Type to Swing or Telescopic to Eject out to place said Rollers ahead of the car. Both can be done hydraulically, mechanically, or by other ways. One preferred way is to fire open by an explosive action as in air bags. Another way of pushing the Rollers ahead of the Car is to let the Car to Head-Roll slightly, and Lever the Head-Roll Momentum to Swing or Eject said Arms to place the Rollers ahead of the Car. Said controlled or Head-Roll should preferably be by compressing front springs without the rear of the car being lifted off ground. Said Levering can be done in a variety of known ways, each suitable to the Car, Arms and Rollers specific designs, and there is no preset best way.

Swinging or Ejecting can be Sideways, i.e. the Roller moves parallel to road surface, away from its resting position close to or within the Car, and placed ahead of the Car. A better way is to Swing or Eject the Arm Downwards, to bring the Roller from its resting position down towards the road surface, thus the Rollers meet the road even if the Car is part Head-Rolled.

Said Rollers and Arms better be made such that when the car is not tilted forward, but the Rollers are placed where they should be in case activated, the Rollers are slightly above road surface, so that it is easier for them to eject or or swing to their most extracted position ahead of the Car.

Said Arms can be the same ones used to prevent Side-Rolls. The Arm is attached close to the Front of the Car. It places said Rollers a distant away from the Car's Side(say eastward) when sensing Side-Roll, or ahead of the Car (say northward), when sensing Head-Roll or both ahead and aside (say north-east ward) when sensing both concurrently, as it can happen.

Said Arms should Lock once Swang or Ejected, not to swing or slide back and or sideways and not to let said Rollers to get close to the Car, until they are retracted willfully, manually or automatically.

The Base, where said Arms are attached to the Car better have some Springing function to allow some acceptable Head-Tilt, after the Rollers are on the road surface, to absorb some momentum rather than throwing the Car's Driver forward. Known methods exist fitting of said spring action, each suiting particulars of the Car, Arm & Rollers, and no preset best way.

The Car Side Door's lower edge can be well above ground, say as high as the seat's sitting surface, allowing many gears such as said Arms to be installed to the lower portion of Car's sides, without obstructing said Doors. Since this may block putting side entry to the to use underneath of the Seat as luggage room, the Seat's sitting surface can be liftable, especially if Seat's lower front is used as a Glovebox, or the Seat can lien entirely on its back and or side legs, leaving its lower front open.

Another Head-Roll Prevention is an Air Bag firmly fixed to Outside Front or the Car. It inflates upon sensing Head-Roll and adds to Car length and forms a soft wall in front of the Car preventing such Roll.

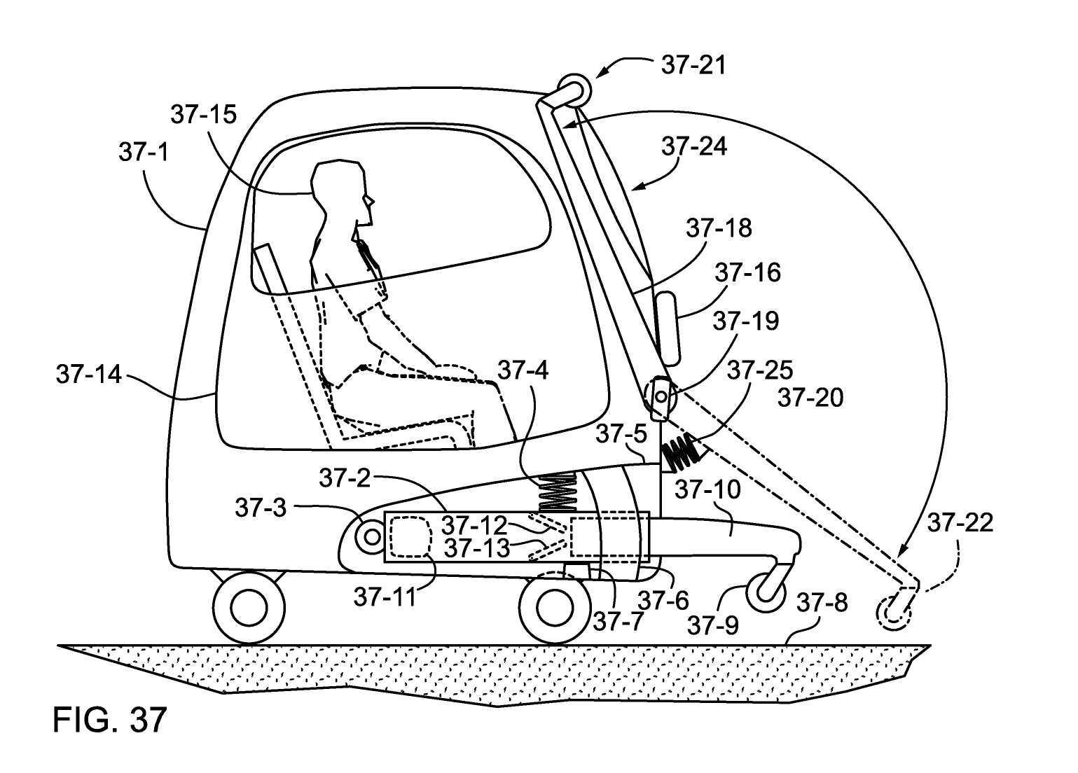

FIG. 37—Shows a Short Car 37-1 with a Telescopic Head-Roll Preventor, having a Gun 37-2 fixed to the Car at Pivot 37-3 allowing said Gun to move up and down. Cars lower side 37-5 prevents the Gun to move towards the Car and Harness 37-6 prevents the Arm from moving aside from the car. Support 37-7 keep the Gun at an angle to keep the Omni-Direction Roller 37-9 off the road Surface 37-8. Telescopic Arm 37-10 is Ejected by Explosive 37-11 once pending or actual Head-Roll is sensed by a Sensor in the Cars Controls. Thus Roller is placed ahead of the Car and said Arm is prevented from sliding back by Spring Blades 37-12 & 13, which allow the Arm to eject but close in afterwards. Contracting Spring 37-4, allows some Head-Tilt to smooth Passenger 37-15 forelash. Cars Door 37-14 opens from above the Gun's Home.

Swing Arm Head-Roll Preventor 37-18, attached to the Car at Lockable Hinge 37-19 and resting on the Car's outer body, without blocking Windshield 37-24, swings to position 37-20, placing Roller 37-21 in position 37-22, then said Hinge Locks preventing swing back, Stretch Spring 37-25 allows some Head-Tilt.

An Air Bag 37-16 serves as a second Head-Roll Preventor. It can also be used to absorb Crashes with other vehicles, barriers and humans.

Side-Roll Prevention

This section describes Anti Roll Techniques more suited to NV Car, but most can be applied NV Bus, Train, Tram, also to other types of vehicles s.a Cars, Vans, Trucks, etc, useful in narrow and or short vehicles.

NV Car should preferably go fast, even if used typically, for the last mile to/from a Public Transit Stop. One Preferred Version of NV Car is One Passenger or about 60 cm wide, for a number of advantages described. A Sought Advantage is that “A lane half the width of a conventional street Lane will suffice”.

If Side-Rolling is considered occasional and or accidental, say if the Car is above 150 cm wide, Techniques for Head-Roll Prevention can be applied, modified for Side-Roll Prevention. Side-Roll Preventing, for a Narrow Car is typically a constant task.

Rolling Preventors better be activated by the Car Automatic Controls, only after a pre-programmed threshold of centrifugal force, tilting or pending Roll Over is sensed by the Sensor, so that minor tilting does not activate them.

Both Side and Head Anti-Rolls can be manually applied too. Also they can have manual Over-ride. They can be applied by default and retracted as necessary.

A prior art way of stabilizing a narrow car is to use hydraulics to lift the side which is tilting down. This is expensive to make and maintain, heavy and fuel hungry as hydraulics are used constantly.

One Anti Side-Roll uses a heavy Weight attached to the Car and moved mechanically, hydraulically, electronically or otherwise to the side about to lift, as sensed by a Sensor. This adds to cars weight, size and consumption, but has the Advantage of not adding to cars width or the width of the lane it uses, so that a lane half as wide as a conventional street lane will suffice for such Car.

A good Anti Side-Roll is a Roller Wing, such as the one in FIG. 20-12 which can Swing away from the Car, Hydraulically (preferred), mechanically, electro-mechanically or otherwise, as known to the skilled. Wing Angle with the car is widened when more pending tilt is sensed and vice versa.

Another is a Telescopic Arm, as in Anti Head-Roll (FIG. 37), but its Arm extrude off Car's Side. It uses hydraulic, mechanical or electro-mechanical means (not explosives) to extrude and retract the Arm out and into its Gun. It can be sturdier than the Wing version, but cannot change its angle with the Car, unless extra gear is added to swivel its Gun to the desired angle with the Car.

Anti-Roll Swing Wings and Telescopic Arms are light and simple, can fold close to the Car when not needed. Since their (preferably Omni-Directional Rollers FIG. 20-13 and FIG. 37-9) need not lift anything and must only counter frictional forces, they do not consume much power.

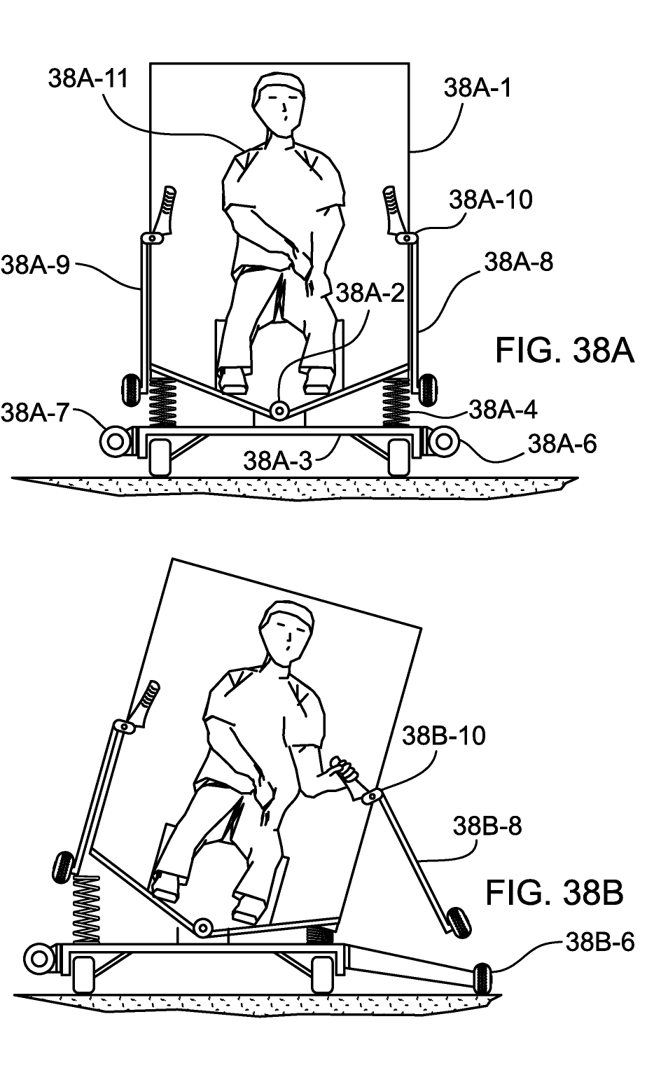

FIG. 38—Side-Roll Prevention by Driver Tilting

This techniques enables an NV Car Driver to do what a cyclist does to stabilize the Car, avoid side rolling. NV Car 38A-1 affixed to Chassie 38-3 via pivot 38A-2 and stabilized by Springs 38A-4 & 5. Swing Wing Side-Roll Preventor 38A-6 is Folded close the Car, so is Manual Swing Leg Side-Roll Preventors 38A-8, attached to the car via the Hing 38A-10, opposite Leg 38-9. Driver 38A-11 is sitting vertical.

FIG. 38B shows the Driver Tilting, Swing Wing is Swang away from the Car to prevent real or perceived over tilting. Driver manually holds the Swing Leg at proper angle to Prevent real or perceived over tilting, as a cyclist leg. Swing Wing and Leg are not essential, none, one or both can be used.

Anti-Roll Wheels

Note: A Wheel has (a) Suspension (b) Steering (c) Power (d) Brakes attached. All should be extendable.

A preferred Anti Side-Roll Technique is to make the Car's wheel move away and towards the Car, using similar techniques as those used for Swing Wing or Telescopic Arm Rollers. Wheels that are not connected to Transmission are simpler to do, as their electrical cable can have slack length and their brake hydraulic tubes can be at least partially flexible with slack length, thus can elongate to allow the Wheel to move away from the Car.

Wheels connected to transmission (Power Wheels) can be one or two, in front or in back of the Car. Remaining or Powerless Wheels, to acting as Anti-Roll should be at least two, one for each side of the Car. If the Engine is in front of the car, rear Power Wheels better be in front, vice versa to simplify transmission.

Telescopic Anti-Roll Wheels are connected to one end of a Telescopic Arm, the other end of which arm moves slidingly inside a Telescopic Gun, which Gun is fixed to the Car. Hydraulic, electromechanical or mechanical means connected to the Arm slide it in and out of the Gun, extending the Telescopes length and moving the Wheel away from the Car. Reverse action moves the Wheel closer to the Car. Movement is controlled by Car Controls, subject to degree of Tilt, pending Roll-Over or Centrifugal force registered by a Sensor. Tilt Sensors based on Gyroscopes and their electronic equivalents are available and used in Segways, Wii Game Devices, etc.

Swing Wing Anti-Roll Wheels are connected to one end of a Wing, the other end of which Wing is connected pivotably to the Car. Swinging said Wing away and towards the Car brings the Wheels away and towards the Car. Wings can be Telescopic as well, mentioned for completeness.

Anti-Roll Wheels can move away from the Car sideways (say east or west) to prevent Side Rolling, or forward (say north) to prevent Head-Rolling or both, say north east & west to prevent both. Anti-Roll Wheel Covers should be detached from the Car, attached to the Wheel Supports to be movable.

For simplicity, Anti-Roll Wheels better not be the Steering Wheels. So Front Wheel Drive (a preferred choice regardless of Anti-Roll) and Rear Anti-Roll Wheels work fine.

It is not essential nor worth the extra costs, weight and complexity to make Power Wheels also perform Anti-Roll functions. But if so desired, say when the Car must be All Wheel Drive, above techniques can be modified. One way is to use a drive system that runs each Wheel independently, such as many Electronic Vehicles that have a small Electromotor for each Power Wheel. Then so long as Electrical cables or other connectors from the Car Power Source, say Batteries to Anti-Roll Power Wheel are Extendible (say coined with slack length), said Wheel can move away from the Car. Anti-Roll Wings can also transmit electrical power to Wheels.

If Power is mechanically transmitted to the Wheel, typically Propeller Shaft from Gearbox to the Wheel, said Shaft can be made Telescopic. The Gun can rotate by transmitted power, rotating the Arm to rotate the Wheel, which Arm cannot revolve inside the Gun. Or, power can be connected to the Arm directly.

Shaft Rotation can be transmitted to a Universal Joint (Swingable) on Anti-Roll Wing Base, then to Wheel.

All shafts connecting Steering to a Wheel can be made Telescopic or otherwise Extendable, but complexity of connecting Power and Anti-Roll to a Steering Wheel is not justified nor needed, as alternatives are fine.

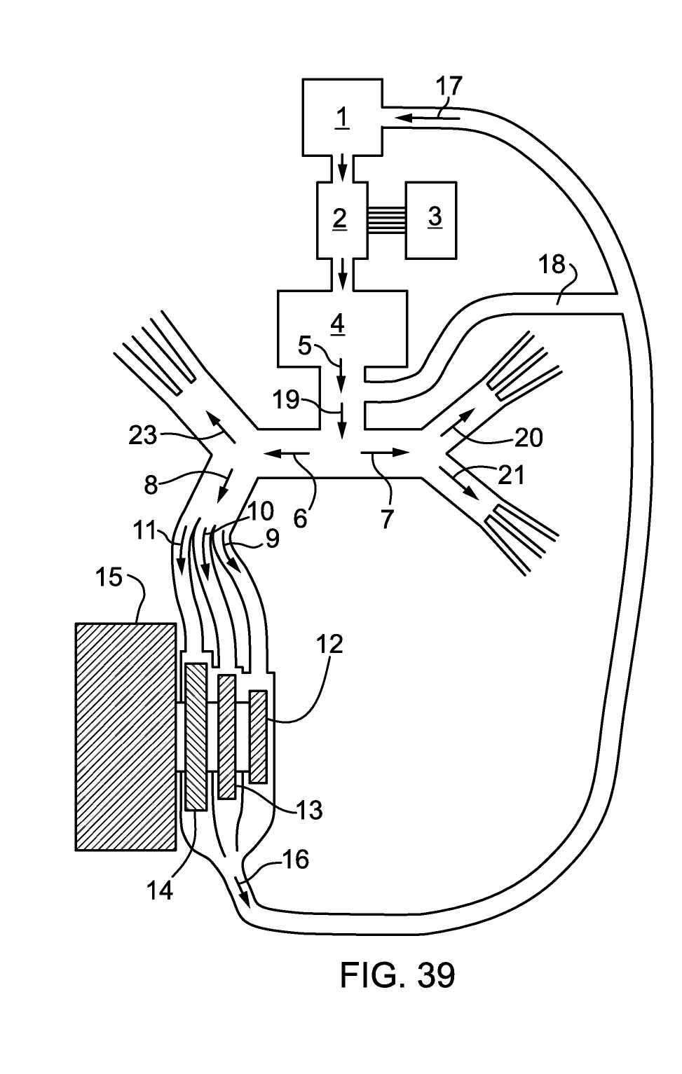

NV Hydraulic Power Transmission (FIG. 39)

Hydraulic Transmission is one preferred way of distributing power, providing many benefits. It can be applied to all kinds of power sources, be it combustion, electro-motor, etc, and to all types of vehicles. It uses compressed liquid (typically oil) or gas (typically air) to distribute power. We use Oil for describing to represent all suitable fluids.

In FIG. 39 (schematic only) 39-1 is an Oil Collector, feeding Oil to Pump 39-2, powered by Engine 39-3, which Pump compressing Oil in Tank 39-4. High Pressure Oil (HPO) is directed via Pipe 39-5 to 39-19, divided into 39-7 which in turn divides it into 39-20 heading to front right wheel, 39-21 to rear right wheel. Pipe 39-6 is divided into 39-23 heading to front left wheel and 39-8 heading to Rear Left Wheel. Pipe 39-8 is divided to Pipes 39-9-10 & 11 heading to Hydraulic Gears (Turbines) 39-12 (Speed), 39-13 (Load) & 39-14 (Reverse) respectively. Reverse Gear can be either a reverse action gear that converts front thrust to reverse motion or that Pipe 39-11 is directed to a position around it that causes reverse movement, as compared to other gears. In the latter case, Load Gear 39-13 can also act as Reverse by Pipe 39-11 entering its thrust at a location almost opposite of where Pipe 39-10 hits it, and Gear 39-14 would not be necessary. HPO causes Wheel 39-15 to spin, then flows to Pipe 39-16, then back to Collector 39-1 via Pipe 39-17. Ditto for other wheels. Each of above Pipes has a Valve that opens and closes it to various degrees, as directed by Driver or Automatics.

Gears can be placed off the wheels, transmitting spin to them via drive shafts. Gears can be in one box, even coupled with an automatic gear shift, before their power is transmitted to the wheels.

To Speed Up, 39-5&19 are opened more, 39-18 is closed, Reverse 39-11 is closed. At low speeds, 39-9 is closed but 39-10 is open. For high speeds, 39-10 is closed & 39-9 is opened. There can be more gears. For Reverse, 39-9 & 10 are closed, 39-11 is opened. To reduce speed, restrict 39-5 &19.

To Brake, open 39-18, so HPO is directed against forward movement, and as long as forward momentum or thust in 39-16 is is higher than in 39-18, pressure is transferred to the Tank 39-4. So Braking does not waste energy into heat, as in friction brakes, but recycles energy. No brake pad or disk wear either.

To Steer Left, 39-6 (or just 39-8) is closed slightly plus if necessary, some Braking, as in normal driving. Thus left side of NV is slowed down. This means less friction for left wheels as they turn. Ditto for right turn.

To distribute more power to rear wheels, as in some cars, Pipes 39-20 & 23 are restricted more while 39-8 & 21 are opened more.

All Valves can be in one Control Box, as all Pipes can have one tail in said Control, in which tail their Valve is placed. Valves can be controlled manually, semi manually or automatically. Valve Closing and Opening need not be complete nor sudden, but can be partial and or gradual. Since PHO is available, said controls can also be powered by it. Said Valves are typically cutting off PHO flow by being inserted in and out of the flow Pipe, at almost right angle to the flow, by screw or push, not moving against the direction of flow. Thus they use little energy.

Sensors can monitor each wheels speed and adjust it as necessary, depending on the situation, by said hydraulic Controls. Each wheel can have an auxiliary friction brake activated automatically, to adjust the relative speed of some wheels according to the situation, just in case hydraulics have not acted quickly enough. For example, when sensors detect that a number of wheels are faster than they should be, but hydraulic brakes will take some fraction of second to be transmitted to said wheel, a temporary brake can be applied. This may become necessary on ice when some wheels turn faster.

Hydraulic Brake Valves can be installed closer to the Wheels for faster response, in addition or instead of those in the Hydraulic Control Box. All Valves can be prompted and or moved by electrically, mechanically or electromechanically. Using same principles, other maneuvers are possible. For example, if rear brakes must apply before front brakes to prevent head rolls or vice versa to prevent skidding.

Since PHO is available, NVs power seats, windows, locks, etc, can be made hydraulic. One, two or more Jacks can be attached beneath NV to lift one wheel, one side or all of the car, for repairs or other purposes. Also for pick-ups and other cargo vehicles, Loading & Unloading Jack becomes easier to add.

Hydraulic Transmission eliminates bulky, mechanical, vertical Differential, which is the cause of many problems, such as trucks having their load platforms so high above the road. No Differential can reduce NV Height, or increase capacity of a Car or Truck without without increasing their height. Hydraulic Transmission can also eliminate drive shafts, friction brakes, gear boxes, power steering, power brakes, gear box, many electric motors (say for power windows). They also have some reserve power in their Pressure Tank, even after primary fuel has run out. If Compressed Air is used, auxiliary Pressure Tank(s) can be installed, especially in Vehicle unused spaces, without adding the extra weight of Oil, only the extra tanks weight.

If Air is used as the Pressurized Fluid, compressed air is available via Exit Valves and Hoses for the car, (say to inflate tires and dusting the engine), garage, home, yard (say to blow leafs), etc. Add a cheap simple water container with a nuzzle to the end of one of said hoses, hence a water jet with many uses.

Detached Self Propelled Trailer:

NV Car (NVC) is typically, but not necessarily, small and made for short distances. But as described, some versions of it can travel fast and long distances, and or carry loads via a small preferably foldable trailer. Since it can do all that, may people may not have a separate car. To add utility to NVC, say to eliminate the need for anther car, we have described features such as Family NVC. This section adds more features. Detached Self Propelled Trailer (DSPT) is a Trailer with Propelling Means, just as a complete Vehicle. In addition it has a Remotely Controlled Driver, which can be controlled by a Driver in an Control NVC or other Control Vehicle. Remote Control can be directed from a far distance too, using GPS or similar means to establish its location, cameras to show its surrounding, etc. DSPT can also be used in conjunction with vehicles other than NVC.

DSPT can be for Cargo, say a Flatbed, Container or Truck, a Recreational Vehicle, another NVC, a Car, other Vehicle, etc. A typical use is an RV for fun or a motorized open or covered Flatbed for Cargo. NVC or other Control Vehicle has a Remote Controller, communicating with DSPT Driver by Cable or preferably Wireless. If Cable, it should be extendable, say a coiled cable, to allow the DSPT to get some distant away from the Control NVC.

Typically NVC is driving ahead, trailed by DSPT Other formations are possible, but the Control Driver should be able to view the road, even if via a Camera installed in front of the Trailer, transmitting road views. NVC and DSPT are programmed to run and act in tandem, so that when NVC speeds, stops, DSPT follows. Of importance is that DSPT is programmed to follow turns after a while behind the NVC (if NVC is in front, ditto for other formations). Said time lag can be calculated from NVC Speed and distance between NVC & DSPT, which can be monitored thousands of times per second with todays technology. Straightening after a turn follows same principles. For backing up, a cameras installed behind the Trailer can transmit rear view to Control Driver, on a screen in NVC.

Automatic Coordinated Driving with the Controlled NVC enables the Trailer to be about a meter behind.

Warnings should be provided to other drivers. For example, Banners and or LED, OLED, LCD and or similar screens can be installed behind the Trailer and or around it, so that certain messages such as Long Vehicle or Remote Controlled Vehicle can be shown for other Vehicles. Such screens can be manipulated by Control Driver, say by typing “thank you” to other vehicles who are considerate of the situation.

There can be preferably expandable Panels or Sheets, say of rubber or Ropes, connecting say the rear of the NVC to the front of DSPT, even though not for pulling the DSPT, but to provide at least the impression of a United Vehicle, so that other vehicles do not get confused or try to cut between NVC and DSPT.

Add-on Trailer (Cable or especially Wireless), like many techniques introduced here have universal applications. One major problem with having a Tow Trailers or RV is that the Horse Vehicle has to be powerful, well equipped, expensive with high running costs, yet most of its abilities are used occasionally. This application introduces Control or Lead Vehicle (instead of Horse), which can be a bicycle, motorbike, car, etc, with Wireless or Cable control of Trailer. Trailer's electrical connections with Lead Vehicle can be cable, which is looped or otherwise extendible, but better be wireless so that Trailer can run at longer distances from Lead, if necessary, say when Lead crosses a terrain to test if the Tailer should follow. One Lead can direct many Trailers. Trailers can run behind or on sides of Lead.

Wireless or Cable communication between passengers in Lead & Trailer(s) is possible by telephone, headphone, even videophone. Many NVC Cars can run in harmony, carrying a family or group, each in their Personal NV Car, listening or watching their own show, without bothering others, only one person directing.

Wireless control messages between Lead Vehicles and Trailers should include a Code specifying to which Trailer, identified by a Trailer ID, each segment of message is sent, so that each trailer obeys only instructions meant for that trailer. In particular, at least the rearmost Trailer should be instructed manually or automatically, to activate Brake, Indicator and Reversing Lights, when necessary, which may not be necessary for other Trailers or even Lead.

To avoid situations where wireless controlling signals can be inadvertently picked up by other similarly operating lead & trailer vehicles, one preferred solution is as above, all vehicles to have a unique ID and said signals are tagged with said ID and not responded to by other vehicles' control mechanisms. Another solution is to reduce the range of or use short range wireless, so that messages reach only the one or few nearest Targets. Another solution is to use Directional Wireless, such as IrDa, which directs transmission towards the Target Trailer or Lead by Infra Red, Laser or other direct Beams. The receptors on Target should be large and or numerous enough not to miss a Beam when sender and receiver are misaligned, (say one is turning but the other has not yet). Also where possible, Walls (preferably rubber to crumble if needed, not to add to vehicles effective length for parking or storage) better be erected around some or all Receptors, at a suitable distance to reduce leaking or any reflection of the Beam, but receive all of it. Receptors and their surroundings better be Beam Absorbent, not reflecting. Again better a sufficient short range Beam be used. When wireless Beam (Direct) or Short Range Multi-Directional (Radio), even Sonar is used, signal transmission can or should be multi-step, from sender to a next receiver for onward transmission to the next, until it reaches the target. Even Internet Protocol can be used, where each receiver/sender is a node, transmitting to a next, choosing the best next depending on route situations, so that even if one node is not functioning or busy, another can be used. All above techniques can be used in combinations and permutations too.

Cables between Trailer(s) and Lead Vehicle, can also supply Electricity to one another, especially when Lead Vehicle does not carry much power storage. Similarly pipes for Gas or even Liquid Fuel.

Lead Vehicle, say NVC can be loaded on one of the Trailers, and be offloaded at some destinations. For Example a Recreational Vehicle can carry a number of NVCs, perhaps one directing it, even if loaded at a bay at the back of RV, until a campsite is reached, RV parks, NVCs are used independently.

When there are many Trailers, or Trailer Train driving on a road, certain measures should be taken by road authorities. For example, once a Trailer Train enters a junction when traffic light is green, light should not turn red until the rearmost Trailer has cleared the junction. This can be done by Sonar, Laser, or other surveillance and or auto-vision at the junction, identifying Trailer Trains from Trailer proximity to each other, which can be typically below a meter, much less than gap between untangled vehicles, and or by signals sent by the Trailer Train, and similarly detecting when all Train has cleared.

Many of the Concepts introduced for Family NV Car can be applied for DSPT and vice versa.

A Practical Mono-Rail

Mono-Rail here is the type where passenger cabin(s) are suspended from a Railing high above ground. Conventional Mono-Rails take years, even decades to roll out, because their purpose is to avoid other vehicles, not to be slowed by them nor slow any of them, along the roads and at crossroads. To achieve this, considering that they are wide, major infrastructure works such as road widening, new roads or skyways are needed.

As disclosed in this application, a vehicle if very narrow and does not sway, it need not rely on any of above. It can use a narrow strip, preferably along the curb, with negligible to no reduction of speed or flow of other vehicles. But the problem of narrow vehicles roll over, especially at high speed, must be addressed, as disclosed before.

At Crossroads, Conventional Mono-Rails use Skyways, so high under which other vehicles can run. Alternatively they can tunnel under, but being neither Narrow nor Low, tunnels become a major work. So as disclosed before, if a Mono-Rail is made Narrow, it will enjoy far less new infrastructure. If it is also Low Profile, it will fit into shallow and narrow Trenches, especially at crossroads, to avoid and be avoided by other vehicles. Such trenches are take far less time and money to construct.

Such Low Profile and Narrow Trains require much simpler and smaller Railings, crossing over a road where needed. Such Railings do not block view, hence much easier to construct anywhere. Other Features disclosed here, such as one door per row of seats, speeds loading, unloading and comfort. So using the techniques disclosed here, Mono-Rails can be made much cheaper, closer to curbside and accessible, made in shorter time, with much less resistance form those that live or work on its path. A preferred version is one seat wide, one door per row, small say five rows with frequent auto drive trains. It uses preferably a curbside strip of existing roads for cheap and quick roll out, yet no blocking or being blocked, and trenches, rather than flyover at crossroads to avoid traffic lights.

Conventional Trains, Trams, even Buses can do same, provided they utilize Narrowing, Anti-Roll, No-Sway and other techniques disclosed.

Traffic Solutions

NVTS can be much more efficient if the rest of Traffic has better flow. Stopping and acceleration at a traffic light or sign consumes more time, fuel, brakepads, green credit and driver patience than driving a much longer path. Here are some solutions, basically aiming at reducing stops:
Construction of more Under & Over Passes at cross roads.
Using more Low Profile Vehicles, enabling faster, cheaper & less obstructive Under &/Over Passes. Say below 180 cm height vehicles enable underpassing 120 cm and say 60 cm high Overpass.
Limiting movement of High Profile Vehicles to roads without low underpasses.
Legally and or Physically Blocking Left Turns (for Right Hand Drive Countries, ditto for LHD), at Cross Roads, at least while the road is busy, measured by timing and or camera counting of passing vehicles.
Making the roads next to cross roads traffic worthy, so that cross road left turns move straight, right at next road, then right at next, then right at next, Looping around the block to achieve a cross road left turn, much longer by distance, but more efficient in all factors that matter.
More use of Roundabouts, proven to be much better than lights or stops.
Right Turn (say from northward to eastward) to have priority over west to east traffic, if west to east traffic can choose a lane other than the one used for right turner. Preferably erecting a dividing wall between said lanes. This applies also if northward is closed beyond the crossroad, say at a T-Junction, where T-Tail approaching T-Head is northward.
Vehicles approaching a T-Junctions from T-Tail turning Left or west onto the T-Heads Center Lane(s), if allowed, to have priority over those moving east to west, provided there are non center lanes on east west T-Tail for east west traffic. Preferably erecting a low wall between said Center and other Lane(s).
Providing Transfer Stations where High Profile Vehicles can Transfer their load or passengers to Low profile Vehicles, until current HPVs are phased out.

Private Public Transit (PPT)—(Potential) Features

PPT is a novel intra & inter city transit system, using numerous Inventions, solving Problems of Private & Public Conventional Transit Systems (CTS), offer many new features, is fun to ride, for less capital & running costs.

PPT Infrastructure Capital Costs & Time to Build:
Fraction of costs of Conventional Transit Systems
Negligible to Minimal new infrastructure
Does not need Subways or Skyways
Does not need new roads or road widening
Simple Stops using cheap/free locations
Incremental Roll Out from a street to a city, country and wider
Can be Up in Months, not decades

PPT Operating Cost, Coverage & Speed:
Cheaper than CTS & Cars per Passenger Mile
Less power/fuel consumption than CTS
Automatic & Manual Driver Options
Can add Rides (Units) without driver costs
Can cover back streets
Dynamic Scheduling and Routing
Frequent Rides, one every few minutes
Avoids Traffic Lights, Jams, Blockages, etc.
Faster than CTS & often than Cars
Eco Friendly in numerous ways
Carbon Credit generator

PPT Facilities Per Passenger
Private Cabin (enabling many features)
Cheaper Fares than CTS
Much Cheaper than Cars
Option to link to other cabins
Private Window with Blind Control
Individual Heat & Cold Control
Scooter Hold
Bicycle Rack
Extendable Luggage Room
Wheelchair Space
Bed for Commuters
Programmable Destination Alarm
Desk
Power Jack & Broadband Jack
Computer & Games
Simple s.a. Elastic Gym Tools
Driveless Work, Rest, Play, Exercise in Transit

Some Grudges Against Public Transit, Solved by PPT:

Most are consciously subconsciously noticed by users, but are assumed unavoidable. (Some potential capabilities. Exact features depend on options versions chosen).

PPT Stops:
No long walk from stop to home/work
No long walk from waiting room to Ride
No loss of any scooter used for last mile
No underground, damp, dirty atmosphere
No long, (sometimes icy) entry/exit stairs
No escalators
No haven for suspect strangers

PPT Effect on other Vehicles & Streets:
No depriving other vehicles from a prime lane, unlike bus lanes
No stopping of other vehicles (unlike trams)
No stopping at junctions or lights
No slowing down by/for other vehicles
No noisy, polluting road behemoth
No eyesore overhead cables
No street car (tram) like metal rattle

PPT Ride (Vehicle)—Entry, Seating & Exit:
No waiting for many to disembark a Ride
No waiting for others to embark a Ride
No climbing up and down to get on board
No waiting for on board ticket vending
No stairs to second deck
No standing along Ride's Isle
No Isle walk/struggle/clash to a Seat or Exit
No letting others to reach or leave a Seat
No lap crushing to reach or leave a window Seat
No suitcase handling nightmare

PPT Privacy
No unwanted company
No sitting or standing beside a weird stranger
No strange's stare, music or noise
No unpleasant odor or smoke
No other peoples kids
No strangers rubbing, pinching, fingering
No Driving, yet privacy, speed & comfort

Some Important Features of Private Public Transit (PPT):
Does not require new roads to be constructed
Does not rely on widening of existing roads
Does not rely on Subways
Does not rely on Skyways
Does not require long walks to/from home, and can cover back streets
Does not noticeably reduce roads capacity for existing vehicles, unlike other vehicles and bus lanes
Does not noticeably reduce speed and flow of existing vehicles, (unlike other vehicles or bus lanes)
Does not have to stop or slow at traffic jams, behind other cars, traffic lights
Requires negligible to minimal Infrastructure, depending on version and/or options chosen
Roll out can be at a fraction of time and cost of Subways and Skyways, even Trams
Is far safer than CPT for Passengers in the Station, in the Ride and People on the Road
Can incorporate features to reduce preference of automobile over Conventional Public Transit
Can provide one or more private cabins per passenger
Thus enable many features not possible in conventional public transit (CPT)
Increases capacity of roads and speed of existing vehicles by absorbing much of said traffic load
Cost per Km per Passenger depends on chosen options and version
But its simplicity, light weight and other features all reduce cost below CPT

NVTS Some Indirect Health & Safety Features (in addition to explored safety inside NV and Stops):
dedicated lane substantially reduces crash with other vehicles and pedestrians
narrow, insignificant lane reduces need or urge by pedestrians or other vehicles to use said lane
no sway increases predictability of NV direction resulting in better avoidance of collisions
low height and narrow body increases visibility for pedestrians and other vehicles
small NVs are less dangerous, when hitting a pedestrians or other vehicles
fewer private cars, less road stress, less time on the roads, etc, all increase safety
more use of NVTS, more auto driven NVs, more . . . all increase safety
more efficient NVTS, less fuel, less stress, less transit time adding to sports time, etc, increase health
NV Cabin exercise tools, drive free time, sleep option, . . . , all increase health

Cargo Ways Features:

Cargoway use the techniques described for passenger transit to move cargo. Most described features have their equivalent in CargoWays. No need to recompare for the skilled. Cargo can often be broken into smaller parcels to fit into Lower height, width and length Containers or Cargo NV than a person can. Thus many features are more prominent in Cargoways. In particular, CargoWay Trenches can have a smaller profile than a large utility pipe. There is more freedom in their profile, say can be triangular to run along the angle between street walls and sidewalk, above ground, &/occupy the unused margin of sidewalk. CargoWays can substantially reduce need for vans, pick ups, trucks and multi stage transit. CargoWay can also reduce drivers and costs, using auto drive containers. Todays Auto Drive technology is not advanced for open roads, but is sufficient for dedicated lanes, tracks and trenches.

Supporting Brief for Some Claims:

Some of the novel features of techniques introduced in this application are summarized below:
1—A transit system having a number of lane(s) and or track(s) along road(s), within which lanes a number of vehicles run, where:
   said vehicles have means to prevent roll over on their side,
   said means use claws or hooks that slidingly grab or hook to at least one rail or railing stretched along said lane, or
   said means use magnets gliding above a steel strip(s) or band(s) doped with iron or other magnet attracting material, which strip and band are laid along the surface of said lane, pulling said vehicle towards the road, at least when potential roll over is sensed by a control mechanism on said vehicle,
   or said means use a wall on at least one side of said vehicles on and along said lane/track,
   said lane and anti roll means have means and structures to allow being run over by other vehicles, at least at locations where said lane must be crossed by other vehicles,
   which crossing vehicles run over at least some of the structures along said lane as they cross over, as opposed to flying over said means or structures,
   said lane and anti roll means have means and structures to withstand being run over by other vehicles, at least at locations where said lane must be crossed by other vehicles,
   said locations include at least a number of crossroads, traffic entrances and exits along said lane.
2—A vehicle running along a lane, independently of imposing its weight onto any rail, where:
   said vehicle has means to prevent it from roll over on its side,
   said means use claws or hooks with roller fingers that slidingly grab or hook to at least one rail or railing stretched along said lane, or
   said means use magnets gliding above a steel strip(s) or band(s) doped with iron or other magnet attracting material, which strip and band are laid along the surface of said lane, pulling said vehicle towards the road, at least when potential roll over is sensed by a control mechanism on said vehicle,
   or said means use a wall on at least one side of said vehicles on and along said lane/track,
   said lane and anti roll means have means and structures to allow and withstand being run over by other vehicles, at least at locations where said lane must be crossed by other vehicles, and
   said locations include at least a number of crossroads, traffic entrances and exits along said lane.
3—A tram or a train vehicle, running along a lane or track, on two rails bearing its weight, where:
   said vehicle has means to prevent it from roll over on its side,
   said means use claws or hooks with roller fingers that slidingly grab or hook to at least one rail or railing stretched along said lane, or
   said means use magnets gliding above a steel strip(s) or band(s) doped with iron or other magnet attracting material, which strip and band are laid along the surface of said lane, pulling said vehicle towards the road, at least when potential roll over is sensed by a control mechanism on said vehicle,
   or said means use a wall on at least one side of said vehicles on and along said lane/track,
   said lane, weight bearing rails and anti roll means have means and structures to allow and withstand being run over by other vehicles, at least at locations where said lane must be crossed by other vehicles, and
   said locations include at least a number of crossroads, traffic entrances and exits along said lane.
4—A Train, running on weight bearing rails, which rails have an I cross section, where:
   said vehicle has means to prevent it from roll over on its side,
   said means use claws or hooks with roller fingers that slidingly grab or hook to the underside of the top portion of said rail.
5—A magnetic levitating train vehicle, running on a rail, where:
   said rail has means and structures to allow and withstand being run over by other vehicles, at least at locations where it must be crossed by other vehicles, and
   said locations include at least a number of crossroads, traffic entrances and exits along said lane.
6—above 5 where said train uses rollers instead of repulsion for weight support, anti-roll and or propelling.
7—A vehicle running along a lane in a direction on a public transit road, independently of imposing its weight onto any rail, wherein:
   said vehicle has means to reduce the sway allowance in the width of said lane to below a desired span along said direction,
   said road has means to assist said anti sway functions,
   both said means achieve said functions independently of any human driver,
   said road means have means and structures to allow being run over, at least at locations where said lane must be crossed by other vehicles,
   said road means have means and structures to protect them from damage when run over, at least at locations where said lane must be crossed by other vehicles,
   said span is below about 30 cm.
8—A public transit system having a number of lane(s) and or track(s) along road(s), within which lanes a number of vehicles run, where:
   said vehicles capable of not rolling over on their side, even at speeds above about 30 kmh,
   said lanes and structures within them are capable and have means to allow being run over by other vehicles, at least at locations where said lane must be crossed by other vehicles,
   said lane and anti roll means have means and structures to withstand being run over by other vehicles, at least at locations where said lane must be crossed by other vehicles,
   which crossing vehicles run over at least some of the structures along said lane as they cross over, as opposed to flying over said means or structures,
   said locations include at least a number of crossroads, traffic entrances and exits along said lane, and
   said vehicles are below about 150 cm wide.
9—Above plus enough doors along its length and enough isles along the width of said vehicle to enable each passenger to reach a seat inside and exit said vehicle without need for any isle along vehicle length.
10—Above plus vehicles are below about 150 cm wide.
11—Above where said vehicle is below about 110 cm wide.
12—Above where said vehicle is below about 70 cm wide.
13—Above with one exit and entry door per passenger.
14—Above where the vehicle height is below about 120 cm.
15—Above where said vehicle runs inside a trench, at least along a number of locations where its lane needs to be crossed over, which trenches are covered, at least along a said locations.
16—Above where said vehicle runs substantially close to the outer limit of the road or close to said limit lanes for most locations where some of its body or of the structures on its lane are above the road surface and block other vehicles.
28—above 1 where said vehicles are chosen from a list vehicle types chosen from following:
   those running independent of any rails to carry their weight, including buses,
   trains running on two parallel rails which rails are raised above the road,
   trams or street cars running on two parallel rails, which rails are dented onto the road,
   maglevs running on a single rail, propelled, supported for weight and protected from roll over typically by magnetic repulsion, and or by rollers, and
   private vehicles.

1- A transit system having a number of lane(s) and or track(s) along road(s), within which lanes a number of vehicles run, where:
said vehicles have means to prevent roll over on their side,
said anti roll-over means use at least one of a, b, and or c below:
(a) claws or hooks attached to said vehicles that slidingly grab at least one rail stretched along said lane,
(b) magnets gliding above a steel strip(s) or band(s) doped with iron or other magnet attracting material, which strip and band are laid along the surface of said lane, pulling said vehicle towards the road, at least when potential roll over is sensed by a control mechanism on said vehicle,
(c) walls on at least one side of said vehicle on and along lanes or tracks,
said rails have means and structures to allow and withstand being crossed and run over and by other vehicles, at least at locations where said lane must be crossed by other vehicles,
which crossing vehicles run over at least some of the structures along said lane as they cross over, as opposed to flying over said means or structures,
said locations include at least a number of crossroads, traffic entrances and exits along said lane.

2- claim 1 where said said vehicle runs independently of imposing its weight onto any rail.

3- claim 1 where said vehicle imposes its weight on a rail, which rial is chosen from a list of tram-like channel rails and train-like upright rails.

4- claim 1 where said vehicle is a train and imposes its weight on a rail, which rails have an “I” cross section, said train has claws or hooks with roller fingers slidingly grabbing or hooking to the underside of the top portion of said rail to prevent said train from roll over.

5- claim 1 where said vehicle is a magnetic levitating train, running on a rail, where:
said rail has means and structures to allow and withstand being run over by other vehicles, at least at locations where it must be crossed by other vehicles, and
said locations include at least a number of crossroads, traffic entrances and exits along said lane.

6- claim 5 where said train uses rollers instead of repulsion for weight support, anti-roll and or propelling.

7- A vehicle running along a lane in a direction on a public transit road, where
said vehicle runs independently of imposing its weight onto any rail,
said vehicle has means to reduce the sway allowance in the width of said lane to below a desired span along said direction,
said road has means to assist said anti sway functions,
both said means achieve said task independently of any human driver,
said road means have means and structures to allow and withstand being run over, at least at locations where said lane must be crossed by other vehicles, and
said span is below about 30 cm.

8- A public transit system having a number of lane(s) and or track(s) along road(s), within which lanes a number of private and or public vehicles run, where:
said vehicles are capable of not rolling over on their side, even at speeds above about 30 kmh,
said lanes and structures within them are capable and have means to allow being run over by other vehicles, at least at locations where said lane must be crossed by other vehicles,
said lane and anti roll means have means and structures to withstand being run over by other vehicles, at least at locations where said lane must be crossed by other vehicles,
which crossing vehicles run over at least some of the structures along said lane as they cross over, as opposed to flying over said means or structures,
said locations include at least a number of crossroads, traffic entrances and exits along said lane, and
said vehicles are below about 110 cm wide.

9- claim 1, where said vehicle is below about 110 cm wide.

10- claim 1 where said vehicle is below about 70 cm wide.

11- claim 1 with enough doors along its length, on at least one side of said vehicle, and enough isles along the width of said vehicle to enable each passenger to reach a seat inside and exit said vehicle without need for any isle along the length of the vehicle.

12- claim 11 where said vehicle is below about 110 cm wide.

13- claim 11 where said vehicle is below about 70 cm wide.

14- claim 13 where said vehicle has at least one door per row of passengers.

15- claim 14 where the vehicle height is below about 150 cm.

16- claims 1 where said vehicle runs inside a trench, at least along a number of locations where its lane needs to be crossed over, which trenches are covered, at least along a said locations, which covers allow and withstand being run over by crossing traffic.

17- claim 14 where said vehicle runs inside a trench, at least along a number of locations where its lane needs to be crossed over, which trenches are covered, at least along a said locations, which covers allow and withstand being run over by crossing traffic.

18- claim 1 where said vehicle runs substantially close to the outer limit of the road or close to said limit lane(s) for most locations where at least some of its body or of the structures on its lane are above the road surface blocking other vehicles.

19- claim 14 where said vehicle runs substantially close to the outer limit of the road or close to said limit lane(s) for most locations where at least some of its body or of the structures on its lane are above the road surface blocking other vehicles.

20- claim 17 where said vehicle runs substantially close to the outer limit of the road or close to said limit lane(s) for most locations where at least some of its body or of the structures on its lane are above the road surface blocking other vehicles.
